(19) United States
(12) Patent Application Publication
(10) Pub. No.: US 2024/0194208 A1
(43) Pub. Date: Jun. 13, 2024

(54) INTEGRAL BAND-WISE PARAMETRIC AUDIO CODING

(71) Applicant: Fraunhofer-Gesellschaft zur Förderung der angewandten Forschung e.V., München (DE)

(72) Inventor: Goran MARKOVIC, Erlangen (DE)

(21) Appl. No.: 18/405,402

(22) Filed: Jan. 5, 2024

Related U.S. Application Data
(63) Continuation of application No. PCT/EP2022/069811, filed on Jul. 14, 2022.

(30) Foreign Application Priority Data
Jul. 14, 2021 (EP) 21185666.1

(51) Int. Cl. G10L 19/02; G10L 19/032

(52) U.S. Cl. CPC G10L 19/0204; G10L 19/032

(57) ABSTRACT

Encoder for encoding a spectral representation of audio signal divided into a plurality of sub-bands, wherein the spectral representation consists of frequency bins or of frequency coefficients and wherein at least one sub-band contains more than one frequency bin, the encoder having: a quantizer configured to generate a quantized representation of the spectral representation of audio signal divided into the plurality sub-bands; a band-wise parametric coder configured to provide a coded parametric representation of the spectral representation depending on the quantized representation, wherein the coded parametric representation consists of parameters describing the spectral representation in the sub-bands or coded versions of the parameters; wherein there are at least two sub-bands being different and parameters describing the spectral representation in the at least two sub-bands being different.

### CROSS-REFERENCE TO RELATED APPLICATIONS

This application is a continuation of copending International Application No. PCT/EP2022/069811, filed Jul. 14, 2022, which is incorporated herein by reference in its entirety, and additionally claims priority from European Application No. 21185666.1, filed Jul. 14, 2021, which is also incorporated herein by reference in its entirety.

### TECHNICAL FIELD

Embodiments of the present invention refer to an encoder and a decoder. Further embodiments refer to a method for encoding and decoding and to a corresponding computer program. In general, embodiments of the present invention are in the field of integral band-wise parametric coder.

### BACKGROUND OF THE INVENTION

Modern audio and speech coders at low bit-rates usually employ some kind of parametric coding for at least part of its spectral bandwidth. The parametric coding either is separated from a waveform preserving coder (called core coder with a bandwidth extension in this case) or is very simple (e.g. noise filling).

In the known technology, several approaches in the field of parametric coder are already known.

In [1] comfort noise of a magnitude derived from the transmitted noise fill-in level is inserted in subvectors rounded to zero.

In [2] noise level calculation and noise substitution detection in the encoder comprise:
Detect and mark spectral bands that can be reproduced perceptually equivalent in the decoder by noise substitution. For example, a tonality or a spectral flatness measure may be checked for this purpose;
Calculate and quantize the mean quantization error (which may be calculated over a plurality or over all scale factor bands not quantized to zero); and
Calculate scale factor for band quantized to zero such that the (decoder) introduced noise matches the original energy.

In [2] noise is introduced into spectral lines quantized to zero starting from a “noise filling start line”, where the magnitudes of the introduced noise is dependent on the mean quantization error and the introduced noise is per band scaled with the scale factors.

In [3] a noise filling in frequency domain coder is proposed, where zero-quantized lines are replaced with a random noise shaped depending on a tonality and the location of the non-zero-quantized lines, the level of the inserted noise set based on a global noise level.

In [4] noise-like components are detected on a coder frequency band basis in the encoder. The spectral coefficients in a scalefactor bands containing noise-like components are omitted from the quantization/coding and only a noise substitution flag and the total power of the substituted bands are transmitted. In the decoder random vectors with the desired total power are inserted for the substituted spectral coefficients.

In [5] a bandwidth extension method operating in the time domain that avoids inharmonicity is proposed. Harmonicity of the decoded signal is ensured by calculation of the autocorrelation function of the magnitude spectrum, where the magnitude spectrum is obtained from the decoded time domain signal. By using the autocorrelation, an estimation of F0 is avoided. The analytical signal of the LF part is generated by Hilbert transformation and multiplied with the modulator to produce the bandwidth extension. Envelope shaping and noise addition is done by the SBR.

In [6] the complete core band is copied into the HF region and afterwards shifted so that the highest harmonic of the core matches with the lowest harmonic of the replicated spectrum. Finally the spectral envelope is reconstructed. The frequency shift, also named the modulation frequency, is calculated based on f0 that can be calculated on encoder side using the full spectrum or on decoder side using only the core band. The proposal also takes advantage of the steep bandpass filters of the MDCT to separate the LF and HF bands.

In [7-14] a semi-parametric coding technique, named the Intelligent Gap Filling (IGF), is proposed that fills spectral holes in the high-frequency region using synthetic HF generated out of low-frequency content and post-processing by parametric side information consisting of the HF spectral and temporal envelope. The IGF range is determined by a user-defined IGF start and a stop frequency. Waveforms, which are deemed necessary to be coded in a waveform preserving way by the core coder, e.g. prominent tones, may also be located above the IGF start frequency. The encoder codes the spectral envelope in IGF-range and afterwards quantizes the MDCT spectrum. The decoder uses traditional noise filling below the IGF start frequency. A tabulated user-defined partitioning of the spectrum bandwidth is used with a possible signal adaptive choice of the source partition (tile) and with a post-processing of the tiles (e.g. cross-fading) for reducing problems related to tones at tile borders.

In [11] an automated selection of source-target tile mapping and whitening level in IGF is proposed, based on a psychoacoustic model.

In [15] the encoder finds extremum coefficients in a spectrum, modifies the extremum coefficient or its neighboring coefficients and generates side information, so that pseudo coefficients are indicated by the modified spectrum and the side information. Pseudo coefficients are determined in the decoded spectrum and set to a predefined value in the spectrum to obtain a modified spectrum. A time-domain signal is generated by an oscillator controlled by the spectral location and value of the pseudo coefficients. The generated time-domain signal is mixed with the time-domain signal obtained from the modified spectrum.

In [16] pseudo coefficients are determined in the decoded spectrum and replaced by a stationary tone pattern or a frequency sweep pattern.

In [17][18] quantizers use a dead-zone that is adapted depending on the input signal characteristics. The dead-zone makes sure that low-level spectral coefficients, potentially noisy coefficients, are quantized to zero.

Below, drawbacks of the known technology will be discussed, wherein the analysis of the known technology and the identification of the drawbacks is part of the invention.

In the known technology either just simple noise filling is integrated in the core coder [1][2][3][4], the core coder being the waveform preserving quantizer for spectral lines, or there is a distinction between the core coder and the bandwidth extension [1][5][6][7-14]. Even though the IGF [7-14] allows preservation of spectral lines in the whole bandwidth, it requires a spectral analyzer operating before the spectral domain encoder and thus it is not possible to have a choice, which parts of the spectrum to code parametrically depending on the result of the spectral domain encoder. The PNS in [4] decides before the quantization, just depending on tonality, which sub-bands to zero out and uses only random noise for the sub-bands substitution.

In [15] only parametric coding of single tonal components is considered. It is decided before the quantizer, which spectral lines to code parametrically and only simple maxima determination is used for the decision. The result of the quantizer is not used for determining which spectral lines to code parametrically. Non-zero pseudo coefficients need to be coded in the spectrum and coding non-zero coefficients is in almost all cases more expensive than coding zero coefficients. On top of coding the pseudo coefficients, a side information is required to distinguish pseudo coefficients from the waveform preserving spectral coefficients. Thus, a lot of information needs to be transmitted in order to generate a signal with many tonal components. The method also does not propose any solution for non-tonal parts of a signal. In addition, the computational complexity for generating signals containing many tonal components coded parametrically is very high.

In [16] the high computation complexity is reduced compared to [15], by using spectral patterns instead of time-domain generator. Yet only predetermined patterns or their modifications are used for replacing the pseudo coefficients, thus either requiring a lot of storage or limiting the range of the possible tones that can be generated. The other drawbacks from [15] remain in [16].

The noise filling in [1][2][3] and similar methods provide substitution of spectral lines quantized to zero, but with very low spectral resolution, usually just using a single level for the whole bandwidth.

The IGF has predefined sub-band partitioning and the spectral envelope is transmitted for the complete IGF range, without a possibility to adaptively transmit the spectral envelope only for some sub-bands.

In [5] only the characteristics of the autocorrelation of the magnitude spectrum and predefined constants are used for choosing the offset used in the modulator. Only one offset is found for the whole spectrum bandwidth.

In [6] only one modulation frequency for the whole bandwidth is used for the frequency shift and the modulation frequency is calculated only on the basis of the fundamental frequency. In [11] only predefined source tiles below the IGF start frequency are used to fill the IGF target range, where the target range is above the start frequency. The tile choice is dictated by the adaptive encoding and thus needs to be coded in the bit-stream. The proposed brute force approach has high computational complexity.

In IGF a source tile is obtained bellow the IGF start frequency and thus does not use the waveform preserving core coded prominent tones located above the IGF start frequency. There is also no mention of using combined low-frequency content and the waveform-preserving core coded prominent tones located above the IGF start frequency as a source tile. This shows that the IGF is a tool that is an addition to a core coder and not an integral part of a core coder.

The methods that use dead-zone [17][18] try to estimate value range of spectral coefficients that should be set to zero. As they are not using the actual output of the quantization, they are prone to errors in the estimation.

It is an objective of the of the present invention to provide a concept for efficient coding, especially efficient parametric coding.

### SUMMARY

According to an embodiment, an encoder for encoding a spectral representation of audio signal divided into a plurality of sub-bands, wherein the spectral representation consists of frequency bins or of frequency coefficients and wherein at least one sub-band contains more than one frequency bin, may have: a quantizer configured to generate a quantized representation of the spectral representation of audio signal divided into the plurality sub-bands; and a band-wise parametric coder configured to provide a coded parametric representation of the spectral representation depending on the quantized representation, wherein the coded parametric representation consists of parameters describing the spectral representation in the sub-bands or coded versions of the parameters describing the spectral representation in the sub-bands; wherein there are at least two sub-bands being different and the parameters describing the spectral representation in the at least two sub-bands being different wherein the parameters describe the energy in the sub-bands; wherein at least one sub-band of the plurality of sub-bands is quantized to zero or wherein a spectral representation for at least one sub-band of the plurality of sub-bands is zero in the quantized representation.

According to another embodiment, a decoder for decoding an encoded audio signal, the encoded audio signal consisting of at least a coded representation of spectrum and a coded parametric representation, wherein the encoded audio signal further has a quantization step, may have: a spectral domain decoder configured for generating a decoded and dequantized spectrum from the coded representation of spectrum and quantization step, wherein the decoded and dequantized spectrum is divided into sub-bands; band-wise parametric decoder is configured to identify zero sub-bands in a decoded spectrum or the decoded and dequantized spectrum and to decode a parametric representation of the zero sub-bands based on the coded parametric representation, wherein the parametric representation hasa parameters describing the energy in the zero sub-bands and wherein there are at least two sub-bands being different and, thus, parameters in at least two sub-bands being different and wherein the coded parametric representation is represented by use of a variable number of bits and wherein the number of bits used for representing the coded parametric representation is dependent on the coded representation of spectrum.

According to another embodiment, a decoder for decoding an encoded audio signal may have: a spectral domain decoder configured for generating a decoded and dequantized spectrum dependent on the encoded audio signal, wherein the decoded and dequantized spectrum is divided into sub-bands; a band-wise parametric decoder configured to identify zero sub-bands in a decoded spectrum or a decoded and dequantized spectrum and to decode a parametric representation of the zero sub-bands based on the encoded audio signal; aa band-wise spectrum generator configured to generate a band-wise generated spectrum dependent on the parametric representation of the zero sub-bands; a combiner configured to provide a band-wise combined spectrum; where the band-wise combined spectrum has a combination of the band-wise generated spectrum and the decoded and dequantized spectrum or a combination of the band-wise generated spectrum and a combination of a predicted spectrum and the decoded and dequantized spectrum and a spectrum-time converter configured for converting the band-wise combined spectrum or a derivative of the band-wise combined spectrum into a time representation.

Another embodiment may have a band-wise parametric spectrum generator configured to generate a spectrum to obtain a generated spectrum that is added to a decoded and dequantized spectrum or to a combination of a predicted spectrum and the decoded and dequantized spectrum, where the generated spectrum is band-wise obtained from a source spectrum, the source spectrum being one of:
a second prediction spectrum; or
a random noise spectrum; or
the already generated parts of the generated spectrum ; or
the decoded and dequantized spectrum or the combination of the predicted spectrum and the decoded and dequantized spectrum; or
a combination of one or two of the above
   wherein at least one sub-band is obtained using the already generated parts of the generated spectrum.

According to another embodiment, a method for encoding a spectral representation of audio signal divided into a plurality of sub-bands, wherein the spectral representation consists of frequency bins or of frequency coefficients and wherein at least one sub-band contains more than one frequency bin, may have the steps of: generating a quantized representation of the spectral representation of audio signal divided into plurality sub-bands; providing a coded parametric representation of the spectral representation depending on the quantized representation, wherein the coded parametric representation consists of parameters describing the spectral representation in the sub-bands or coded versions of the parameters describing the spectral representation in the sub-bands; wherein there are at least two sub-bands being different and the parameters describing the spectral representation in the at least two sub-bands being different wherein the parameters describe the energy in the sub-bands; wherein at least one sub-band of the plurality of sub-bands is quantized to zero or wherein a spectral representation for at least one sub-band of the plurality of sub-bands is zero in the quantized representation.

According to another embodiment, a method for decoding an encoded audio signal, the encoded audio signal consisting of at least a coded representation of spectrum and a coded parametric representation, wherein the encoded audio signal further has a quantization step, may have the steps of: generating a decoded and dequantized spectrum from the coded representation of spectrum and quantization step, wherein the decoded and dequantized spectrum is divided into sub-bands; identifying zero sub-bands in a decoded spectrum or the decoded and dequantized spectrum and decoding a parametric representation of the zero sub-bands based on the coded parametric representation, wherein the parametric representation has parameters describing the energy in the zero sub-bands and wherein there are at least two sub-bands being different and, thus, parameters in at least two sub-bands being different and wherein the coded parametric representation is represented by use of a variable number of bits and wherein the number of bits used for representing the coded parametric representation is dependent on the coded representation of spectrum.

According to another embodiment, a method for decoding an encoded audio signal may have the steps of: generating a decoded and dequantized spectrum based on an encoded audio signal, wherein the decoded and dequantized spectrum is divided into sub-bands; identifying zero sub-bands in a decoded spectrum or the decoded and dequantized spectrum and to decode a parametric representation of the zero sub-bands based on the encoded audio signal; generating a band-wise generated spectrum dependent on the parametric representation of the zero sub-band; providing a band-wise combined spectrum; where the band-wise combined spectrum has a combination of the band-wise generated spectrum and the decoded and dequantized spectrum or a combination of the band-wise generated spectrum and a combination of a predicted spectrum and the decoded and dequantized spectrum; and converting the band-wise combined spectrum or a derivative of the band-wise combined spectrum into a time representation.

Another embodiment may have a method for generating a band-wise generated spectrum, having the step of generating a spectrum to obtain a generated spectrumthat is added to a decoded and dequantized spectrum or to a combination of a predicted spectrum and the decoded and dequantized spectrum, where the generated spectrum is band-wise obtained from a source spectrum, the source spectrum being one of:
a second prediction spectrum; or
a random noise spectrum; or
the already generated parts of the generated spectrum ; or
a combination of at least two of the above.

Another embodiment may have a non-transitory digital storage medium having stored thereon a computer program for performing the above inventive methods when the computer medium is run by a computer.

An embodiment provides an encoder for encoding a spectral representation of audio signal (X_{MR}) divided into a plurality of sub-bands, wherein the spectral representation (X_{MR}) consists of frequency bins or of frequency coefficients and wherein at least one sub-band contains more than one frequency bin. The encoder comprises a quantizer and a band-wise parametric coder. The quantizer is configured to generate a quantized representation (X_{Q}) of the spectral representation of audio signal (X_{MR}) divided into plurality sub-bands. The band-wise parametric coder is configured to provide a coded parametric representation (zfl) of the spectral representation (X_{MR}) depending (based) on the quantized representation (X_{Q}), e.g. in a band-wise manner, wherein the coded parametric representation (zfl) consists of a parameter describing energy in sub-bands or a coded version of parameters describing energy in sub-bands; wherein there are at least two sub-bands being different and, thus, the corresponding parameters describing energy in at least two sub-bands are different. Note the at least two sub-bands may belong to the plurality of sub-bands.

An aspect of the present invention is based on finding that an audio signal or a spectral representation of the audio signal divided into a plurality of sub-bands can be efficiently coded in a band-wise manner (band-wise may mean per band/sub-band). According to embodiments the concept allows restricting the parametric coding only in the sub-bands that are quantized to zero by a quantizer (used for quantizing the spectrum). This concept enables an efficient joint coding of a spectrum and band-wise parameters, so that a high spectral resolution for the parametric coding is achieved, yet lower than the spectral resolution of a spectral coder can be achieved. The resulting coder is defined as an integral band-wise parametric coding entity within a waveform preserving coder. According to embodiments, the band-wise parametric coder together with a spectrum coder are configured to jointly obtain a coded version of the spectral representation of audio signal (X_{MR}). This joint coder concept has the benefit that the bitrate distribution between the two coders may be done jointly.

According to further embodiments, at least one sub-band is quantized to zero. For example, the parametric coder determines which sub-bands are zero and codes (just) a representation for the sub-bands that are zero. According to embodiments, at least two sub-bands may have different parameters.

According to embodiments the spectral representation is perceptually flattened. This may be done, for example, by use of a spectral shaper which is configured for providing a perceptually flattened spectral representation from the spectral representation based on a spectral shape obtained from a coded spectral shape. Note, the perceptually flattened spectral representation is divided into sub-bands of different or higher frequency resolution than the coded spectral shape.

According to further embodiments, the encoder may further comprise a time-spectrum converter, like an MDCT converter configured to convert an audio signal having a sampling rate into a spectral representation. Starting from said enhancements, the band-wise parametric coder is configured to provide parametric representation of the perceptually flattened spectral representation, or a derivative of the spectrally flattened spectral representation, where the parametric representation may depend on the optimal quantization step and may consist of parameters describing energy in sub-bands, wherein the quantized spectrum is zero, so that at least two sub-bands have different parameters or that at least one parameter is restricted to only one sub-band.

According to further embodiments, the spectral representation is used to determine the optimal quantization step. For example, the encoder can be enhanced by use of a so called rate distortion loop configured to determine a quantization step. This enables that said rate distortion loop determines or estimates an optimal quantization step as used above. This may be done in that way, that said loop performs several (at least two) iteration steps, wherein the quantization step is adapted dependent on one or more previous quantization steps.

In order to code the representation of the quantized spectrum the encoder may further comprise a lossless spectrum coder. According to further embodiments the encoder comprises the spectrum coder and/or spectrum coder decision entity configured to provide a decision if a joint coding of the coded representation of the quantized spectrum and a coded representation of the parametric representation fulfills a constraint that a total number of bits for the joint coding is below a predetermined threshold. This especially makes sense, when both the encoded representation of the quantized spectrum and the coded representation of the parametric spectrum are based on a variable number of bits (optional feature) dependent on the spectral representation or dependent on a derivative of the perceptually flattened spectral representation and the quantization step. According to further embodiments both the band-wise parametric coder as well as the spectrum coder form a joint coder which enables the interaction, e.g., to take into account parameters used for both, e.g. the variable number of bits or the quantization step.

According to further embodiments the encoder further comprises a modifier configured to adaptively set at least a sub-band in the quantization step to zero dependent on a content of the sub-band in the quantized spectrum and/or in the spectral representation.

According to further embodiments the band-wise parametric coder comprises two stages, wherein the first stage of the two stages of the band-wise parametric coder is configured to provide individual parametric representations of the sub-bands above a frequency, and where the second stage of the two stages provides an additional average parametric representation for the sub-bands above the frequency, e.g. based on the parametric representations of the (individual) sub-bands, where the individual parameter representation is zero and for sub-bands below the frequency.

According to an embodiment this encoder may be implemented by a method, namely a method for encoding an audio signal comprising the following steps:
generating a quantized representation X_{Q} of the spectral representation of audio signal X_{MR} divided into plurality of sub-bands;
providing a coded parametric representation zfl of the spectral representation X_{MR} depending on the quantized representation X_{Q}, wherein the coded parametric representation zfl consists of parameters describing the spectral representation X_{MR} in the sub-bands or coded versions of the parameters; wherein there are at least two sub-bands being different and parameters describing the spectral representation X_{MR} in the at least two sub-bands being different.

Here, there are at least two sub-bands that are different and, thus, the parameters describing energy in at least two sub-bands are different.

Another embodiment provides a decoder. The decoder comprises a spectral domain decoder and band-wise parametric decoder. The spectral domain decoder is configured for generating a decoded spectrum or dequantized (and decoded) spectrum based on an encoded audio signal, wherein the decoded spectrum is divided into sub-bands. Optionally the spectral domain decoder uses for the decoding/dequantizing an information on a quantization step. The band-wise parametric decoder is configured to identify zero sub-bands in the decoded and/or dequantized spectrum and to decode a parametric representation of the zero sub-bands based on the encoded audio signal. Here, wherein the parametric representation comprises parameters describing the sub-bands, e.g. energy in the sub-bands, and wherein there are at least two sub-bands being different and, thus, parameters describing the at least two sub-bands being different; note the identifying can be performed based on the decoded and dequantized spectrum or just a spectrum, referred to as decoded spectrum, processed by the spectral domain decoder without the dequantization step. additionally or alternatively, the coded parametric representation is coded by use of a variable number of bits and/or wherein the number of bits used for representing the coded parametric representation is dependent on the spectral representation of audio signal. Expressed in other words, this means, that the decoder is configured to generate a decoded output from a jointly coded spectrum and band-wise parameters.

Another embodiment provides another decoder, having the following entities: spectral domain decoder, band-wise parametric decoder in combination with band-wise spectrum generator, a combiner, and spectrum-time converter. The spectral domain decoder, band-wise parametric decoder may be defined described as above; alternatively another parametric decoder, like from the IGF (cf. [7-14]) may be used. The band-wise spectrum generator is configured to generate a band-wise generated spectrum dependent on the parametric representation of the zero sub-bands. The combiner is configured to provide a band-wise combined spectrum, where the band-wise combined spectrum comprises a combination of the band-wise generated spectrum and the decoded spectrum or a combination of the band-wise generated spectrum and a combination of a predicted spectrum and the decoded spectrum. The spectrum-time converter is configured for converting the band-wise combined spectrum or a derivative thereof (e.g. e reshaped spectrum, reshaped by an SNS or TNS or alternatively reshaped by use of a LP predictor) into a time representation.

The band-wise parametric decoder may according to embodiments be configured to decode a parametric representation of the zero sub-bands (E_{B}) based on the encoded audio signal using the quantization step. According to further embodiments the decoder comprises a spectrum shaper which is configured for providing a reshaped spectrum from the band-wise combined spectrum, or a derivative of the band-wise combined spectrum. For example, the spectrum shaper may use spectral shape obtained from a coded spectral shape of different or lower frequency resolution than the sub-band division.

According to further embodiments the parametric representation consists of parameters describing energy in the zero sub-bands, so that at least two sub-bands have different parameters or that at least one parameter is restricted to only one sub-band. Note, the zero sub-bands are defined by the decoded and/or dequantized spectrum output of the spectrum decoder.

According to another embodiment, a band-wise parametric spectrum generator may be provided together with the above decoder or independent. The parametric spectrum generator is configured to generate a generated spectrum that is added to the decoded and dequantized spectrum or to a combination of a predicted spectrum and the decoded spectrum. Note the step of adding to the decoded and dequantized spectrum is, for example performed, when there is no LTP in a system is present. Here, the generated spectrum (X_{G}) may be band-wise obtained from a source spectrum, the source spectrum being one of:
a second prediction spectrum (X_{NP}); or
a random noise spectrum (X_{N}); or
the already generated parts of the generated spectrum; or
a combination of one of the above.

The decoder may be implemented by a method. The method for decoding an audio signal comprises:
generating a decoded and dequantized spectrum (X_{D}) from the coded representation of spectrum (spect), wherein the decoded and dequantized spectrum (X_{D}) is divided into sub-bands;
identifying zero sub-bands in the decoded and dequantized spectrum (X_{D}) and decoding a parametric representation of the zero sub-bands (E_{B}) based on the coded parametric representation (zfl),

Note the parametric representation (E_{B}) comprises parameters describing sub-bands and wherein there are at least two sub-bands being different and, thus, parameters describing at least two sub-bands being different and/or wherein the coded parametric representation (zfl) is coded by use of a variable number of bits and/or wherein the number of bits used for representing the coded parametric representation (zfl) is dependent on the coded representation of spectrum (spect).

Alternatively, the method comprises the following steps:
generating a decoded and dequantized spectrum (X_{D}) based on an encoded audio signal, wherein the decoded and dequantized spectrum (X_{D}) is divided into sub-bands;
identifying zero sub-bands in the decoded and dequantized spectrum (X_{D}) and to decode a parametric representation of the zero sub-bands (E_{B}) based on the encoded audio signal;
generating a band-wise generated spectrum dependent on the parametric representation of the zero sub-bands (E_{B});
providing a band-wise combined spectrum (X_{CT}); where the band-wise combined spectrum (X_{CT}) comprises a combination of the band-wise generated spectrum and the decoded and dequantized spectrum (X_{D}) or a combination of the band-wise generated spectrum and a combination (X_{DT}) of a predicted spectrum (X_{PS}) and the decoded and dequantized spectrum (X_{D}); and
   converting the band-wise combined spectrum (X_{CT}) or a derivative of the band-wise combined spectrum (X_{CT}) into a time representation.

The above discussed generator may be implemented by a method for generating a generated spectrum that is added to the decoded and dequantized spectrum or to a combination of a predicted spectrum and the decoded spectrum, where the generated spectrum is band-wise obtained from a source spectrum, the source spectrum being one of:
a second prediction spectrum; or
a random noise spectrum; or
the already generated parts of the generated spectrum; or
a combination of one of the above.

Note the source spectrum can be derived from any of the listed possibilities.

According to embodiments the source spectrum is weighted based on energy parameters of zero sub-bands. According to further embodiments a choice of the source spectrum for a sub-band is dependent on the sub-band position, tonality information, the power spectrum estimation, energy parameters, pitch information and/or temporal information. Note the tonality information may be ϕ_{H}, and/or pitch information may be d̅_{F}_{₀}, and/or a temporal information may be the information if TNS is active or not.

According to embodiments, the source spectrum is weighted based on the energy parameters of zero bands.

It should be noted, that all of the above-discussed methods may be implemented using a computer program.

### BRIEF DESCRIPTION OF THE DRAWINGS

Embodiments of the present invention will subsequently be discussed referring to the enclosed figures, wherein:

FIG. 1a shows schematic representation of a basic implementation of an encoder having a band-wise parametric coder according to an embodiment;

FIGS. 1b shows schematic representation of another implementation of an encoder having band-wise parametric coder according to an embodiment;

FIG. 1c shows schematic representation of an implementation of a decoder according to an embodiment;

FIG. 2a shows a schematic block diagram illustrating an encoder according to an embodiment and a decoder according to another embodiment;

FIG. 2b shows a schematic block diagram illustrating an excerpt of FIG. 2a comprising the according to an embodiment;

FIG. 2c shows a schematic block diagram illustrating excerpt of FIG. 2a comprising the decoder according to another embodiment;

FIG. 3 shows a schematic block diagram of a signal encoder for the residual signal according to embodiments and a decoder according to another embodiment;

FIG. 4 shows a schematic block diagram of a decoder comprising the principle of zero filling according to further embodiments;

FIG. 5 shows a schematic diagram for illustrating the principle of determining the pitch contour (cf. block gap pitch contour) according to embodiments;

FIG. 6 shows a schematic block diagram of an pulse extractor using an information on a pitch contour according to further embodiments;

FIG. 7 shows a schematic block diagram of a pulse extractor using the pitch contour as additional information according to an alternative embodiment;

FIG. 8 shows a schematic block diagram illustrating a pulse coder according to further embodiments;

FIGS. 9a-9b show schematic diagrams for illustrating the principle of spectrally flattening a pulse according to embodiments;

FIG. 10 shows a schematic block diagram of a pulse coder according to further embodiments;

FIGS. 11a-11b show a schematic diagram illustrating the principle of determining a prediction residual signal starting from a flattened original;

FIG. 12 shows a schematic block diagram of a pulse coder according to further embodiments;

FIG. 13 shows a schematic diagram illustrating a residual signal and coded pulses for illustrating embodiments;

FIG. 14 shows a schematic block diagram of a pulse decoder according to further embodiments;

FIG. 15 shows a schematic block diagram of a pulse decoder according to further embodiments;

FIG. 16 shows a schematic flowchart illustrating the principle of estimating an optimal quantization step (i.e. step size) using the block IBPC according to embodiments;

FIGS. 17a-17d show schematic diagrams for illustrating the principle of long-term prediction according to embodiments; and

FIGS. 18a-18d show schematic diagrams for illustrating the principle of harmonic post-filtering according to further embodiments.

### DETAILED DESCRIPTION OF THE INVENTION

Below, embodiments of the present invention will subsequently be discussed referring to the enclosed figures, wherein identical reference numerals are provided to objects having identical or similar functions, so that the description thereof is mutually applicable and interchangeable.

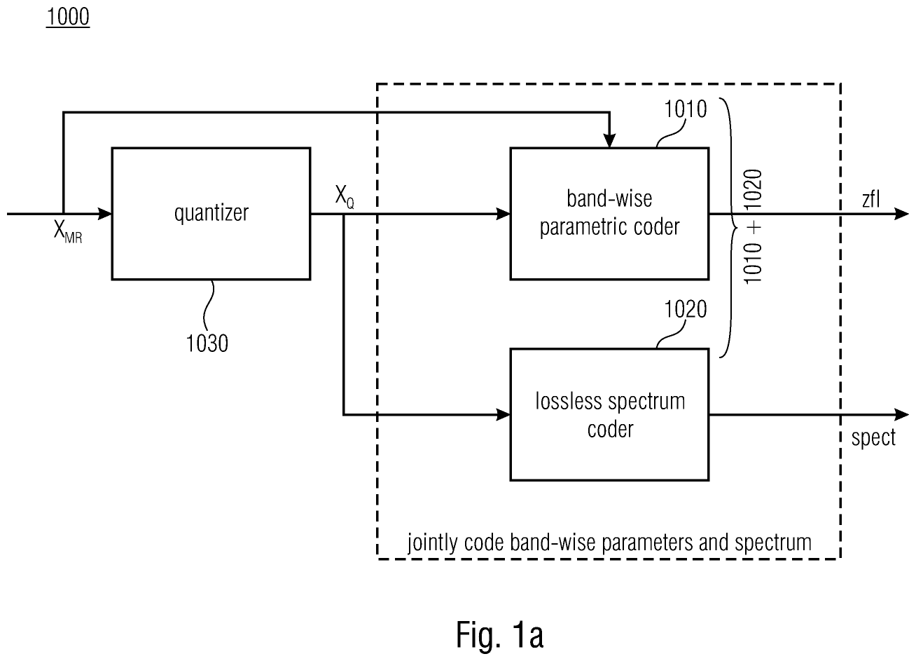

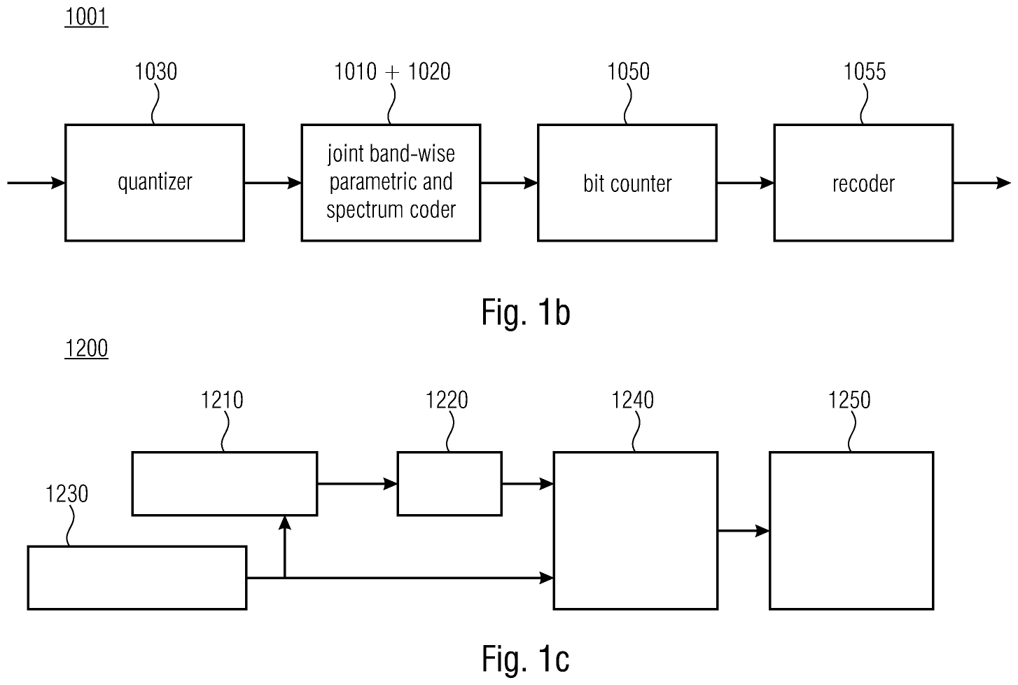

FIG. 1a shows an encoder 1000 comprising a quantizer 1030, a band-wise parametric coder 1010 and an optional (lossless) spectrum coder 1020. Before discussing the band-wise parametric coder 1010 the surrounding for the same will be discussed. In the surrounding of the parametric coder 1010, the encoder 1000 comprises a plurality of optional elements.

According to embodiments, the parametric coder 1010 is coupled with the spectrum coder or lossless spectrum coder 1020, so as to form a joint coder 1010 plus 1020. The signal to be processed by the joint coder 1010 plus 1020 is provided by the quantizer 1030, while the quantizer 1030 uses spectral representation of audio signal X_{MR} divided into plurality sub-bands as input.

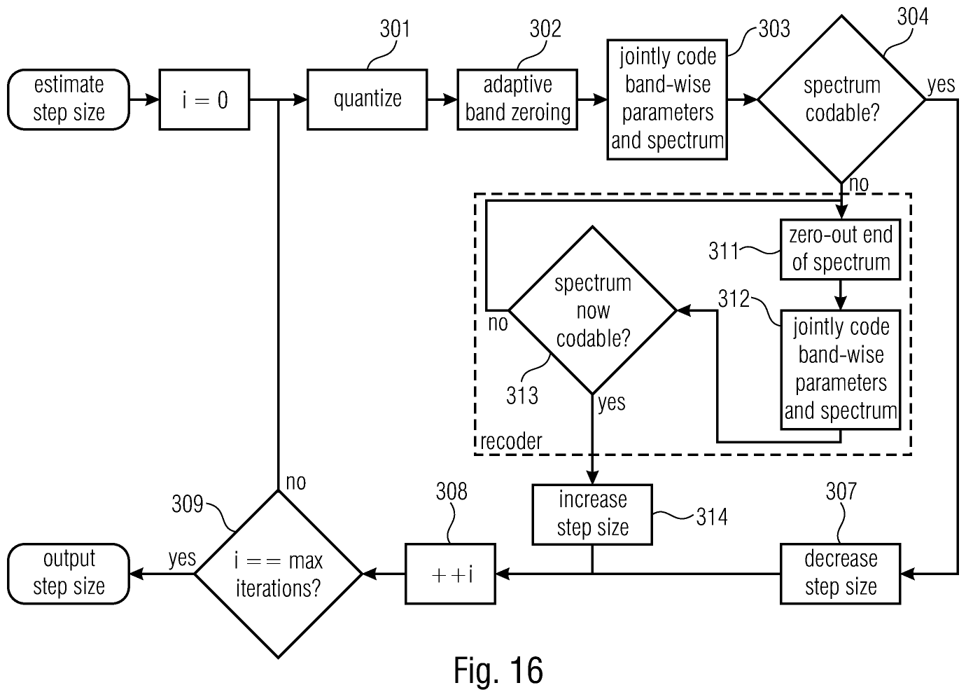

The quantizer 1030 quantizes X_{MR} to generate a quantized representation X_{Q} of the spectral representation of audio signal X_{MR} (divided into plurality sub-bands). Optionally, the quantizer may be configured for providing a quantized spectrum of a perceptually flattened spectral representation, or a derivative of the perceptional flattened spectral representation. The quantization may be dependent on the optimal quantization step, which is according to further embodiments determined iteratively (cf. FIG. 16).

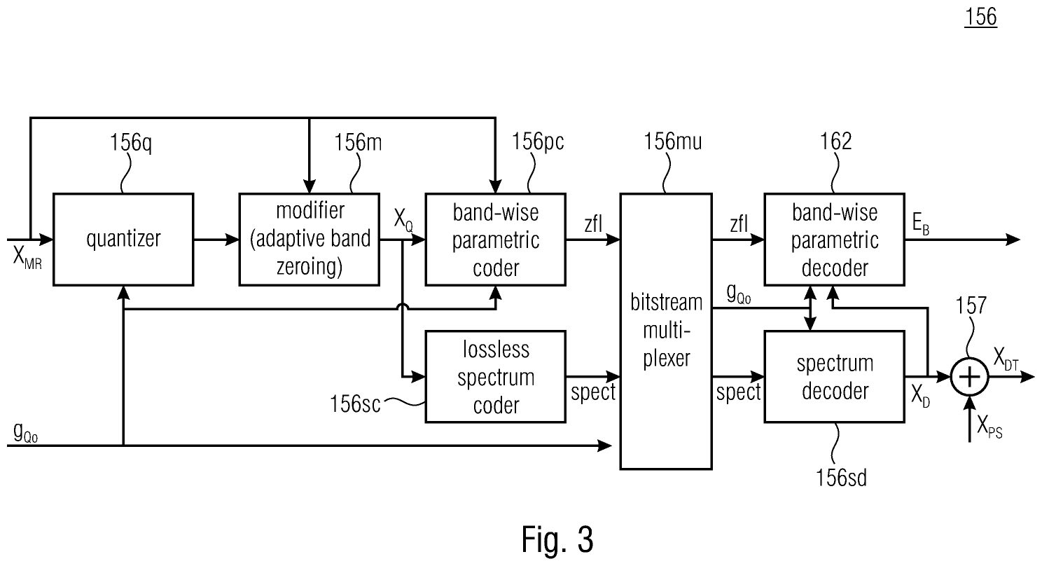

Both coders 1010 and 1020 receive the quantized representation X_{Q}, i.e. the signal X_{MR} preprocessed by a quantizer 1030 and an optional modifier (not shown in FIG. 1a, but shown as 156m in FIG. 3). The parametric coder 1010 checks which sub-bands in X_{Q} are zero and codes a representation of X_{MR} for the sub-bands that are zero in X_{Q}. Regarding the modifier it should be noted that same provides for the joint coder 1010 plus 1020 a quantized and modified audio signal (as shown in FIG. 3). For example, the modifier may set different sub-bands to zero as will be discussed with respect to FIG. 16 (in FIG. 16 the modifier is marked with 302).

According to embodiments, the coded parametric representation (zfl) uses variable number of bits. For example the number of bits used for representing the coded parametric representation (zfl) is dependent on the spectral representation of audio signal (X_{MR}).

According to embodiments, the coded representation (spect) uses variable number of bits or that the number of bits used for representing the coded representation (spect) is dependent on the spectral representation of audio signal (X_{MR}). Note the coded representation (spect) may be obtained by the lossless spectrum coder.

According to embodiments, the (sum of) number of bits needed for representing the coded parametric representation (zfl) and the coded representation (spect) may be below a predetermined limit.

According to embodiments, the parameters describe energy only in sub-bands for which the quantized representation (X_{Q}) is zero (that is all frequency bins of X_{Q} in the sub-bands are zero). Other parametric representations of zero sub-bands may be used. This may be a specification of “depending on the quantized representation (X_{Q})”.

According to embodiments, the band-wise parametric coder 1010 is configured to provide a parametric description of sub-bands quantized to zero. The parametric representation may depend on an optimal quantization step (cf. step size in FIG. 16 and g_{Q}_{₀} in FIG. 3) and may consist of parameters describing energy in sub-bands where the quantized spectrum is zero, so that at least two sub-bands have different parameters or that at least one parameter is restricted to only one sub-band. The lossless spectrum coder 1020 is configured to provide a coded representation of the (quantized) spectrum. This joint coding 1010 plus 1020 is of high efficiency, especially enables high spectral resolution of the parametric coding 1010 and yet lower than the spectral resolution of the spectrum coder 1020.

The above approach further allows restricting the parametric coding only in the sub-bands that are quantized to zero by a quantizer used for quantizing the spectrum. Due to the usage of a modifier it is additionally possible to provide an adaptive way of distributing bits between the band-wise parametric coder 1010 and the spectrum coder 1020, each of the coder taking into account the bit demand of the other, and allows fulfillment of bitrate limit.

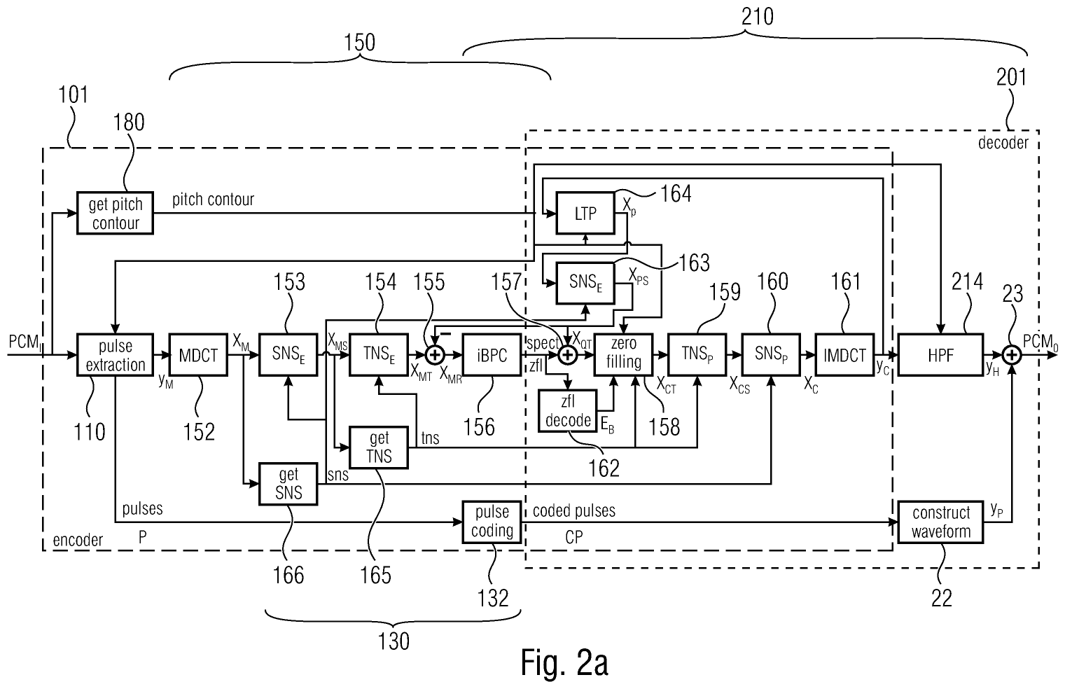

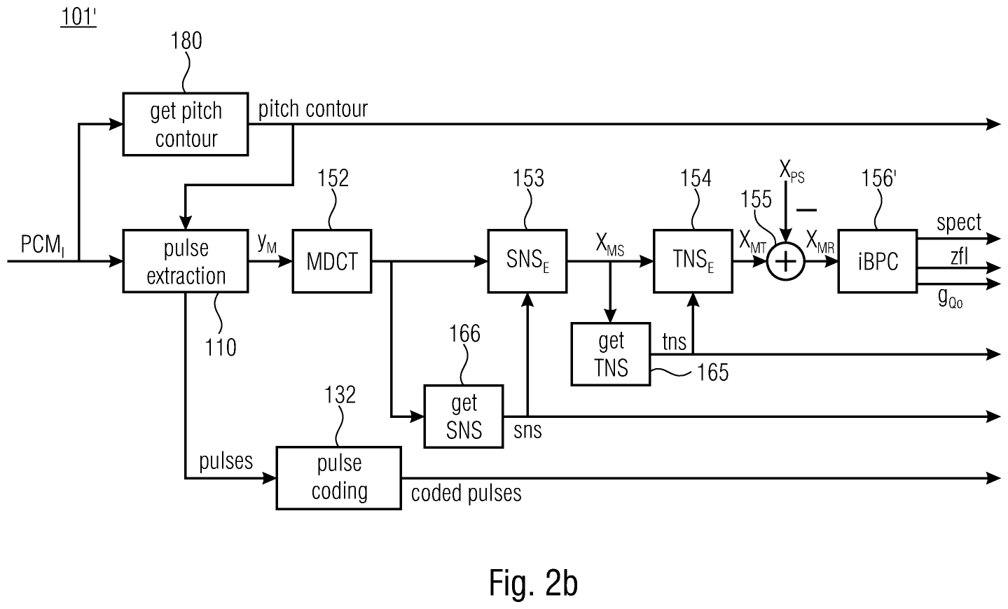

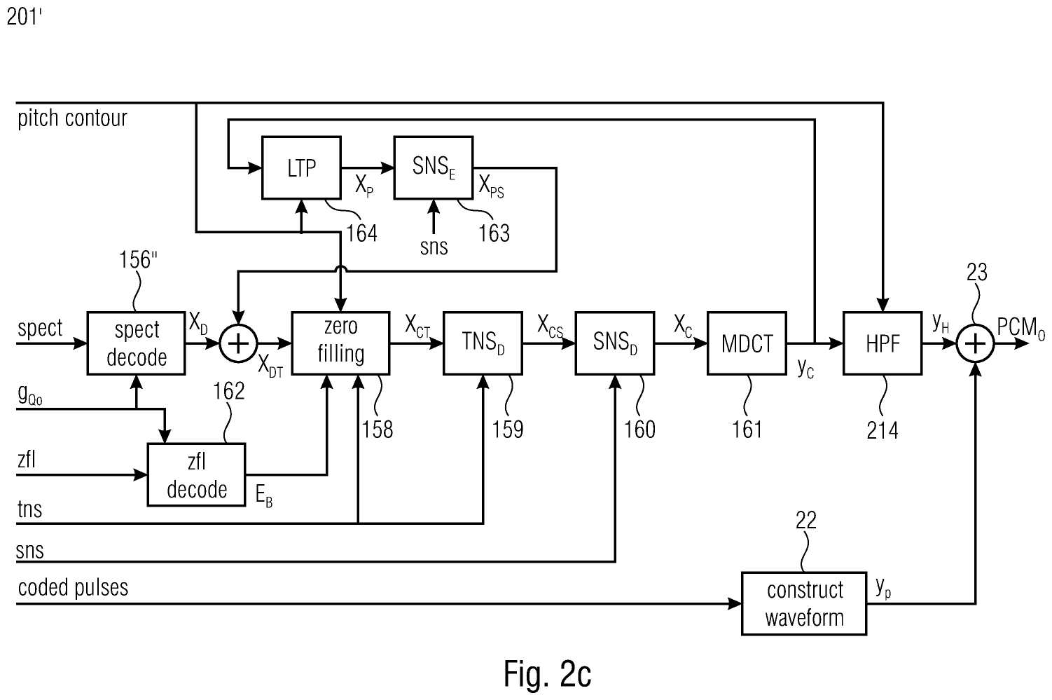

According to further embodiments the encoder 1000 may comprise an entity like a divider (not shown) which is configured to divide the spectral representation of the audio signal into said sub-bands. Optionally or additionally, the encoder 1000 may comprise in the upstream path a TDtoFD transformer (not shown), like the MDCT transformer (cf. entity 152, MDCT or comparable) configured to provide the spectral representation based on a time domain audio signal. Further optional elements are a temporal noise shaping (TNS_{E} cf. 154 of FIG. 2a) and entity 155 combining the signals X_{MS}, X_{MT} and X_{PS} of the spectrum shaper SNS/the Temporal Noise Shaping TNS_{E}.

At the output of the audio signal 1010 plus 1020 a bit stream multiplexer (not shown) may be arranged. The multiplexer has the purpose to combine the band-wise parametric coded and spectrum coded bit stream.

According to embodiments, the output of the MDCT 152 is X_{M} of length L_{M}. For an example at the input sampling rate of 48 kHz and for the example frame length of 20 milliseconds, L_{M} is equal to 960. The codec may operate at other sampling rates and/or at other frame lengths. All other spectra derived from X_{M}: X_{MS}, X_{MT}, X_{MR}, X_{Q}, X_{D}, X_{DT}, X_{CT}, X_{CS}, X_{C}, X_{P}, X_{PS}, X_{N}, X_{NP}, X_{S} may also be of the same length L_{M}, though in some cases only a part of the spectrum may be needed and used. A spectrum consists of spectral coefficients, also known as spectral bins or frequency bins. In the case of an MDCT spectrum, the spectral coefficients may have positive and negative values. We can say that each spectral coefficient covers a bandwidth. In the case of 48 KHz sampling rate and the 20 milliseconds frame length, a spectral coefficient covers the bandwidth of 25 Hz. The spectral coefficients may be for an example indexed from 0 to L_{M}−1.

SNS_{E}SNS_{D}N_{SB}=64N_{SB}−1N_{SB}=64 The SNS scale factors, used in and (cf. FIG. 2a), may be obtained from energies in frequency sub-bands (sometimes also referred to as bands) having increasing bandwidths, where the energies are obtained from a spectrum divided in the frequency sub-bands. For an example, the sub-bands borders, expressed in Hz, may be set to 0, 50, 100, 150, 200, 250, 300, 350, 400, 450, 500, 550, 600, 700, 800, 900, 1000, 1100, 1200, 1300, 1400, 1500, 1600, 1700, 1800, 1900, 2050, 2200, 2350, 2500, 2650, 2800, 2950, 3100, 3300, 3500, 3700, 3900, 4100, 4350, 4600, 4850, 5100, 5400, 5700, 6000, 6300, 6650, 7000, 7350, 7750, 8150, 8600, 9100, 9650, 10250, 10850, 11500, 12150, 12800, 13450, 14150, 15000, 16000, 24000. The sub-bands may be indexed from 0 to. In this example the 0^{th} sub-band (from 0 to 50 Hz) contains 2 spectral coefficients, the same as the sub-bands 1 to 11, the sub-band 62 contains 40 spectral coefficients and the sub-band 63 contains 320 coefficients. The energies in frequency sub-bands may be downsampled to 16 values which are coded, the coded values being denoted as “sns” (cf. FIG. 2a, FIG. 2b, FIG. 2c). The 16 decoded values obtained from “sns” are interpolated into SNS scale factors, where for example there may be 32, 64 or 128 scale factors. For more details on obtaining the SNS, the reader is referred to [21-25].

In iBPC, “zfl decode” and/or “Zero Filling” blocks, the spectra may be divided into sub-bands Bᵢ of varying length L_{B}_{ᵢ}, the sub-band i starting at j_{B}_{ᵢ}. The same 64 sub-band borders may be used as used for the energies for obtaining the SNS scale factors, but also any other number of sub-bands and any other sub-band borders may be used—independent of the SNS. To stress it out, the same principle of sub-band division as in the SNS may be used, but the sub-band division in iBPC, “zfl decode” and/or “Zero Filling” blocks is independent from the SNS and from SNS_{E} and SNS_{D} blocks. With the above sub-band division example, j_{B}_{₀}=0 and L_{B}_{₀}=2, j_{B}_{₁}=0 and L_{B}_{₁}=2, . . . , j_{B}_{₆₂}=600 and L_{B}_{₆₂}=40, j_{B}_{₆₃}=640 and L_{B}_{₆₃}=320.

In other example iBPC may be used in a codec where SNS_{E} is replaced with an LP analysis filter at the input of a time to frequency converter (e.g. at the input of 152) and where SNS_{D} is replaced with an LP synthesis filter at the output of a frequency to time converter (e.g. at the output of 161).

According to further embodiments the band-wise parametric coder 1010 is integrated into a rate distortion loop (cf. FIG. 16) thanks to an efficient modification of the quantized spectrum as it is illustrated by FIG. 1b.

FIG. 1b shows a part of rate distortion loop 1001. The part of rate distortion loop 1001 comprises the quantizer 1030, the joint band-wise parametric and spectrum coder 1010-1020, a bit counter 1050 and a recoder 1055. The recoder 1055 is configured to recode the spectrum and the band-wise parameters (as shown for example in detail by FIG. 16). For example, the bit counter 1050 may estimate/calculate/recalculate the bits needed for the coding of the spectral lines in order to reach an efficient way for storing the bits needed for coding. Expressed in other words, instead of an actual coding, an estimation of maximum number of bits needed for the coding may be performed. This helps to perform an efficient coding having a limited bit budget. Note FIG. 1b shows a part of FIG. 16: Here, 1030 is comparable to 301, 1010+1020 is comparable to 303, 1050 is 304, 1055 is comparable to the “recoder”. Thus, according to embodiments, the rate distortion loop comprises a bit counter 1050 configured to estimate or calculated bits used for the coding and/or a recoder 1055 configured to recode the parameters describing the spectral representation (X_{MR}), e.g. spectrum parameters and the band-wise parameters.

Note, although in FIGS. 1a and 1b same blocks are used indicating that the block have same functionality, it should be noted that the entity of FIG. 1a (part of FIG. 3) differs from the entity of FIG. 1b (part of FIG. 16).

With respect to FIG. 1c a decoder 1200 will be discussed. FIG. 1c shows a decoder for decoding an audio signal. It comprises the spectral domain decoder 1230, the band-wise parametric decoder 1210 being arranged in a processing path with the band-wise spectrum generator 1220, wherein the band-wise parametric decoder 1210 uses output of the spectrum decoder 1230. Both decoders have an output to a combiner 1240, wherein a spectrum-time converter 1250 is arranged at the output of the combiner 1240.

The spectral domain decoder 1230 (which may comprise a dequantizer in combination with a decoder) is configured for generating a dequantized spectrum (X_{D}) dependent on a quantization step, wherein the dequantized spectrum is divided into sub-bands. The band-wise parametric decoder 1210 identifies zero sub bands i.e., sub-bands consisting only of zeros, in the dequantized spectrum and decodes energy parameters of the zero sub-bands wherein the zero sub-bands are defined by the dequantized spectrum output of the spectrum decoder. For this an information, e.g. regarding the quantized representation (X_{Q}) taken from an output of the spectrum decoder 1230 may be used, since which sub-bands have a parametric representation depends on a decoded spectrum obtained from spect. Note the output of 1230 used as input for 1220 can have an information on the decoded spectrum or an derivative thereof like an information on the dequantized spectrum, since both the decoded spectrum and the dequantized spectrum may have the same zero sub-bands. The decoded spectrum obtained from spect may contain the same information as the input to 1010+1020 in FIG. 1a. The quantization step q_{Q}_{₀} may be used for obtaining the dequantized spectrum (X_{D}) from the decoded spectrum. The location of zero sub-bands in the decoded spectrum and/or in the dequantized spectrum may be determined independent of the quantization step q_{Q}_{₀}.

Starting from this, the band-wise generator 1220 provides a band-wise generated spectrum X_{G} depending on the parametric representation of the zero sub-bands. The combiner 1240 provides a band-wise combined spectrum X_{CT}. For example, for the combined spectrum X_{CT} the following combinations are possible:
the band-wise generated spectrum X_{G} and the decoded spectrum X_{D}; or
the band-wise generated spectrum X_{G} and a combination of the predicted spectrum and the decoded spectrum X_{DT}.

In other words the interaction of the entities 1220, 1230 with the entity 1240 can be described as follows: The band-wise parametric spectrum generator 1220 provides a generated spectrum X_{G} that is added to the decoded spectrum or to a combination of the predicted spectrum and the decoded spectrum by the entity 1240. The generated spectrum X_{G} is band-wise obtained from a source spectrum, the source spectrum being a second prediction spectrum X_{NP} or a random noise spectrum X_{N} or the already generated parts of the generated spectrum or a combination of them. Note, X_{CT} may contain X_{G}. The already generated parts of X_{CT} may be used to generate X_{G}. The source spectrum may be weighted based on the energy parameters of zero sub-bands. The choice of the source spectrum for a sub-band may be on the band position, tonality, power spectrum estimation, energy parameters, pitch parameter and temporal information. This method obtains the choice of sub-bands that are parametrically coded based on a decoded spectrum, thus avoiding additional side information in a bit stream. According to another way in this adaptive method, it is decided for each sub-band which source spectrum to use for replacing zeros in a sub-band is provided in the decoder 1200, thus avoiding additional side information in a bit stream and allowing a big number of possibilities for the source spectrum choice.

The output of the combiner 1240 can be further processed by an optional TNS or SNS_{D} (not shown) to obtain a so-called reshaped spectrum. Based on the output of the combiner 1240 or based on this reshaped spectrum the optional spectrum-time converter 1250 outputs a time representation. According to further embodiments, the decoder 1200 may comprise a spectrum shaper for providing a reshaped spectrum from the band-wise combined spectrum of from a derivative of the band-wise combined spectrum.

According to further embodiments the encoder may comprise a spectrum coder decision entity for providing a decision, if a joint coding or a coded representation of the quantized spectrum and a coded representation of the parametric zero sub-bands representation fulfills a constraint that the total number of bits of the joint coding is below a predetermined limit. Here, both the encoded representation of the quantized spectrum and the coded representation of parametric zero sub-bands may use a variable number of the bits dependent on the perceptually flattened spectral representation, or a derivative of the perceptually flattened spectral representation, and/or the quantization step.

As discussed above, the band-wise parametric spectrum generator and combiner 1240 may be implemented as follows. The band-wise parametric spectrum generator provides a generated spectrum in a band-wise manner and adds it to a decoded spectrum or to a combination of a predicted spectrum and the decoded spectrum. The generated spectrum is band-wise obtained from a source spectrum, the source spectrum being a second prediction spectrum or a random noise spectrum of already generated parts of the generated spectrum or a combination of them. The source spectrum may be weighted based on the energy parameters of zero-bands. The use of the already generated parts of the generated spectrum provides a combination of any two distinct parts of the decoded spectrum and thus a harmonic or tonal source spectrum not available by using just one part of the decoded spectrum. The combination of the second prediction spectrum and the source spectrum is another advantage for creating harmonic or tonal source spectrum not available by just using the decoded spectrum.

FIG. 2a shows an encoder 101 in combination with decoder 201.

The main entities of the encoder 101 are marked by the reference numerals 110, 130, 150. The entity 110 performs the pulse extraction, wherein the pulses p are encoded using the entity 132 for pulse coding.

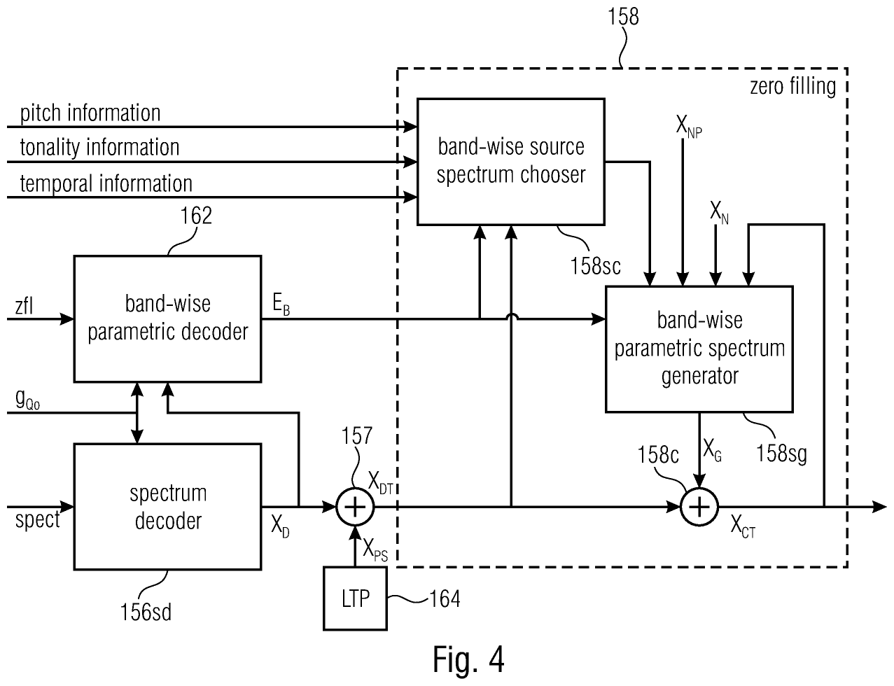

The signal encoder 150 is implemented by a plurality of entities 152, 153, 154, 155, 156, 157, 158, 159, 160 and 161. These entities 152-161 form the main path of the encoder 150, wherein in parallel, additional entities 162, 163, 164, 165 and 166 may be arranged. The entity 162 (zfl decoder) connects informatively the entities 156 (iBPC) with the entity 158 for Zero filling. The entity 165 (get TNS) connects informatively the entity 153 (SNSE) with the entity 154, 158 and 159. The entity 166 (get SNS) connects informatively the entity 152 with the entities 153, 163 and 160. The entity 158 performs zero filling an can comprise a combiner 158c which will be discussed in context of FIG. 4. Note there could be an implementation where the entities 153 and 160 do not exist—for example a system with an LP analysis filtering of the MDCT input and an LP synthesis filtering of the IMDCT output. Thus, these entities 153 and 160 are optional.

The entities 163 and 164 receive the pitch contour from the entity 180 and the coded residual yc so as to generate the predicted spectrum X_{P} and/or the perceptually flattened prediction X_{PS}. The functionality and the interaction of the different entities will be described below.

Before discussing the functionality of the encoder 101 and especially of the encoder 150 a short description of the decoder 210 is given. The decoder 210 may comprise the entities 157, 162, 163, 164, 158, 159, 160, 161 as well as encoder specific entities 214 (HPF), 23 (signal combiner) and 22 (for decoding and reconstructing the pulse portion consisting of reconstructed pulse waveforms).

Below, the encoding functionality will be discussed: The pulse extraction 110 obtains an STFT of the input audio signal PCM_{I}, and uses a non-linear magnitude spectrogram and a phase spectrogram of the STFT to find and extract pulses, each pulse having a waveform with high-pass characteristics. Pulse residual signal ym is obtained by removing pulses from the input audio signal. The pulses are coded by the Pulse coding 132 and the coded pulses CP are transmitted to the decoder 201.

y_{M}X_{M}L_{M}X_{M}SNS_{E}X_{MS}TNS_{E}X_{MT}ϕ_{H}X_{M}X_{MS}X_{MT}LTPX_{P}X_{PS}X_{MT}LTPX_{MR} The pulse residual signal is windowed and transformed via the MDCT 152 to produce of length. The windows are chosen among 3 windows as in [19]. The longest window is 30 milliseconds long with 10 milliseconds overlap in the example below, but any other window and overlap length may be used. The spectral envelope of is perceptually flattened via 153 obtaining. Optionally Temporal Noise Shaping 154 is applied to flatten the temporal envelope, in at least a part of the spectrum, producing. At least one tonality flag in a part of a spectrum (in or or) may be estimated and transmitted to the decoder 201/210. Optionally Long Term Prediction 164 that follows the pitch contour 180 is used for constructing a predicted spectrum from a past decoded samples and the perceptually flattened prediction is subtracted in the MDCT domain from , producing an residual. A pitch contour 180 is obtained for frames with high average harmonicity and transmitted to the decoder 201/210. The pitch contour 180 and a harmonicity is used to steer many parts of the codec. The average harmonicity may be calculated for each frame.

FIG. 2b shows an excerpt of FIG. 2a with focus on the encoder 101′ comprising the entities 180, 110, 152, 153, 153, 155, 156′, 165, 166 and 132. Note 156 in FIG. 2a is a kind of a combination of 156′ in FIGS. 2b and 156″ in FIG. 2c. Note the entity 163 (in FIG. 2a, 2c) can be the same or comparable as 153 and is the inverse of 160.

According to embodiments, the encoder splits the input signal into frames and outputs for example for each frame at least one or more of the following parameters:
pitch contour
MDCT window choice, 2 bits
LTP parameters
coded pulses
sns, that is coded information for the spectral shaping via the SNS
tns, that is coded information for the temporal shaping via the TNS
global gain gQo, that is the global quantization step size for the MDCT codec
spect, consisting of the entropy coded quantized MDCT spectrum
zfl, consisting of the parametrically coded zero portions of the quantized

X_{PS} is coming from the LTP which is also used in the encoder, but the LTP is shown only in the decoder (cf. FIGS. 2a and 2c).

FIG. 2c shows excerpt of FIG. 2a with focus on the encoder 201′ comprising the entities 156″, 162, 163, 164, 158, 159, 160, 161, 214, 23 and 22 which have been discussed in context of FIG. 2a. Regarding the LTP 164: Basically, the LTP is a part of the decoder (except HPF, “Construct waveform” and their outputs) that may be also used/required in the encoder (as part of an internal decoder). In implementations without the LTP, the internal decoder is not needed in the encoder.

The encoding of the X_{MR} (residual from the LTP) output by the entity 155 is done in the integral band-wise parameter coder (iBPC) as will be discussed with respect to FIG. 3.

FIG. 3 shows that the entity iBPC 156 which may have the sub-entities 156q, 156m, 156pc, 156sc and 156mu. Note FIG. 1a shows a part of FIG. 3: Here, 1030 is comparable to 156q, 1010 is comparable to 156pc, 1020 is comparable to 156sc.

At the output of the bit-stream multiplexer 156mu the band-wise parametric decoder 162 is arranged together with the spectrum decoder 156sd. The entity 162 receives the signal zfl, the entity 156sd the signal spect, where both may receive the global gain/step size g_{Q0}. Note the parametric decoder 162 uses the output X_{D} of the spectrum decoder 156sd for decoding zfl. It may alternatively use another signal output from the decoder 156sd. Background there of is that the spectrum decoder 156sd may comprise two parts, namely a spectrum lossless decoder and a dequantizer. For example, the output of the spectrum lossless decoder may be a decoded spectrum obtained from spect and used as input for the parametric decoder 162. The output of the spectrum lossless decoder may contain the same information as the input X_{Q} of 156pc and 156sc. The dequantizer may use the global gain/step size to derive X_{D} from the output of the spectrum lossless decoder. The location of zero sub-bands in the decoded spectrum and/or in the dequantized spectrum X_{D} may be determined independent of the quantization step q_{Q}_{₀}.

X_{MR} is quantized and coded including a quantization and coding of an energy for zero values in (a part of) the quantized spectrum X_{Q}, where X_{Q} is a quantized version of X_{MR}. The quantization and coding of X_{MR} is done in the Integral Band-wise Parametric Coder iBPC 156. As one of the parts of the iBPC, the quantization (quantizer 156q) together with the adaptive band zeroing 156m produces, based on the optimal quantization step size g_{Qo}, the quantized spectrum X_{Q}. The iBPC 156 produces coded information consisting of spect 156sc (that represents X_{Q}) and zfl 162 (that may represent the energy for zero values in a part of X_{Q}).

The zero-filling entity 158 arranged at the output of the entity 157 is illustrated by FIG. 4.

FIG. 4 shows a zero-filling entity 158 receiving the signal E_{B} from the entity 162 and a combination (X_{DT}) of a predicted spectrum (X_{PS}) and the decoded and dequantized spectrum (X_{D}) from the entity 156sd optionally via the element 157. The zero-filling entity 158 may comprise the two sub-entities 158sc and 158sg as well as a combiner 158c.

The spect is decoded to obtain a dequantized spectrum X_{D} (decoded LTP residual, error spectrum) equivalent to the quantized version of X_{MR}. E_{B} are obtained from zfl taking into account the location of zero values in X_{D}. E_{B} may be a smoothed version of the energy for zero values in X_{Q}. E_{B} may have a different resolution than zfl, advantageously higher resolution coming from the smoothing. After obtaining E_{B} (cf. 162), the perceptually flattened prediction X_{PS} is optionally added to the decoded X_{D}, producing X_{DT}. A zero filling X_{G} is obtained and combined with X_{DT} (for example using addition 158c) in “Zero Filling”, where the zero filling X_{G} consists of a band-wise zero filling

$${X}_{{G}_{{B}_{i}}}$$

that is iteratively obtained from a source spectrum X_{S} consisting of a band-wise source spectrum

$${X}_{{G}_{{B}_{i}}}$$

(cf. 156sc) weighted based on E_{B}. X_{CT} is a band-wise combination of the zero filling X_{G} and the spectrum X_{DT} (158c). X_{S} is band-wise constructed (158sg, outputting X_{G}) and X_{CT} is band-wise obtained starting from the lowest sub-band. For each sub-band the source spectrum is chosen (cf. 158sc), for example depending on the sub-band position, the tonality flag (toi), a power spectrum estimated from X_{DT}, E_{B}, pitch information (pii) and temporal information (tei). Note power spectrum estimated from X_{DT} may be derived from X_{DT} or X_{D}. Alternatively a choice of the source spectrum may be obtained from the bit-stream. The lowest sub-bands

$${X}_{{S}_{{B}_{i}}}$$

in X_{S} up to a starting frequency f_{ZFStart} may be set to 0, meaning that in the lowest sub-bands X_{CT} may be a copy of X_{DT}. f_{ZFStart} may be 0 meaning that the source spectrum different from zeros may be chosen even from the start of the spectrum. The source spectrum for a sub-band i may for example be a random noise or a predicted spectrum or a combination of the already obtained lower part of X_{CT}, the random noise and the predicted spectrum. The source spectrum X_{S} is weighted based on E_{B} to obtain the zero filling X_{G}.

The weighting may, for example, be performed by the entity 158sg and may have higher resolution than the sub-band division; it may be even sample wise determined to obtain a smooth weighting.

$${X}_{{G}_{{B}_{i}}}$$

is added to the sub-band i of X_{DT} to produce the sub-band i of X_{CT}. After obtaining the complete X_{CT}, its temporal envelope is optionally modified via TNS_{D} 159 (cf. FIG. 2a) to match the temporal envelope of X_{MS}, producing X_{CS}. The spectral envelope of X_{CS} is then modified using SNS_{D} 160 to match the spectral envelope of X_{M}, producing X_{C}. A time-domain signal y_{C} is obtained from X_{C} as output of IMDCT 161 where IMDCT 161 consists of the inverse MDCT, windowing and the Overlap-and-Add. y_{C} is used to update the LTP buffer 164 (either comparable to the buffer 164 in FIGS. 2a and 2c, or to a combination of 164+163). for the following frame. A harmonic post-filter (HPF) that follows pitch contour is applied on y_{C} to reduce noise between harmonics and to output y_{H}. The coded pulses, consisting of coded pulse waveforms, are decoded and a time domain signal y_{P} is constructed from the decoded pulse waveforms. y_{P} is combined with y_{H} to produce the decoded audio signal (PCM_{O}). Alternatively y_{P} may be combined with y_{C} and their combination can be used as the input to the HPF, in which case the output of the HPF 214 is the decoded audio signal.

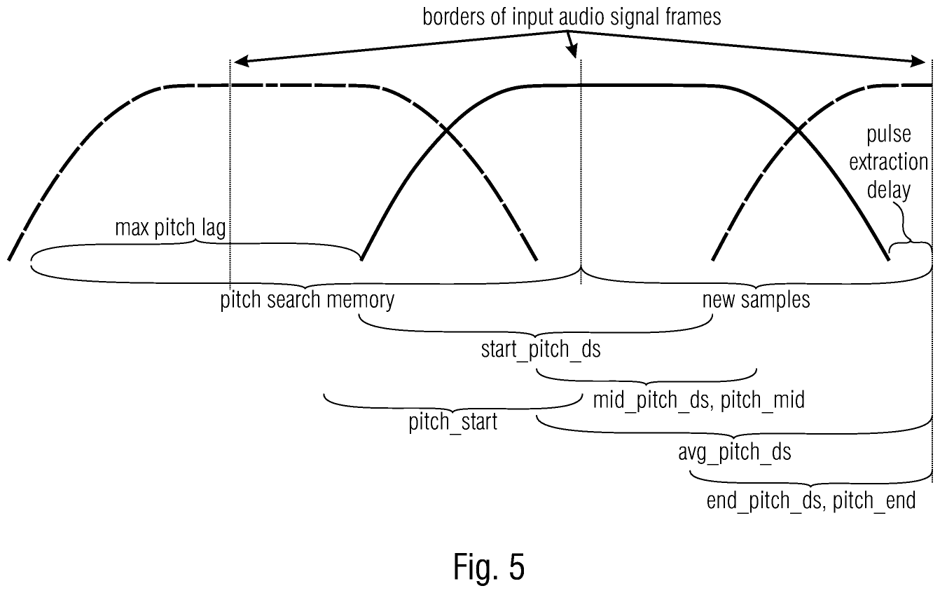

The entity “get pitch contour” 180 is described below taking reference to FIG. 5.

The process in the block “Get pitch contour 180” will be explained now. The input signal is downsampled from the full sampling rate to lower sampling rate, for example to 8 kHz. The pitch contour is determined by pitch_mid and pitch_end from the current frame and by pitch_start that is equal to pitch_end from the previous frame. The frames are exemplarily illustrated by FIG. 5. All values used in the pitch contour may be stored as pitch lags with a fractional precision. The pitch lag values are between the minimum pitch lag d_{Fmin}=2.25 milliseconds (corresponding to 444.4 Hz) and the maximum pitch lag d_{Fmax}=19.5 milliseconds (corresponding to 51.3 Hz), the range from d_{Fmin} to d_{Fmax} being named the full pitch range. Other range of values may also be used. The values of pitch_mid and pitch_end are found in multiple steps. In every step, a pitch search is executed in an area of the downsampled signal or in an area of the input signal.

The pitch search calculates normalized autocorrelation ρ_{H}[d_{F}] of its input and a delayed version of the input. The lags d_{F} are between a pitch search start d_{Fstart} and a pitch search end d_{Fend}. The pitch search start d_{Fstart}, the pitch search end d_{Fend}, the autocorrelation length l_{ρH} and a past pitch candidate d_{Fpast} are parameters of the pitch search. The pitch search returns an optimum pitch d_{Foptim}, as a pitch lag with a fractional precision, and a harmonicity level ρ_{Hoptim}, obtained from the autocorrelation value at the optimum pitch lag. The range of ρ_{Hoptim} is between 0 and 1, 0 meaning no harmonicity and 1 maximum harmonicity.

The location of the absolute maximum in the normalized autocorrelation is a first candidate d_{F1} for the optimum pitch lag. If d_{Fpast} is near d_{F1} then a second candidate d_{F2} for the optimum pitch lag is d_{Fpast}, otherwise the location of the local maximum near d_{Fpast} is the second candidate d_{F2}. The local maximum is not searched if d_{Fpast} is near d_{F1}, because then d_{F1} would be chosen again for d_{F2}. If the difference of the normalized autocorrelation at d_{F1} and d_{F2} is above a pitch candidate threshold τ_{dF}, then d_{Foptim} is set to d_{F1} (ρ_{H}[d_{F1}]−ρ_{H}[d_{F2}]>τ_{dF}⇒d_{Foptim}=d_{F1}), otherwise d_{Foptim} is set to d_{F2}. τ_{dF} is adaptively chosen depending on d_{F1}, d_{F2} and d_{Fpast}, for example τ_{dF}=0.01 if 0.75·d_{F1}≤d_{Fpast}≤1.25·d_{F1} otherwise τ_{dF}=0.02 if d_{F1}≤d_{F2} and τ_{dF}=0.03 if d_{F1}>d_{F2} (for a small pitch change it is easier to switch to the new maximum location and if the change is big then it is easier to switch to a smaller pitch lag than to a larger pitch lag).

Locations of the areas for the pitch search in relation to the framing and windowing are shown in FIG. 5. For each area the pitch search is executed with the autocorrelation length l_{ρH} set to the length of the area. First, the pitch lag start_pitch_ds and the associated harmonicity start_norm_corr_ds is calculated at the lower sampling rate using d_{Fpast}=pitch_start, d_{Fstart}=d_{Fmin} and d_{Fend}=d_{Fmax} in the execution of the pitch search. Then, the pitch lag avg pitch_ds and the associated harmonicity avg_norm_corr_ds is calculated at the lower sampling rate using d_{Fpast}=start_pitch_ds, d_{Fstart}=d_{Fmin} and d_{Fend}=d_{Fmax} in the execution of the pitch search. The average harmonicity in the current frame is set to max(start_norm_corr_ds,avg_norm_corr_ds). The pitch lags mid_pitch_ds and end_pitch_ds and the associated harmonicities mid_norm_corr_ds and end_norm_corr_ds are calculated at the lower sampling rate using d_{Fpast}=avg_pitch_ds, d_{Fstart}=0.3·avg_pitch_ds and d_{Fend}=0.7·avg_pitch_ds in the execution of the pitch search. The pitch lags pitch_mid and pitch_end and the associated harmonicities norm_corr_mid and norm_corr_end are calculated at the full sampling rate using d_{Fpast}=pitch_ds, d_{Fstart}=pitch_ds−Δ_{Fdown} and d_{Fend}=pitch_ds+Δ_{Fdown} in the execution of the pitch search, where Δ_{Fdown} is the ratio of the full and the lower sampling rate and pitch_ds=mid_pitch_ds for pitch_mid and pitch_ds=end_pitch_ds for pitch_end.

If the average harmonicity is below 0.3 or if norm_corr_end is below 0.3 or if norm_corr_mid is below 0.6 then it is signaled in the bit-stream with a single bit that there is no pitch contour in the current frame. If the average harmonicity is above 0.3 the pitch contour is coded using absolute coding for pitch_end and differential coding for pitch_mid. Pitch_mid is coded differentially to (pitch_start+pitch_end)/2 using 3 bits, by using the code for the difference to (pitch_start+pitch_end)/2 among 8 predefined values, that minimizes the autocorrelation in the pitch_mid area. If there is an end of harmonicity in a frame, e.g. norm_corr_end<norm_corr_mid/2, then linear extrapolation from pitch_start and pitch_mid is used for pitch_end, so that pitch_mid may be coded (e.g. norm_corr_mid>0.6 and norm_corr_end<0.3).

If |pitch_mid-pitch_start|≤τ_{HPFconst} and |norm_corr_mid-norm_corr_start|≤0.5 and the expected HPF gains in the area of the pitch_start and pitch_mid are close to 1 and don't change much then it is signaled in the bit-stream that the HPF should use constant parameters.

According to embodiments, the pitch contour provides d_{contour} a pitch lag value d_{contour}[i] at every sample i in the current window and in at least d_{Fmax} past samples. The pitch lags of the pitch contour are obtained by linear interpolation of pitch_mid and pitch_end from the current, previous and second previous frame.

An average pitch lag d̅_{F}_{₀} is calculated for each frame as an average of pitch_start, pitch_mid and pitch_end.

A half pitch lag correction is according to further embodiments also possible.

The LTP buffer 164, which is available in both the encoder and the decoder, is used to check if the pitch lag of the input signal is below d_{Fmin}. The detection if the pitch lag of the input signal is below d_{Fmin} is called “half pitch lag detection” and if it is detected it is said that “half pitch lag is detected”. The coded pitch lag values (pitch_mid, pitch_end) are coded and transmitted in the range from d_{Fmin} to d_{Fmax}. From these coded parameters the pitch contour is derived as defined above. If half pitch lag is detected, it is expected that the coded pitch lag values will have a value close to an integer multiple n_{Fcorrection} of the true pitch lag values (equivalently the input signal pitch is near an integer multiple n_{Fcorrection} of the coded pitch). To extended the pitch lag range beyond the codable range, corrected pitch lag values (pitch_mid_corrected, pitch_end_corrected) are used. The corrected pitch lag values (pitch_mid_corrected, pitch_end_corrected) may be equal to the coded pitch lag values (pitch_mid, pitch_end) if the true pitch lag values are in the codable range. Note the corrected pitch lag values may be used to obtain the corrected pitch contour in the same way as the pitch contour is derived from the pitch lag values. In other words, this enables to extend the frequency range of the pitch contour outside of the frequency range for the coded pitch parameters, producing a corrected pitch contour.

The half pitch detection is run only if the pitch is considered constant in the current window and d̅_{F}_{₀}<N_{Fcorrection}·d_{Fmin}. The pitch is considered constant in the current window if max(|pitch_mid-pitch_start|,|pitch_mid-pitch_end|)<τ_{Fconst}. In the half pitch detection, for each n_{Fmultiple}∈{1,2, . . . , n_{Fmaxcorrection}} pitch search is executed using l_{ρH}=d̅_{F}_{₀}, d_{Fpast}=d̅_{F}_{₀}/n_{Fmultiple}, d_{Fstart}=d_{Fpast}−3 and d_{Fend}=d_{Fpast}+3. n_{Fcorrection} is set to n_{Fmultiple} that maximizes the normalized correlation returned by the pitch search. It is considered that the half pitch is detected if n_{Fcorrection}>1 and the normalized correlation returned by the pitch search for n_{Fcorrection} is above 0.8 and 0.02 above the normalized correlation return by the pitch search for n_{Fmultiple}=1.

If half pitch lag is detected then pitch_mid_corrected and pitch_end_corrected take the value returned by the pitch search for n_{Fmultiple}=n_{Fcorrection}, otherwise pitch_mid_corrected and pitch_end_corrected are set to pitch_mid and pitch_end respectively.

An average corrected pitch lag d̅_{F}_{_{corrected}} is calculated as an average of pitch_start, pitch_mid_corrected and pitch_end_corrected after correcting eventual octave jumps. The octave jump correction finds minimum among pitch_start, pitch_mid_corrected and pitch_end_corrected and for each pitch among pitch_start, pitch_mid_corrected and pitch_end_corrected finds pitch/n_{Fmultiple} closest to the minimum (for n_{Fmultiple}∈{1,2, . . . , n_{Fmaxcorrection}}). The pitch/n_{Fmultiple} is then used instead of the original value in the calculation of the average.

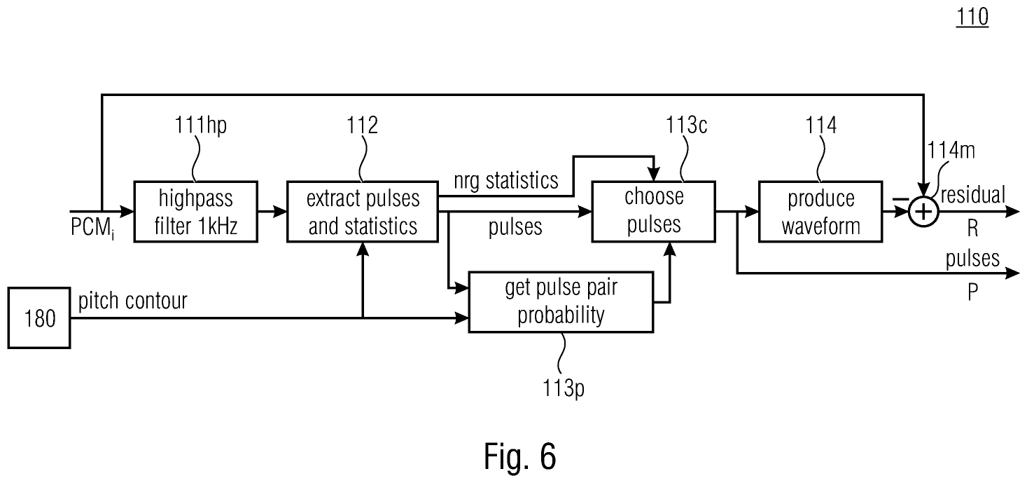

Below the pulse extraction may be discussed in context of FIG. 6. FIG. 6 shows the pulse extractor 110 having the entities 111hp, 112, 113c, 113p, 114 and 114m. The first entity at the input is an optional high pass filter 111hp which outputs the signal to the pulse extractor 112 (extract pulses and statistics).

At the output two entities 113c and 113p are arranged, which interact together and receive as input the pitch contour from the entity 180. The entity for choosing the pulses 113c outputs the pulses p directly into another entity 114 producing a waveform. This is the waveform of the pulse and can be subtracted using the mixer 114m from the PCM signal so as to generate the residual signal R (residual after extracting the pulses).

Up to 8 pulses per frame are extracted and coded. In another example other number of maximum pulses may be used. N_{P}_{ₚ} pulses from the previous frames are kept and used in the extraction and predictive coding (0≤N_{P}_{ₚ}≤3). In another example other limit may be used for N_{P}_{ₚ}. The “Get pitch contour 180” provides d̅_{F}_{₀}; alternatively, d̅_{F}_{_{corrected}} may be used. It is expected that d̅_{F}_{₀} is zero for frames with low harmonicity.

Time-frequency analysis via Short-time Fourier Transform (STFT) is used for finding and extracting pulses (cf. entity 112). In another example other time-frequency representations may be used. The signal PCM_{I} may be high-passed (111hp) and windowed using 2 milliseconds long squared sine windows with 75% overlap and transformed via Discrete Fourier Transform (DFT) into the Frequency Domain (FD). Alternatively, the high pass filtering may be done in the FD (in 112s or at the output of 112s). Thus in each frame of 20 milliseconds there are 40 points for each frequency band, each point consisting of a magnitude and a phase. Each frequency band is 500 Hz wide and we are considering only 49 bands for the sampling rate F_{S}=48 kHz, because the remaining 47 bands may be constructed via symmetric extension. Thus there are 49 points in each time instance of the STFT and 40·49 points in the time-frequency plane of a frame. The STFT hop size is H_{P}=0.0005 F_{S}.

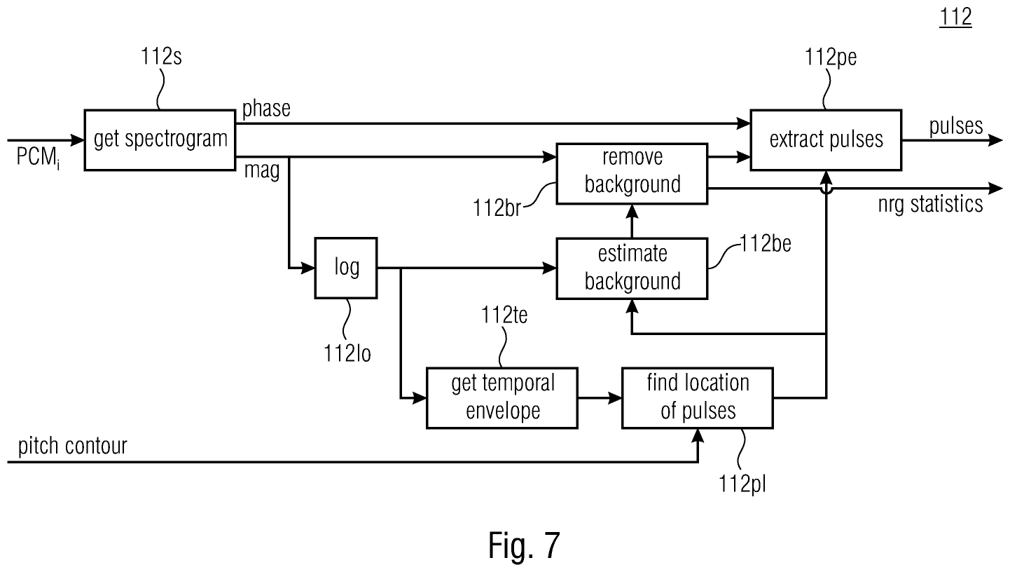

In FIG. 7 the entity 112 is shown in more details. In 112te a temporal envelope is obtained from the log magnitude spectrogram by integration across the frequency axis, that is for each time instance of the STFT log magnitudes are summed up to obtain one sample of the temporal envelope.

The shown entity 112 comprises a spectrogram entity 112s outputting the phase and/or the magnitude spectrogram based on the PCM_{I} signal. The phase spectrogram is forwarded to the pulse extractor 112pe, while the magnitude spectrogram is further processed. The magnitude spectrogram may be processed using a background remover 112br, a background estimator 112be for estimating the background signal to be removed. Additionally or alternatively a temporal envelope determiner 112te and a pulse locator 112pl processes the magnitude spectrogram. The entities 112pl and 112te enable to determine that pulse location(s) which are used as input for the pulse extractor 112pe and the background estimator 112be. The pulse locator finder 112pl may use a pitch contour information. Optionally, some entities, for example, the entity 112be and the entity 112te may use algorithmic representation of the magnitude spectrogram obtained by the entity 112lo.

o.

Below the functionality will be discussed. Smoothed temporal envelope is low-pass filtered version of the temporal envelope using short symmetrical FIR filter (for an example 4^{th} order filter at F_{S}=48 kHz).

Normalized autocorrelation of the temporal envelope is calculated:

$${ρ}_{{e}_{T}} [ m ] = \frac{{\sum }_{n = 0}^{40} {e}_{T} [ n ] {e}_{T} [ n - m ]}{\sqrt{( {\sum }_{n = 0}^{40} {e}_{T} [ n ] {e}_{T} [ n ] ) ( {\sum }_{n = - m}^{40 - m} {e}_{T} [ n ] {e}_{T} [ n ] )}} \\ {\hat{ρ}}_{{e}_{T}} = \{ \begin{matrix}{max}_{5 \leq m \leq 12} {ρ}_{{e}_{T}} [ m ] , & {max}_{5 \leq m \leq 12} {ρ}_{{e}_{T}} [ m ] > 0 \text{.65} \\ 0 & {max}_{5 \leq m \leq 12} {ρ}_{{e}_{T}} [ m ] \leq 0.65\end{matrix}$$

where e_{T} is the temporal envelope after mean removal. The exact delay for the maximum

$$( {D}_{{ρ}_{{e}_{T}}} )$$

is estimated using Lagrange polynomial of 3 points forming the peak in the normalized autocorrelation.

Expected average pulse distance may be estimated from the normalized autocorrelation of the temporal envelope and the average pitch lag in the frame:

$${\tilde{D}}_{P} = \{ \begin{matrix}{D}_{{ρ}_{{e}_{T}}} , & {\hat{ρ}}_{{e}_{T}} > 0 \\ min ( \frac{{\overline{d}}_{{F}_{0}}}{{H}_{P}} , 13 ) , & {\hat{ρ}}_{{e}_{T}} = 0 ∧ {\overline{d}}_{{F}_{0}} > 0 \\ 13 & {\hat{ρ}}_{{e}_{T}} = 0 ∧ {\overline{d}}_{{F}_{0}} = 0\end{matrix}$$

where for the frames with low harmonicity, \tilde{D}_{P} is set to 13, which corresponds to 6.5 milliseconds.

Positions of the pulses are local peaks in the smoothed temporal envelope with the requirement that the peaks are above their surroundings. The surrounding is defined as the low-pass filtered version of the temporal envelope using simple moving average filter with adaptive length; the length of the filter is set to the half of the expected average pulse distance (\tilde{D}_{P}). The exact pulse position (\dot{t}_{P}_{ᵢ}) is estimated using Lagrange polynomial of 3 points forming the peak in the smoothed temporal envelope. The pulse center position (t_{P}_{ᵢ}) is the exact position rounded to the STFT time instances and thus the distance between the center positions of pulses is a multiple of 0.5 milliseconds. It is considered that each pulse extends 2 time instances to the left and 2 to the right from its center position. Other number of time instances may also be used.

Up to 8 pulses per 20 milliseconds are found; if more pulses are detected then smaller pulses are disregarded. The number of found pulses is denoted as N_{P}_{_{X}}. i^{th} pulse is denoted as Pᵢ. The average pulse distance is defined as:

$${\overline{D}}_{P} = \{ \begin{matrix}{\tilde{D}}_{P} , & {\hat{ρ}}_{{e}_{T}} > 0 ∧ {\overline{d}}_{{F}_{0}} > 0 \\ min ( \frac{40}{{N}_{{P}_{X}}} , 13 ) , & {\hat{ρ}}_{{e}_{T}} = 0 ∧ {\overline{d}}_{{F}_{0}} = 0\end{matrix}$$

Magnitudes are enhanced based on the pulse positions so that the enhanced STFT, also called enhanced spectrogram, consists only of the pulses. The background of a pulse is estimated as the linear interpolation of the left and the right background, where the left and the right backgrounds are mean of the 3^{rd} to 5^{th} time instance away from the (temporal) center position. The background is estimated in the log magnitude domain in 112be and removed by subtracting it in the linear magnitude domain in 112br. Magnitudes in the enhanced STFT are in the linear scale. The phase is not modified. All magnitudes in the time instances not belonging to a pulse are set to zero.

The start frequency of a pulse is proportional to the inverse of the average pulse distance (between nearby pulse waveforms) in the frame, but limited between 750 Hz and 7250 Hz:

$${f}_{{P}_{i}} = min ( ⌊ 2 {( \frac{13}{{\overline{D}}_{P}} )}^{2} + 0.5 ⌋ , 15 )$$

The start frequency (f_{P}_{ᵢ}) is expressed as index of an STFT band.

The change of the starting frequency in consecutive pulses is limited to 500 Hz (one STFT band). Magnitudes of the enhanced STFT bellow the starting frequency are set to zero in 112pe.

Waveform of each pulse is obtained from the enhanced STFT in 112pe. The pulse waveform is non-zero in 4 milliseconds around its (temporal) center and the pulse length is L_{W}_{_{P}}=0.004 F_{S} (the sampling rate of the pulse waveform is equal to the sampling rate of the input signal F_{S}). The symbol x_{P}_{ᵢ} represents the waveform of the i^{th} pulse.

Each pulse Pᵢ is uniquely determined by the center position t_{P}_{ᵢ} and the pulse waveform x_{P}_{ᵢ}. The pulse extractor 112pe outputs pulses Pᵢ consisting of the center positions t_{P}_{ᵢ} and the pulse waveforms x_{P}_{ᵢ}. The pulses are aligned to the STFT grid. Alternatively, the pulses may be not aligned to the STFT grid and/or the exact pulse position (t_{P}_{ᵢ}) may determine the pulse instead of t_{P}_{ᵢ}.

Features are calculated for each pulse:
percentage of the local energy in the pulse—p_{E}_{_{L}}_{,P}_{ᵢ}
percentage of the frame energy in the pulse—p_{E}_{_{F}}_{,P}_{ᵢ}
percentage of bands with the pulse energy above the half of the local energy—P_{N}_{_{E}}_{,P}_{ᵢ}
correlation ρ_{P}_{ᵢ}_{,P}_{ⱼ} and distance d_{P}_{ᵢ}_{,P}_{ⱼ} between each pulse pair (among the pulses in the current frame and the N_{P}_{ₚ} last coded pulses from the past frames)
pitch lag at the exact location of the pulse—d_{P}_{ᵢ}

The local energy is calculated from the 11 time instances around the pulse center in the original STFT. All energies are calculated only above the start frequency.

The distance between a pulse pair d_{P}_{ⱼ}_{,P}_{ᵢ} is obtained from the location of the maximum cross-correlation between pulses (x_{P}_{ᵢ}*x_{P}_{ⱼ})[m]. The cross-correlation is windowed with the 2 milliseconds long rectangular window and normalized by the norm of the pulses (also windowed with the 2 milliseconds rectangular window). The pulse correlation is the maximum of the normalized cross-correlation:

$$( {x}_{{P}_{i}} * {x}_{{P}_{j}} ) [ m ] = \frac{{\sum }_{n = l}^{{L}_{{W}_{P}} - l} {x}_{{P}_{i}} [ n ] {x}_{{P}_{j}} [ n + m ]}{\sqrt{( {\sum }_{n = l}^{{L}_{{W}_{P}} - l} {x}_{{P}_{i}} [ n ] {x}_{{P}_{i}} [ n ] ) ( {\sum }_{n = l}^{{L}_{{W}_{P}} - l} {x}_{{P}_{j}} [ n + m ] {x}_{{P}_{j}} [ n + m ] )}} \\ {ρ}_{{P}_{j} , {P}_{i}} = \{ \begin{matrix}{max}_{- l \leq m \leq l} ( {x}_{{P}_{i}} * {x}_{{P}_{j}} ) [ m ] , i < j \\ {max}_{- l \leq m \leq l} ( {x}_{{P}_{j}} * {x}_{{P}_{i}} ) [ m ] , i > j \\ 0 , i = j\end{matrix} {Δ}_{{ρ}_{{P}_{j} , {P}_{i}}} = \{ \begin{matrix}{arg max}_{- l \leq m \leq l} ( {x}_{{P}_{i}} * {x}_{{P}_{j}} ) [ m ] , i < j \\ - {arg max}_{- l \leq m \leq l} ( {x}_{{P}_{j}} * {x}_{{P}_{i}} ) [ m ] , i > j \\ 0 , i = j\end{matrix} {d}_{{P}_{j} , {P}_{i}} = \vert {t}_{{P}_{j}} - {t}_{{P}_{i}} + {Δ}_{{ρ}_{{P}_{j} , {P}_{i}}} \vert = \vert {t}_{{P}_{i}} - {t}_{{P}_{j}} + {Δ}_{{ρ}_{{P}_{j} , {P}_{i}}} \vert l = \frac{{L}_{{W}_{P}}}{4}$$

The value of (x_{P}_{ᵢ}*x_{P}_{ⱼ})[m] is in the range between 0 and 1.

Error between the pitch and the pulse distance is calculated as:

$${ϵ}_{{P}_{i} , {P}_{j}} = {ϵ}_{{P}_{j} , {P}_{i}} = min ( {min}_{1 \leq k \leq 6} \frac{\vert k \cdot {d}_{{P}_{j} , {P}_{i}} - {d}_{{P}_{j}} \vert}{{H}_{P}} , {min}_{1 \leq k \leq j - i} \frac{\vert {d}_{{P}_{j} , {P}_{i}} - k \cdot {d}_{{P}_{j}} \vert}{{H}_{P}} , i < j$$

Introducing multiple of the pulse distance (k·d_{P}_{ⱼ}_{,P}_{ᵢ}), errors in the pitch estimation are taken into account. Introducing multiples of the pitch lag (k·d_{P}_{ⱼ}) solves missed pulses coming from imperfections in pulse trains: if a pulse in the train is distorted or there is a transient not belonging to the pulse train that inhibits detection of a pulse belonging to the train. Probability that the i^{th} and the j^{th} pulse belong to a train of pulses (cf. 113p):

$${p}_{{P}_{i} , {P}_{j}} = {p}_{{P}_{j} , {P}_{i}} = \{ \begin{matrix}min ( 1 , \frac{{ρ}_{{P}_{j} , {P}_{i}}^{2}}{\sqrt[10]{max ( 0.2 , {ϵ}_{{P}_{i} , {P}_{j}} )}} ) , - {N}_{{P}_{P}} \leq j < 0 \leq i < {N}_{{P}_{X}} \\ min ( 1 , \frac{{ρ}_{{P}_{j} , {P}_{i}}}{2 \cdot \sqrt{max ( 0.1 , {ϵ}_{{P}_{i} , {P}_{j}} )}} ) , 0 \leq i < j < {N}_{{P}_{X}}\end{matrix}$$

Probability of a pulse with the relation only to the already coded past pulses is defined as:

$${\dot{p}}_{{P}_{i}} = {p}_{{E}_{F} , {P}_{i}} ( 1 + {max}_{- {N}_{{P}_{P}} \leq j < 0} {p}_{{P}_{j} , {P}_{i}} )$$

Probability (cf. entity 113p) of a pulse (p_{P}_{ᵢ}) is iteratively found:
1. All pulse probabilities (p_{P}_{ᵢ}, 0≤i<N_{P}_{_{X}}) are set to 1
2. In the time appearance order of pulses, for each pulse that is still probable (p_{P}_{ᵢ}>0):
a. Probability of the pulse belonging to a train of the pulses in the current frame is calculated:

$${{p}^{…}}_{{P}_{i}} = {p}_{{E}_{F} , {P}_{i}} ( {\sum }_{j = 0}^{i - 1} {p}_{{P}_{j}} \cdot {p}_{{P}_{j} , {P}_{i}} + {\sum }_{j = i + 1}^{{N}_{{P}_{X}} - 1} {p}_{{P}_{j}} \cdot {p}_{{P}_{j} , {P}_{i}} )$$

b. The initial probability that it is truly a pulse is then:

p_{P}_{ᵢ}=\dot{p}_{P}_{ᵢ}+ [symbol]
c. The probability is increased for pulses with the energy in many bands above the half of the local energy:

p_{P}_{ᵢ}=max(_{P}_{ᵢ},min(p_{N}_{_{E}}_{,P}_{ᵢ},1.5·p_{P}_{ᵢ}))
d. The probability is limited by the temporal envelope correlation and the percentage of the local energy in the pulse:

p_{P}_{ᵢ}=min(p_{P}_{ᵢ},(1+0.4·\hat{ρ}ₑ_{_{T}})p_{E}_{_{L}}_{,P}_{ᵢ})
e. If the pulse probability is below a threshold, then its probability is set to zero and it is not considered anymore:

$${p}_{{P}_{i}} = \{ \begin{matrix}1 & , {p}_{{P}_{i}} \geq 0.15 \\ 0 & , {p}_{{P}_{i}} < 0.15\end{matrix}$$

3. The step 2 is repeated as long as there is at least one p_{P}_{ᵢ} set to zero in the current iteration or until all p_{P}_{ᵢ} are set to zero.

At the end of this procedure, there are N_{P}_{_{c}} true pulses with p_{P}_{ᵢ} equal to one. All and only true pulses constitute the pulse portion P and are coded as CP. Among the true N_{P}_{_{c}} pulses up to three last pulses are kept in memory for calculating ρ_{P}_{ᵢ}_{,P}_{ⱼ} and d_{P}_{ᵢ}_{,P}_{ⱼ} in the following frames. If there are less than three true pulses in the current frame, some pulses already in memory are kept. In total up to three pulses are kept in the memory. There may be other limit for the number of pulses kept in memory, for example 2 or 4. After there are three pulses in the memory, the memory remains full with the oldest pulses in memory being replaced by newly found pulses. In other words, the number of past pulses N_{P}_{ₚ} kept in memory is increased at the beginning of processing until N_{P}_{ₚ}=3 and is kept at 3 afterwards.

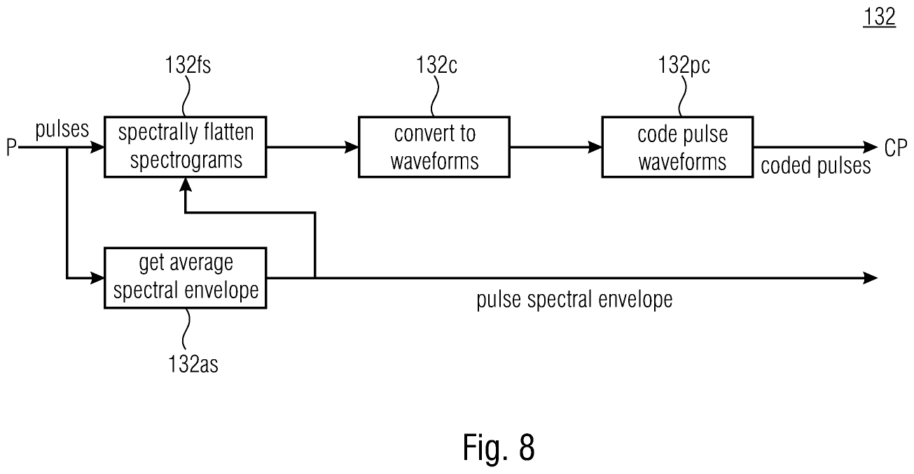

Below, with respect to FIG. 8 the pulse coding (encoder side, cf. entity 132) will be discussed.

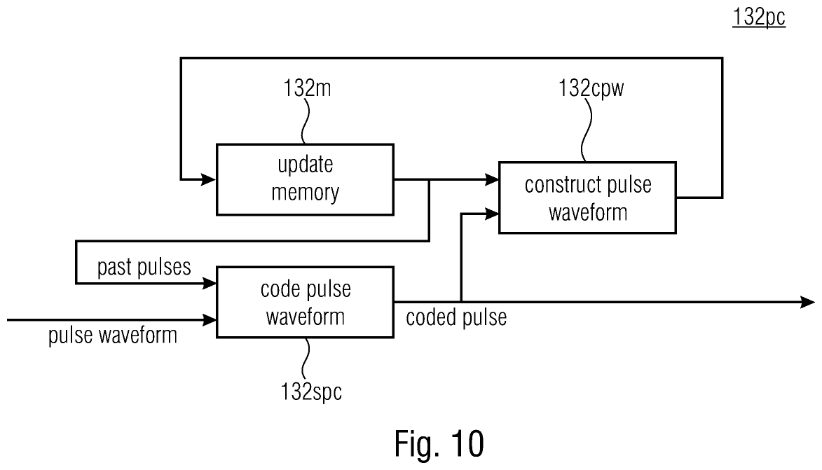

FIG. 8 shows the pulse coder 132 comprising the entities 132fs, 132c and 132pc in the main path, wherein the entity 132as is arranged for determining and providing the spectral envelope as input to the entity 132fs configured for performing spectrally flattening. Within the main path 132fs, 132c and 132pc, the pulses P are coded to determine coded spectrally flattened pulses. The coding performed by the entity 132pc is performed on spectrally flattened pulses. The coded pulses CP in FIG. 2a-c consists of the coded spectrally flattened pulses and the pulse spectral envelope. The coding of the plurality of pulses will be discussed in detail with respect to FIG. 10.

Pulses are coded using parameters:
number of pulses in the frame N_{P}_{_{C}}
position within the frame t_{P}_{ᵢ}
pulse starting frequency t_{P}_{ᵢ}
pulse spectral envelope
prediction gain

$${g}_{{P}_{{P}_{i}}}$$

and if

$${g}_{{P}_{{P}_{i}}}$$

is not zero:
index of the prediction source

$${i}_{{P}_{{P}_{i}}}$$

prediction offset

$${Δ}_{{P}_{{P}_{i}}}$$

innovation gain

$${g}_{{I}_{{P}_{i}}}$$

innovation consisting of up to 4 impulses, each pulse coded by its position and sign

A single coded pulse is determined by parameters:
pulse starting frequency f_{P}_{ᵢ}
pulse spectral envelope
prediction gain

$${g}_{{P}_{{P}_{i}}}$$

and if

$${g}_{{P}_{{P}_{i}}}$$

is not zero;
index of the prediction source

$${i}_{{P}_{{P}_{i}}}$$

prediction offset

$${Δ}_{{P}_{{P}_{i}}}$$

innovation gain

$${g}_{{I}_{{P}_{i}}}$$

innovation consisting of up to 4 impulses, each pulse coded by its position and sign

From the parameters that determine the single coded pulse a waveform can be constructed that present the single coded pulse. We can then also say that the coded pulse waveform is determined by the parameters of the single coded pulse.

The number of pulses is Huffman coded.

The first pulse position t_{P}_{₀} is coded absolutely using Huffman coding. For the following pulses the position deltas Δ_{P}_{ᵢ}=t_{P}_{ᵢ}−t_{P}_{_{i−1}} are Huffman coded. There are different Huffman codes depending on the number of pulses in the frame and depending on the first pulse position.

The first pulse starting frequency f_{P}_{₀} is coded absolutely using Huffman coding. The start frequencies of the following pulses is differentially coded. If there is a zero difference then all the following differences are also zero, thus the number of non-zero differences is coded. All the differences have the same sign, thus the sign of the differences can be coded with single bit per frame. In most cases the absolute difference is at most one, thus single bit is used for coding if the maximum absolute difference is one or bigger. At the end, only if maximum absolute difference is bigger than one, all non-zero absolute differences need to be coded and they are unary coded.

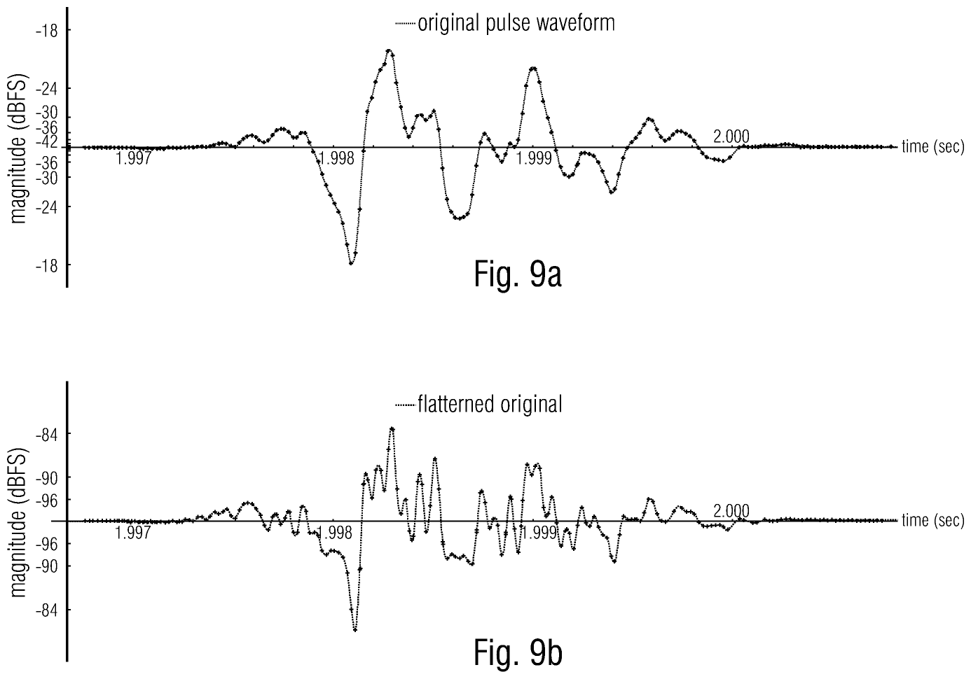

The spectrally flatten, e.g. performed using STFT (cf. entity 132fs of FIG. 8) is illustrated by FIGS. 9a and 9b, where FIG. 9a showing the original pulse waveform in comparison to the flattened version of FIG. 9b. Note the spectrally flattening may alternatively be performed by a filter, e.g. in the time domain.

All pulses in the frame may use the same spectral envelope (cf. entity 132as) consisting of eight bands. Band border frequencies are: 1 kHz, 1.5 kHz, 2.5 kHz, 3.5 kHz, 4.5 kHz, 6 kHz, 8.5 kHz, 11.5 kHz, 16 kHz. Spectral content above 16 kHz is not explicitly coded. In another example other band borders may be used.

Spectral envelope in each time instance of a pulse is obtained by summing up the magnitudes within the envelope bands, the pulse consisting of 5 time instances. The envelopes are averaged across all pulses in the frame. Points between the pulses in the time-frequency plane are not taken into account.

The values are compressed using fourth root and the envelopes are vector quantized. The vector quantizer has 2 stages and the 2^{nd} stage is split in 2 halves. Different codebooks exist for frames with d̅_{F}_{₀}=0 and d̅_{F}_{₀}≠0 and for the values of N_{P}_{_{C}} and f_{P}_{ᵢ}. Different codebooks require different number of bits.

The quantized envelope may be smoothed using linear interpolation. The spectrograms of the pulses are flattened using the smoothed envelope (cf. entity 132fs). The flattening is achieved by division of the magnitudes with the envelope (received from the entity 132as), which is equivalent to subtraction in the logarithmic magnitude domain. Phase values are not changed. Alternatively a filter processor may be configured to spectrally flatten magnitudes or the pulse STFT by filtering the pulse waveform in the time domain.

Waveform of the spectrally flattened pulse y_{P}_{ᵢ} is obtained from the STFT via the inverse DFT, windowing and overlap and add in 132c.

FIG. 10 shows an entity 132pc for coding a single spectrally flattened pulse waveform of the plurality of spectrally flattened pulse waveforms. Each single coded pulse waveform is output as coded pulse signal. From another point of view, the entity 132pc for coding single pulses of FIG. 10 is than the same as the entity 132pc configured for coding pulse waveforms as shown in FIG. 8, but used several times for coding the several pulse waveforms.

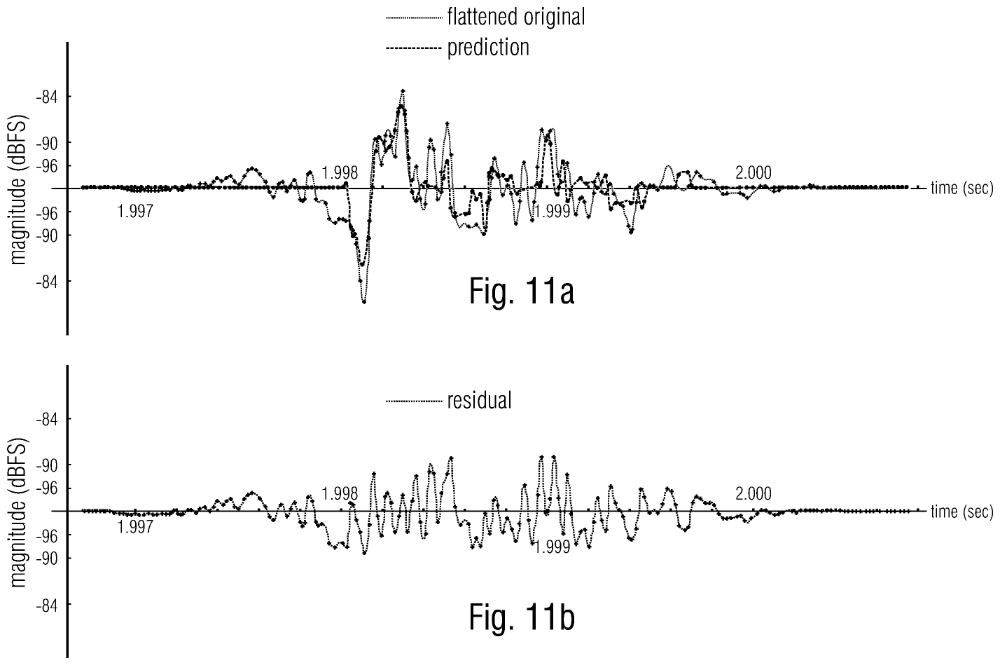

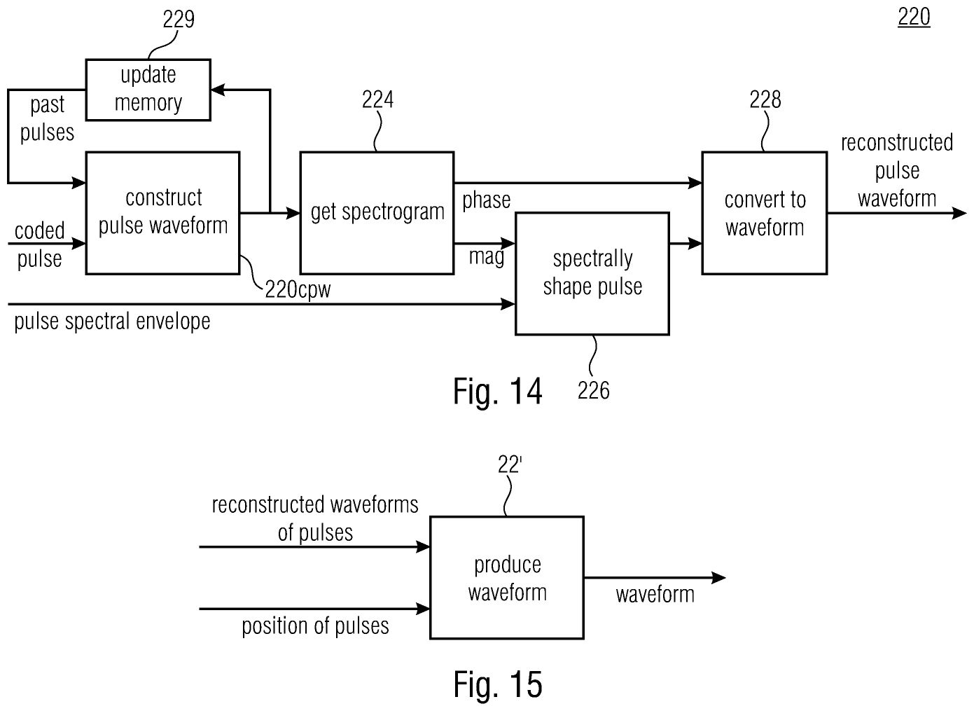

The entity 132pc of FIG. 10 comprises a pulse coder 132spc, a constructor for the flattened pulse waveform 132cpw and the memory 132m arranged as kind of a feedback loop. The constructor 132cpw has the same functionality as 220cpw and the memory 132m the same functionality as 229 in FIG. 14. Each single/current pulse is coded by the entity 132spc based on the flattened pulse waveform taking into account past pulses. The information on the past pulses is provided by the memory 132m. Note the past pulses coded by 132pc are fed via the pulse waveform constructer 132cpw and memory 132m. This enables the prediction. The result by using such prediction approach is illustrated by FIG. 11. Here FIG. 11a, indicates the flattened original together with the prediction and the resulting prediction residual signal in FIG. 11b.

According to embodiments the most similar previously quantized pulse is found among NPP pulses from the previous frames and already quantized pulses from the current frame. The correlation ρ_{P}_{ᵢ}_{,P}_{ⱼ}, as defined above, is used for choosing the most similar pulse. If differences in the correlation are below 0.05, the closer pulse is chosen. The most similar previous pulse is the source of the prediction \tilde{z}_{P}_{ᵢ} and its index

$${i}_{{P}_{{P}_{i}}} ,$$

relative to the currently coded pulse, is used in the pulse coding. Up to four relative prediction source indexes

$${i}_{{P}_{{P}_{i}}}$$

are grouped and Huffman coded. The grouping and the Huffman codes are dependent on N_{P}_{_{C}} and whether d̅_{F}_{₀}=0 and d̅_{F}_{₀}≠0.

The offset for the maximum correlation is the pulse prediction offset

$${Δ}_{{P}_{{P}_{i}}} .$$

It is coded absolutely, differentially or relatively to an estimated value, where the estimation is calculated from the pitch lag at the exact location of the pulse d_{P}_{ᵢ}. The number of bits needed for each type of coding is calculated and the one with minimum bits is chosen.

Gain

$${{g}^{'}}_{{P}_{{P}_{i}}}$$

that maximizes the SNR Is used for scaling the prediction \tilde{z}_{P}_{ᵢ}. The prediction gain is non-uniformly quantized with 3 to 4 bits. If the energy of the prediction residual is not at least 5% smaller than the energy of the pulse, the prediction is not used and

$${{g}^{'}}_{{P}_{{P}_{i}}}$$

is set to zero.

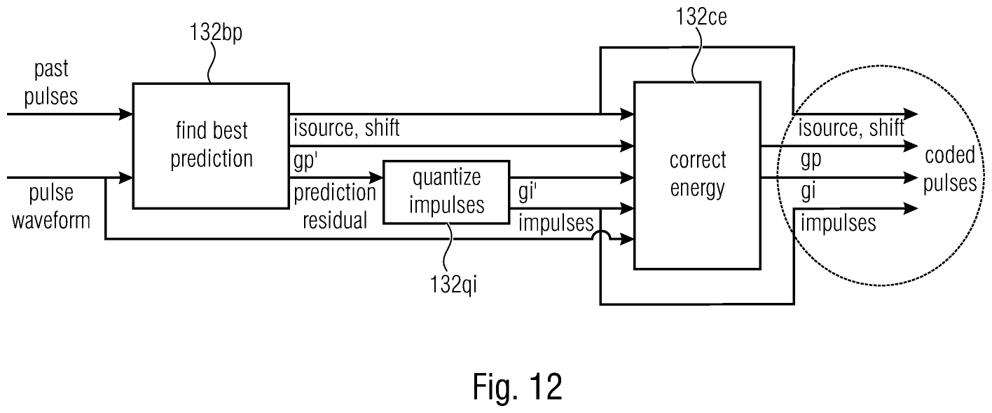

The prediction residual is quantized using up to four impulses. In another example other maximum number of impulses may be used. The quantized residual consisting of impulses is named innovation ż_{P}_{ᵢ}. This is illustrated FIG. 12. To save bits, the number of impulses is reduced by one for each pulse predicted from a pulse in this frame. In other words: if the prediction gain is zero or if the source of the prediction is a pulse from previous frames then four impulses are quantized, otherwise the number of impulses decreases compared to the prediction source.

FIG. 12 shows a processing path to be used as process block 132spc of FIG. 10. The process path enables to determine the coded pulses and may comprise the three entities 132bp, 132qi, 132ce.

The first entity 132bp for finding the best prediction uses the past pulse(s) and the pulse waveform to determine the iSOURCE, shift, GP′ and prediction residual. The quantize impulse entity 132gi quantizes the prediction residual and outputs GI′ and the impulses. The entity 132ce is configured to calculate and apply a correction factor. All this information together with the pulse waveform are received by the entity 132ce for correcting the energy, so as to output the coded impulse. The following algorithm may be used according to embodiments:

:

For finding and coding the impulses the following algorithm is used:
1. Absolute pulse waveform |x|pᵢ is constructed using full-wave rectification:

|x|_{P}_{ᵢ}[n]=|x_{P}_{ᵢ}[n]|,0≤n<L_{W}_{ₚ}
2. Vector with the number of impulses at each location └x┘_{P}_{ᵢ} is initialized with zeros:

└x┘_{P}_{ᵢ}[n]=0,0≤n<L_{W}_{ₚ}
3. Location of the maximum in |x|_{P}_{ᵢ} is found:

$${\hat{n}}_{x} = {argmax}_{0 \leq m < {L}_{{W}_{P}}} {\vert x \vert}_{{P}_{i}} [ m ]$$

4. Vector with the number of impulses is increased for one at the location of the found maximum └x┐_{P}_{ᵢ}└\hat{n}ₓ┘:

└x┘_{P}_{ᵢ}[\hat{n}ₓ]=└x┘_{P}_{ᵢ}[\hat{n}ₓ]+1
5. The maximum in |x|_{P}_{ᵢ} is reduced:

$${\vert x \vert}_{{P}_{i}} [ {\hat{n}}_{x} ] = \frac{\vert {x}_{{P}_{i}} [ {\hat{n}}_{x} ] \vert}{1 + {⌊ x ⌋}_{{P}_{i}} [ {\hat{n}}_{x} ]}$$

6. The steps 3-5 are repeated until the required number of impulses are found, where the number of pulses is equal to Σ└x┘_{P}_{ᵢ}[n]

Notice that the impulses may have the same location. Locations of the pulses are ordered by their distance from the pulse center. The location of the first impulse is absolutely coded. The locations of the following impulses are differentially coded with probabilities dependent on the position of the previous impulse. Huffman coding is used for the impulse location. Sign of each impulse is also coded. If multiple impulses share the same location then the sign is coded only once.

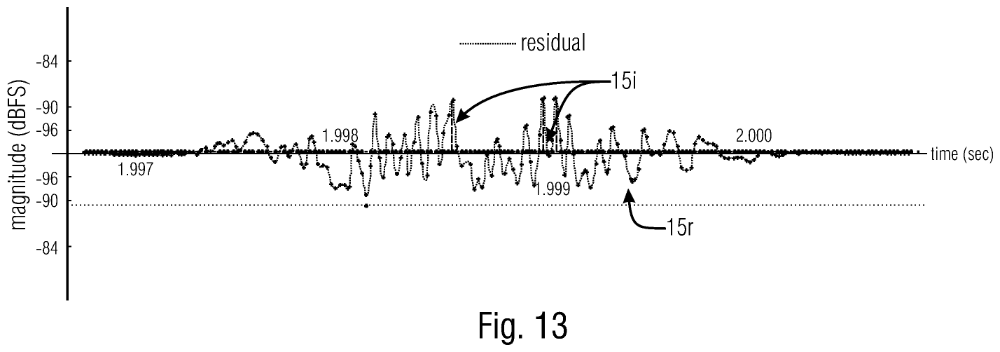

The resulting 4 found and scaled impulses 15i of the residual signal 15r are illustrated by FIG. 13. In detail the impulses represented by the lines

$$Q ( {g}_{{I}_{{P}_{i}}} ) {\dot{z}}_{{P}_{i}}$$

may be scaled accordingly, e.g. impulse +/−1 multiplied by Gain

$${{g}^{'}}_{{I}_{{P}_{i}}} .$$

Gain

$${{g}^{'}}_{{P}_{{P}_{i}}}$$

that maximizes the SNR is used for scaling the innovation ż_{P}_{ᵢ} consisting of the impulses. The innovation gain is non-uniformly quantized with 2 to 4 bits, depending on the number of pulses N_{P}_{_{C}}.

The first estimate for quantization of the flattened pulse waveform ź_{P}_{ᵢ} is then:

$${{z}^{'}}_{{P}_{i}} = Q ( {{g}^{'}}_{{P}_{{P}_{i}}} ) {\tilde{z}}_{{P}_{i}} + Q ( {{g}^{'}}_{{I}_{{P}_{i}}} ) \dot{z} {P}_{i}$$

where Q( ) denotes quantization.

Because the gains are found by maximizing the SNR, the energy of ź_{P}_{ᵢ} can be much lower than the energy of the original target y_{P}_{ᵢ}. To compensate the energy reduction a correction factor c_{g} is calculated:

$${c}_{ℊ} = max ( 1 , {( \frac{{\sum }_{n = 0}^{{L}_{{W}_{P}}} {( {y}_{{P}_{i}} [ n ] )}^{2}}{{\sum }_{n = 0}^{{L}_{{W}_{P}}} {( {{z}^{´}}_{{P}_{i}} [ n ] )}^{2}} )}^{0.25} )$$

The final gains are then:

$${ℊ}_{{P}_{{P}_{i}}} = \{ \begin{matrix}{c}_{ℊ} {{ℊ}^{´}}_{{P}_{{P}_{i}}} , & Q ( {{ℊ}^{´}}_{{P}_{{P}_{i}}} ) > 0 \\ 0 , & Q ( {{ℊ}^{´}}_{{P}_{{P}_{i}}} ) = 0\end{matrix}$$

$${ℊ}_{{I}_{{P}_{i}}} = {c}_{ℊ} {{ℊ}^{´}}_{{I}_{{P}_{i}}}$$

The memory for the prediction is updated using the quantized flattened pulse waveform z_{P}_{ᵢ}:

$${z}_{{P}_{i}} = Q ( {ℊ}_{{P}_{{P}_{i}}} ) {\tilde{z}}_{{P}_{i}} + Q ( {ℊ}_{{I}_{{P}_{i}}} ) {\dot{z}}_{{P}_{i}}$$

At the end of coding of N_{P}_{ₚ}≤3 quantized flattened pulse waveforms are kept in memory for prediction in the following frames.

Below, taking reference to FIG. 14 the approach for reconstructing pulses will be discussed.

FIG. 14 shows an entity 220 for reconstructing a single pulse waveform. The below discussed approach for reconstructing a single pulse waveform is multiple times executed for multiple pulse waveforms. The multiple pulse waveforms are used by the entity 22′ of FIG. 15 to reconstruct a waveform that includes the multiple pulses. From another point of view, the entity 220 processes signal consisting of a plurality of coded pulses and a plurality of pulse spectral envelopes and for each coded pulse and an associated pulse spectral envelope outputs single reconstructed pulse waveform, so that at the output of the entity 220 is a signal consisting of a plurality of the reconstructed pulse waveforms.

The entity 220 comprises a plurality of sub-entities, for example, the entity 220cpw for constructing spectrally flattened pulse waveform, an entity 224 for generating a pulse spectrogram (phase and magnitude spectrogram) of the spectrally flattened pulse waveform and an entity 226 for spectrally shaping the pulse magnitude spectrogram. This entity 226 uses a magnitude spectrogram as well as a pulse spectral envelope. The output of the entity 226 is fed to a converter for converting the pulse spectrogram to a waveform which is marked by the reference numeral 228. This entity 228 receives the phase spectrogram as well as the spectrally shaped pulse magnitude spectrogram, so as to reconstruct the pulse waveform. It should be noted, that the entity 220cpw (configured for constructing a spectrally flattened pulse waveform) receives at its input a signal describing a coded pulse. The constructor 220cpw comprises a kind of feedback loop including an update memory 229. This enables that the pulse waveform is constructed taking into account past pulses. Here the previously constructed pulse waveforms are fed back so that past pulses can be used by the entity 220cpw for constructing the next pulse waveform. Below, the functionality of this pulse reconstructor 220 will be discussed. To be noted that at the decoder side there are only the quantized flattened pulse waveforms (also named decoded flattened pulse waveforms or coded flattened pulse waveforms) and since there are no original pulse waveforms on the decoder side, we use the flattened pulse waveforms for naming the quantized flattened pulse waveforms at the decoder side and the pulse waveforms for naming the quantized pulse waveforms (also named decoded pulse waveforms or coded pulse waveforms or decoded pulse waveforms).

For reconstructing the pulses on the decoder side 220, the quantized flattened pulse waveforms are constructed (cf. entity 220cpw) after decoding the gains

$$( {g}_{{P}_{{P}_{i}}} and {g}_{{I}_{{P}_{i}}} ) ,$$

impulses/innovation, prediction source

$$( {i}_{{P}_{{P}_{i}}} )$$

and offset

$$( {Δ}_{{P}_{{P}_{i}}} ) .$$

The memory 229 for the prediction is updated in the same way as in the encoder in the entity 132m. The STFT (cf. entity 224) is then obtained for each pulse waveform. For example, the same 2 milliseconds long squared sine windows with 75% overlap are used as in the pulse extraction. The magnitudes of the STFT are reshaped using the decoded and smoothed spectral envelope and zeroed out below the pulse starting frequency f_{P}_{ᵢ}. Simple multiplication of magnitudes with the envelope is used for shaping the STFT (cf. entity 226). The phases are not modified. Reconstructed waveform of the pulse is obtained from the STFT via the inverse DFT, windowing and overlap and add (cf. entity 228). Alternatively the envelope can be shaped via an FIR filter, avoiding the STFT.

FIG. 15 shows the entity 22′ subsequent to the entity 228 which receives a plurality of reconstructed waveforms of the pulses as well as the positions of the pulses so as to construct the waveform y_{P} (cf. FIG. 2a, 2c). This entity 22′ is used for example as the last entity within the waveform constructor 22 of 2a or 2c.

The reconstructed pulse waveforms are concatenated based on the decoded positions tpp inserting zeros between the pulses in the entity 22′ in FIG. 15. The concatenated waveform is added to the decoded signal (cf. 23 in FIG. 2a or FIG. 2c or 114m in FIG. 6). In the same manner the original pulse waveforms x_{P}_{ᵢ} are concatenated (cf. in 114 in FIG. 6) and subtracted from the input of the MDCT based codec (cf. FIG. 6).

The reconstructed pulse waveforms are concatenated based on the decoded positions t_{P}_{ᵢ}, inserting zeros between the pulses. The concatenated waveform is added to the decoded signal. In the same manner the original pulse waveforms x_{P}_{ᵢ} are concatenated and subtracted from the input of the MDCT based codec.

The reconstructed pulse waveform are not perfect representations of the original pulses. Removing the reconstructed pulse waveform from the input would thus leave some of the transient parts of the signal. As transient signals cannot be well presented with an MDCT codec, noise spread across whole frame would be present and the advantage of separately coding the pulses would be reduced. For this reason the original pulses are removed from the input.

According to embodiments the HF tonality flag ϕ_{H} may be defined as follows:

Normalized correlation ρ_{HF} is calculate on y_{MHF} between the samples in the current window and a delayed version with d̅_{F}_{₀} (or d̅_{F}_{_{corrected}}) delay, where y_{MHF} is a high-pass filtered version of the pulse residual signal y_{M}. For an example a high-pass filter with the crossover frequency around 6 kHz may be used.

n_{HFTonalCurr}n_{HFTonal}=0.5·n_{HFTonal}+n_{HFTonalcurr} For each MDCT frequency bin above a specified frequency, it is determined, as in 5.3.3.2.5 of [20], if the frequency bin is tonal or noise like. The total number of tonal frequency bins is calculated in the current frame and additionally smoothed total number of tonal frequencies is calculated as.

HF tonality flag ϕ_{H} is set to 1 if the TNS is inactive and the pitch contour is present and there is tonality in high frequencies, where the tonality exists in high frequencies if ρ_{HF}>0 or n_{HFTonal}>1.

With respect to FIG. 16 the iBPC approach is discussed. The process of obtaining the optimal quantization step size g_{Qo} will be explained now. The process may be an integral part of the block iBPC. Note the entity 300 of FIG. 16 outputs g_{Q}_{₀} based on X_{MR}. In another apparatus X_{MR} and g_{Q}_{ₒ} may be used as input (for details cf. FIG. 3).

FIG. 16 shows a flow chart of an approach for estimating a step size. The process starts, with i=0 wherein then for an example four steps of quantize, adaptive band zeroing, determining jointly band-wise parameters and spectrum and determine whether the spectrum is codeable are performed. These steps are marked by the reference numerals 301 to 304. In case the spectrum is codeable the step size is decreased (cf. step 307) a next iteration ++i is performed cf. reference numeral 308. This is performed as long as i is not equal to the maximum iteration (cf. decision step 309). In case the maximum iteration is achieved the step size is output. In case the maximum iterations are not achieved the next iteration is performed.

In case, the spectrum is not codeable, the process having the steps 311 and 312 together with the verifying step (spectrum now codebale) 313 is applied. After that the step size is increased (cf. 314) before initiating the next iteration (cf. step 308).

A spectrum X_{MR}, which spectral envelope is perceptually flattened, is scalar quantized using single quantization step size g_{Q} across the whole coded bandwidth and entropy coded for example with a context based arithmetic coder producing a coded spect. The coded spectrum bandwidth is divided into sub-bands Bᵢ of increasing width L_{B}_{ᵢ}.

The optimal quantization step size g_{Qo}, also called global gain, is iteratively found as explained.

In each iteration the spectrum X_{MR} is quantized in the block Quantize 301 to produce X_{Q1}. In the block “Adaptive band zeroing” 302 a ratio of the energy of the zero quantized lines and the original energy is calculated in the sub-bands Bᵢ and if the energy ratio is above an adaptive threshold τ_{B}_{ᵢ}, the whole sub-band in X_{Q1} is set to zero. The thresholds τ_{B}_{ᵢ} are calculated based on the tonality flag ϕ_{H} and flags

$${{ϕ}^{`}}_{{N}_{{B}_{i}} ,}$$

where the flags

$${{ϕ}^{`}}_{{N}_{{B}_{i}}}$$

indicate if a sub-band was zeroed-out in the previous frame:

$${τ}_{{B}_{i}} = \frac{1 + ( \frac{1}{2} - {{ϕ}^{`}}_{{N}_{{B}_{i}}} ) {ϕ}_{H}}{2}$$

For each zeroed-out sub-band a flag

$${ϕ}_{{N}_{{B}_{i}}}$$

is set to one. At the end of processing the current frame,

$${ϕ}_{{N}_{{B}_{i}}}$$

are copied to

$${{ϕ}^{`}}_{{N}_{{B}_{i}}} .$$

Alternatively there could be more than one tonality flag and a mapping from the plurality of the tonality flags into tonality of each sub-band, producing a tonality value for each sub-band

$${ϕ}_{{H}_{{B}_{i}}} .$$

The values of τ_{B}_{ᵢ} may for example have a value from a set of values {0.25, 0.5, 0.75}. Alternatively other decision may be used to decide based on the energy of the zero quantized lines and the original energy and on the contents X_{Q1} and X_{MR} of whether to set the whole sub-band i in X_{Q1} to zero.

A frequency range where the adaptive band zeroing is used may be restricted above a certain frequency f_{ABZStart}, for example 7000 Hz, extending the adaptive band zeroing as long, as the lowest sub-band is zeroed out, down to a certain frequency f_{ABZMin}, for example 700 Hz.

The individual zero filling levels (individual zfl) of sub-bands of X_{Q1} above f_{EZ}, where f_{EZ} is for an example 3000 Hz that are completely zero is explicitly coded and additionally one zero filling level (zflₛₘₐₗₗ) for all zero sub-bands bellow f_{EZ} and all zero sub-bands above f_{EZ} quantized to zero is coded. A sub-band of X_{Q1} may be completely zero because of the quantization in the block Quantize even if not explicitly set to zero by the adaptive band zeroing. The required number of bits for the entropy coding of the zero filling levels (zfl consisting of the individual zfl and the zflₛₘₐₗₗ) and the spectral lines in X_{Q1} is calculated (e.g. by the band-wise parametric coder). Additionally the number of spectral lines N_{Q} that can be explicitly coded with the available bit budget is found. N_{Q} is an integral part of the coded spect and is used in the decoder to find out how many bits are used for coding the spectrum lines; other methods for finding the number of bits for coding the spectrum lines may be used, for example using special EOF character. As long as there is not enough bits for coding all non-zero lines, the lines in X_{Q1} above N_{Q} are set to zero and the required number of bits is recalculated.

For the calculation of the bits needed for coding the spectral lines, bits needed for coding lines starting from the bottom are calculated. This calculation is needed only once as the recalculation of the bits needed for coding the spectral lines is made efficient by storing the number of bits needed for coding n lines for each n≤N_{Q}.

In each iteration, if the required number of bits exceeds the available bits, the global gain g_{Q} is decreased (307), otherwise g_{Q} is increased (314). In each iteration the speed of the global gain change is adapted. The same adaptation of the change speed as in the rate-distortion loop from the EVS may be used to iteratively modify the global gain. At the end of the iteration process, the optimal quantization step size g_{Qo} is equal to g_{Q} that produces optimal coding of the spectrum, for example using the criteria from the EVS, and X_{Q} is equal to the corresponding X_{Q1}.

Instead of an actual coding, an estimation of maximum number of bits needed for the coding may be used. The output of the iterative process is the optimal quantization step size g_{Qo}; the output may also contain the coded spect and the coded noise filling levels (zfl), as they are usually already available, to avoid repetitive processing in obtaining them again.

Below, the zero-filling will be discussed in detail.

According to embodiments, the block “Zero Filling” will be explained now, starting with an example of a way to choose the source spectrum.

For creating the zero filling, following parameters are adaptively found:
an optimal long copy-up distance \dot{d}_{C}
a minimum copy-up distance ď_{C}
a minimum copy-up source start š_{C}
a copy-up distance shift Δ_{C}

The optimal copy-up distance \dot{d}_{C} determines the optimal distance if the source spectrum is the already obtained lower part of X_{CT}. The value of \dot{d}_{C} is between the minimum \dot{d}_{Č}, that is for an example set to an index corresponding to 5600 Hz, and the maximum \dot{d}_{Ĉ}, that is for an example set to an index corresponding to 6225 Hz. Other values may be used with a constraint \dot{d}_{Č}<\dot{d}_{Ĉ}.

The distance between harmonics

$${Δ}_{{X}_{{F}_{0}}}$$

is calculated from an average pitch lag d̅_{F}_{₀}, where the average pitch lag d̅_{F}_{₀} is decoded from the bit-stream or deduced from parameters from the bit-stream (e.g. pitch contour). Alternatively

$${Δ}_{{X}_{{F}_{0}}}$$

may be obtained by analyzing X_{DT} or a derivative of it (e.g. from a time domain signal obtained using X_{DT}). The distance between harmonics

$${Δ}_{{X}_{{F}_{0}}}$$

is no necessarily an integer. If d̅_{F}_{₀}=0 then

$${Δ}_{{X}_{{F}_{0}}}$$

is set to zero, where zero is a way of signaling that there is no meaningful pitch lag.

The value of

$${d}_{{C}_{{F}_{0}}}$$

is the minimum multiple of the harmonic distance

$${Δ}_{{X}_{{F}_{0}}}$$

larger than the minimal optimal copy-up distance \dot{d}_{Č}:

$${d}_{{c}_{{F}_{0}}} = ⌊ {Δ}_{{X}_{{F}_{0}}} ⌈ \frac{{\dot{d}}_{\breve{C}}}{{Δ}_{{X}_{{F}_{0}}}} ⌉ + 0.5 ⌋$$

If

$${Δ}_{{X}_{{F}_{0}}}$$

is zero then

$${d}_{{C}_{{F}_{0}}}$$

is not used.

The starting TNS spectrum line plus the TNS order is denoted as i_{T}, it can be for example an index corresponding to 1000 Hz.

If TNS is inactive in the frame i_{C}_{_{S}}, is set to

$$⌊ 2.5 {Δ}_{{X}_{{F}_{0}}} ⌋ .$$

If TNS is active i_{C}_{_{S}} is set to i_{T}, additionally lower bound by

$$⌊ 2.5 {Δ}_{{X}_{{F}_{0}}} ⌋$$

if HFs are tonal (e.g. if ϕ_{H} is one).

Magnitude spectrum Z_{C} is estimated from the decoded spect X_{DT}:

$${Z}_{C} [ n ] = \sqrt{{\sum }_{m = - 2}^{2} {( {X}_{DT} [ n + m ] )}^{2}}$$

A normalized correlation of the estimated magnitude spectrum is calculated:

$$\\ {ρ}_{C} [ n ] = \frac{( {\sum }_{m = 0}^{{L}_{C} - 1} {Z}_{C} [ {i}_{{C}_{S}} + m ] {Z}_{C} [ {i}_{{C}_{S}} + n + m ] )}{\sqrt{\begin{matrix}( {\sum }_{m = 0}^{{L}_{C} - 1} {Z}_{C} [ {i}_{{C}_{S}} + m ] {Z}_{C} [ {i}_{{C}_{S}} + m ] ) \\ ( {\sum }_{m = 0}^{{L}_{C} - 1} {Z}_{C} [ {i}_{{C}_{S}} + n + m ] {Z}_{C} [ {i}_{{C}_{S}} + n + m ] )\end{matrix}}} , {\dot{d}}_{{C}^{⋁}} \leq n \leq {\dot{d}}_{\hat{C}}$$

The length of the correlation L_{C} is set to the maximum value allowed by the available spectrum, optionally limited to some value (for example to the length equivalent of 5000 Hz).

Basically we are searching for n that maximizes the correlation between the copy-up source Z_{C}[i_{C}_{_{S}}+m] and the destination Z_{C}[i_{C}_{ₛ}+n+m], where 0≤m<L_{C}.

We choose d_{C}_{_{ρ}} among n (\dot{d}_{Č}≤n≤\dot{d}_{Ĉ}) where ρ_{C} has the first peak and is above mean of ρ_{C}, that is:

$$\\ {ρ}_{C} [ {d}_{{C}_{ρ}} - 1 ] \leq {ρ}_{C} [ {d}_{{C}_{ρ}} ] \leq {ρ}_{C} [ {d}_{{C}_{ρ}} + 1 ] and {ρ}_{C} [ {d}_{{C}_{ρ}} ] \geq \frac{{\sum }_{n} {ρ}_{C} [ n ]}{{\dot{d}}_{\hat{C}} - {\dot{d}}_{{C}^{⋁}}}$$

and for every m≤d_{C}_{_{ρ}} it is not fulfilled that ρ_{C}[m−1]≤ρ_{C}[m]≤ρ_{C}[m+1]. In other implementation we can choose d_{C}_{_{ρ}} so that it is an absolute maximum in the range from de to dc. Any other value in the range from \dot{d}_{Č} to \dot{d}_{Ĉ} may be chosen for d_{C}_{_{ρ}}, where an optimal long copy up distance is expected.

If the TNS is active we may choose \dot{d}_{C}=d_{C}_{_{ρ}}.

If the TNS is inactive \dot{d}_{C}= [symbol] _{C} (ρ_{C},d_{C}_{_{ρ}},

$${d}_{{C}_{{F}_{0}}} ,$$

\grave{d}_{C},\grave{ρ}_{C}[\grave{d}_{C}],

$${Δ}_{{\overline{d}}_{{F}_{0}}} ,$$

\grave{ϕ}_{T}_{_{C}}), where \grave{ρ}_{C} is the normalized correlation and \grave{d}_{C} the optimal distance in the previous frame. The flag \grave{ϕ}_{T}_{_{C}} indicates if there was change of tonality in the previous frame. The function [symbol] _{C} returns either d_{C}_{_{ρ}},

$$\\ {d}_{{C}_{{F}_{0}}}$$

or \grave{d}_{C}. The decision which value to return in [symbol] _{C} i primarily based on the values

$$\\ {ρ}_{C} [ {d}_{{C}_{ρ}} ] , {ρ}_{C} [ {d}_{{C}_{{F}_{0}}} ]$$

and ρ_{C}[\grave{d}_{C}]. If the flag \grave{ϕ}_{T}_{_{C}} is true and ρ_{C}[d_{C}_{_{ρ}}] or

$$\\ {ρ}_{C} [ {d}_{{C}_{{F}_{0}}} ]$$

are valid then ρ_{C}[\grave{d}_{C}] is ignored. The values of \grave{ρ}_{C}[\grave{d}_{C}] and

$${Δ}_{{\overline{d}}_{{F}_{0}}}$$

are used in rare cases.

In an example [symbol] _{C} could be defined with the following decisions:
d_{C}_{_{ρ}} is returned if ρ_{C}[d_{C}_{_{ρ}}] is larger than

$$\\ {ρ}_{C} [ {d}_{{C}_{{F}_{0}}} ]$$

for at least

$$\\ {τ}_{{d}_{{C}_{{F}_{0}}}}$$

and larger than ρ_{C}[\grave{d}_{C}] for at least τ_{\grave{d}}_{_{C}}, where

$$\\ {τ}_{{d}_{{C}_{{F}_{0}}}}$$

and τ_{\grave{d}}_{_{C}} are adaptive thresholds that are proportional to the

$$\\ \vert {d}_{{C}_{ρ}} - {d}_{{C}_{{F}_{0}}} \vert$$

and |d_{C}_{_{ρ}}−\grave{d}_{C} respectively. Additionally it may be requested that ρ_{C}[d_{C}_{_{ρ}}] is above some absolute threshold, for an example 0.5
otherwise

$${d}_{{C}_{{F}_{0}}}$$

is returned if

$$\\ {ρ}_{C} [ {d}_{{C}_{{F}_{0}}} ]$$

is larger than ρ_{C}[\grave{d}_{C}] for at least a threshold, for example 0.2
otherwise d_{C}_{_{ρ}} is returned if \grave{ϕ}_{T}_{_{C}} is set and ρ_{C}[d_{C}_{_{ρ}}]0
otherwise

$$\\ {d}_{{C}_{{F}_{0}}}$$

is returned if \grave{ϕ}_{T}_{_{C}} is set and the value of

$${d}_{{C}_{{F}_{0}}}$$

is valid, that is if there is a meaningful pitch lag
otherwise

$${d}_{{C}_{{F}_{0}}}$$

is returned if \grave{ρ}_{C}[\grave{d}_{C}] is small, for example below 0.1, and the value of

$$\\ {d}_{{C}_{{F}_{0}}}$$

is valid, wat is ir there is a meaningful pitch lag, and the pitch lag change from the previous frame is small
otherwise \grave{d}_{C} is returned

The flag \grave{ϕ}_{T}_{_{C}} is set to true if TNS is active or if ρ_{C}[\dot{d}_{C}]<τ_{T}_{_{C}} and the tonality is low, the tonality being low for an example if ϕ_{H} is false or if d̅_{F}_{₀} is zero. τ_{T}_{_{C}} is a value smaller than 1, for example 0.7. The value set to \grave{ϕ}_{T}_{_{C}} is used in the following frame.

The percentual chang of d̅_{F}_{₀} between the previous frame and the current frame

$$\\ {Δ}_{{\overline{d}}_{{F}_{0}}}$$

is also calculated.

The copy-up distance shift Δ_{C} is set to

$${Δ}_{{X}_{{F}_{0}}}$$

unless the optimal copy-up distance \dot{d}_{C} is equivalent to \grave{d}_{C} and

$$\\ {Δ}_{{\overline{d}}_{{F}_{0}}} < {τ}_{{Δ}_{F}}$$

(τ_{Δ}_{_{F}} being a predefined threshold), in which case Δ_{C} is set to the same value as in the previous frame, making it constant over the consecutive frames.

$$\\ {Δ}_{{\overline{d}}_{{F}_{0}}}$$

is a measure of change (e.g. a percentual change) of d̅_{F}_{₀} between the previous frame and the current frame. τ_{Δdi F} could be for example set to 0.1 if

$${Δ}_{{\overline{d}}_{{F}_{0}}}$$

is the perceptual change of d̅_{F}_{₀}. If TNS is active in the frame Δ_{C} is not used.

The minimum copy up source start Š_{C} can for an example be set to i_{T} if the TNS is active, optionally lower bound by

$$⌊ 2.5 {Δ}_{{X}_{{F}_{0}}} ⌋$$

if HFs are tonal, or for an example set to [2.54Δ_{C}] if the TNS is not active in the current frame.

The minimum copy-up distance ď_{C} is for an example set to ┌Δ_{C}┐ if the TNS is inactive. If TNS is active, ď_{C} is for an example set to š_{C} if HF are not tonal, or ď_{C} is set for an example to

$$⌈ {Δ}_{{X}_{{F}_{0}}} ⌈ \frac{{{s}^{⌣}}_{C}}{{Δ}_{{X}_{{F}_{0}}}} ⌉ ⌉$$

if HFs are tonal.

Using for example X_{N}[−1]=Σₙ 2n|X_{D}[n]| as an initial condition, a random noise spectrum X_{N} is constructed as X_{N}[n]=short(31821X_{N}[n−1]+13849), where the function short truncates the result to 16 bits. Any other random noise generator and initial condition may be used. The random noise spectrum X_{N} is then set to zero at the location of non-zero values in X_{D} and optionally the portions in X_{N} between the locations set to zero are windowed, in order to reduce the random noise near the locations of non-zero values in X_{D}.

For each sub-band Bᵢ of length L_{B}_{ᵢ} starting at j_{B}_{ᵢ} in X_{CT} a source spectrum for

$${X}_{{S}_{{B}_{i}}}$$

is found. The sub-band division may be the same as the sub-band division used for coding the zfl, but also can be different, higher or lower.

For an example if TNS is not active and HFs are not tonal then the random noise spectrum X_{N} is used as the source spectrum for all sub-bands. In another example X_{N} is used as the source spectrum for the sub-bands where other sources are empty or for some sub-bands which start below minimal copy-up destination: š_{C}+min(ď_{C},L_{B}_{ᵢ}).

In another example if the TNS is not active and HFs are tonal, a predicted spectrum X_{NP} may be used as the source for the sub-bands which start below š_{C}+\dot{d}_{C} and in which E_{B} is at least 12 dB above E_{B} in neighboring sub-bands, where the predicted spectrum is obtained from the past decoded spectrum or from a signal obtained from the past decoded spectrum (for example from the decoded TD signal).

For cases not contained in the above examples, distance d_{C} may be found so that X_{CT}[s_{C}+m](0≤m<L_{B}_{ᵢ}) or a mixture of the X_{CT}[s_{C}+m] and X_{N}[s_{C}+d_{C}+m] may be used as the source spectrum for

$${X}_{{S}_{{B}_{i}}}$$

that starts at j_{B}_{ᵢ}, where s_{C}=j_{B}_{ᵢ}−d_{C}. In one example if the TNS is active, but starts only at a higher frequency (for example at 4500 Hz) and HFs are not tonal, the mixture of the X_{CT}[s_{C}+m] and X_{N}[s_{C}+d_{C}+m] may be used as the source spectrum if š_{C}+ď_{C}≤j_{B}_{ᵢ}<š_{C}+\dot{d}_{C}; in yet another example only X_{CT}[s_{C}+m] or a spectrum consisting of zeros may be used as the source. If j_{B}_{ᵢ}≥š_{C}+\dot{d}_{C} then d_{C} could be set to \dot{d}_{C}. If the TNS is active then a positive integer n may be found so that

$${j}_{{B}_{i}} - \frac{{\dot{d}}_{C}}{n} \geq {{s}^{⌣}}_{C}$$

and d_{c} may be set to

$$\frac{{\dot{d}}_{C}}{n} ,$$

for example to the smallest such integer n. If the TNS is not active, another positive integer n may be found so that j_{B}_{ᵢ}−\dot{d}_{C}+n·Δ_{C}≥š_{C} and d_{C} is set to \dot{d}_{C}−n·Δ_{C}, for example to the smallest such integer n.

In another example the lowest sub-bands

$${X}_{{S}_{{B}_{i}}}$$

in X_{S} up to a starting frequency f_{ZFStart} may be set to 0, meaning that in the lowest sub-bands X_{CT} may be a copy of X_{DT}.

An example of weighting the source spectrum based on E_{B} in the block “Zero Filling” is given now.

In an example of smoothing the E_{B}, E_{B}_{ᵢ} may be obtained from the zfl, each E_{B}_{ᵢ} corresponding to a sub-band i in E_{B}. E_{B}_{ᵢ} are then smoothed:

$${E}_{{B}_{1 , i}} = \frac{{E}_{{B}_{i - 1}} + 7 {E}_{{B}_{i}}}{8} and {E}_{{B}_{2 , i}} = \frac{7 {E}_{{B}_{i}} + {E}_{{B}_{i + 1}}}{8} .$$

The scaling factor α_{C}_{ᵢ} is calculated for each sub-band Bᵢ depending on the source spectrum:

$${a}_{{C}_{i}} = {g}_{{Q}_{0}} \sqrt{\frac{{L}_{{B}_{i}}}{{{Σ}_{m = 0}^{{L}_{{B}_{i}} - 1} ( {X}_{{S}_{{B}_{i}}} [ m ] )}^{2}}}$$

Additionally the scaling is limited with the factor b_{C}_{ᵢ} calculated as:

$${b}_{{C}_{i}} = \frac{2}{max ( 2 , {a}_{{C}_{i}} \cdot {E}_{{B}_{1 , i}} , {a}_{{C}_{i}} \cdot {E}_{{B}_{2 , i}} )}$$

The source spectrum band

$${X}_{{S}_{{B}_{i}}}$$

[m] (0≤m<L_{B}_{ᵢ}) is split in two halves and each half is scaled, the first half with g_{C}_{_{1,i}}=b_{C}_{ᵢ}·α_{C}_{ᵢ}E_{B}_{_{1,i}} and the second with g_{C}_{_{2,i}}=b_{C}_{ᵢ}·α_{C}_{ᵢ}E_{B}_{_{2,i}}.

Note in the above explanation, α_{C}_{ᵢ} is derived using g_{Q}_{₀} and g_{C}_{_{1,i}} is derived using α_{C}_{ᵢ} and E_{B}_{_{1,i}} and g_{C}_{_{2,i}} is derived using α_{C}_{ᵢ} and

$${E}_{{B}_{2 , i}} . {X}_{{G}_{{B}_{i}}}$$

is derived using

$${X}_{{S}_{{B}_{i}}}$$

and g_{C}_{_{1,i}} and g_{C}_{_{2,i}}. This explanation was used only to clearly show the usage of g_{Q}_{₀}. According to further embodiments that E_{B} may be derived using g_{Q}_{₀} and we can write the above formula in a different way:

$${a}_{{C}_{i}} = {g}_{{Q}_{0}} \sqrt{\frac{{L}_{{B}_{i}}}{{{Σ}_{m = 0}^{{L}_{{B}_{i}} - 1} ( {X}_{{S}_{{B}_{i}}} [ m ] )}^{2}}}$$

Even with this further embodiment, in which E_{B} may be derived using g_{Q}_{ₒ}, the values of g_{C}_{_{1,i}} and g_{C}_{_{2,i}} may be the same as in the previous example.

The scaled source spectrum band

$${X}_{{S}_{{B}_{i}}} ,$$

where the scaled source spectrum band is

$${X}_{{G}_{{B}_{i}}} ,$$

is added to X_{DT}[j_{B}_{ᵢ}+m] to obtain X_{CT}[j_{B}_{ᵢ}+m].

An example of quantizing the energies of the zero quantized lines (as a part of iBPC) is given now.

X_{QZ} is obtained from X_{MR} by setting non-zero quantized lines to zero. For an example the same way as in X_{N}, the values at the location of the non-zero quantized lines in X_{Q} are set to zero and the zero portions between the non-zero quantized lines are windowed in X_{MR}, producing X_{QZ}.

The energy per band i for zero lines (E_{Z}_{ᵢ}) are calculated from X_{QZ}:

$${E}_{{Z}_{i}} = \frac{1}{{g}_{{Q}_{0}}} \sqrt{\frac{{{Σ}_{m = 0}^{{j}_{{B}_{i}} + {L}_{{B}_{i}} - 1} ( {X}_{QZ} [ m ] )}^{2}}{{L}_{{B}_{i}}}}$$

The E_{Z}_{ᵢ} are for an example quantized using step size ⅛ and limited to 6/8. Separate E_{Z}_{ᵢ} are coded as individual zfl only for the sub-bands above f_{EZ}, where f_{EZ} is for an example 3000 Hz, that are completely quantized to zero. Additionally one energy level E_{Z}_{_{S}} is calculated as the mean of all E_{Z}_{ᵢ} from zero sub-bands bellow f_{EZ} and from zero sub-bands above f_{EZ} where E_{Z}_{ᵢ} is quantized to zero, zero sub-band meaning that the complete sub-band is quantized to zero. The low level E_{Z}_{_{S}} is quantized with the step size 1/16 and limited to 3/16. The energy of the individual zero lines in non-zero sub-bands is estimated (e.g. by the decoder) and not coded explicitly.

The values of E_{B}_{ᵢ} are obtained on the decoder side from zfl and the values of E_{B}_{ᵢ} for zero sub-bands correspond to the quantized values of E_{Z}_{ᵢ}. Thus, the value of E_{B} consisting of E_{B}_{ᵢ} may be coded depending on the optimal quantization step g_{Q}_{₀}. This is illustrated by FIG. 3 where the parametric coder 156pc receives as input for g_{Q}_{₀}. In another example other quantization step size specific to the parametric coder may be used, independent of the optimal quantization step g_{Q}_{₀}. In yet another example a non-uniform scalar quantizer or a vector quantizer may be used for coding zfl. Yet it is advantageous in the presented example to use the optimal quantization step g_{Q}_{₀} because of the dependence of the quantization of X_{MR} to zero on the optimal quantization step g_{Q}_{₀}.

### Long Term Prediction (LTP)

The block LTP will be explained now. The time-domain signal y_{C} is used as the input to the LTP, where y_{C} is obtained from X_{C} as output of IMDCT. IMDCT consists of the inverse MDCT, windowing and the Overlap-and-Add. The left overlap part and the non-overlapping part of y_{C} in the current frame is saved in the LTP buffer.

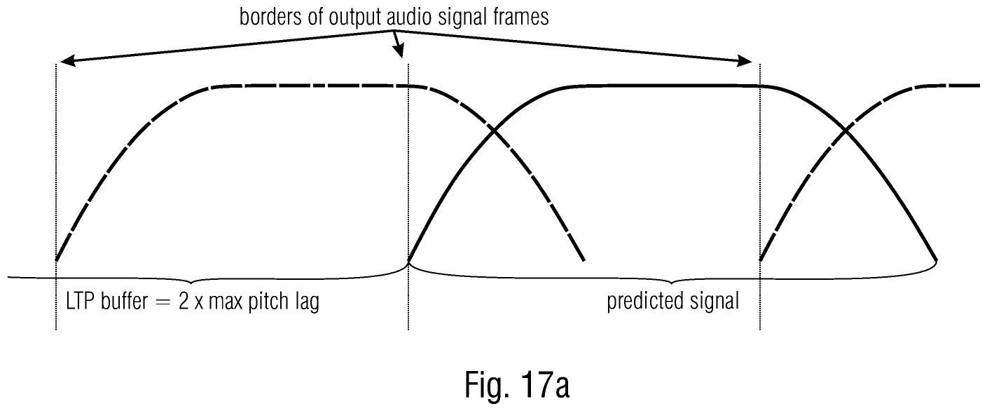

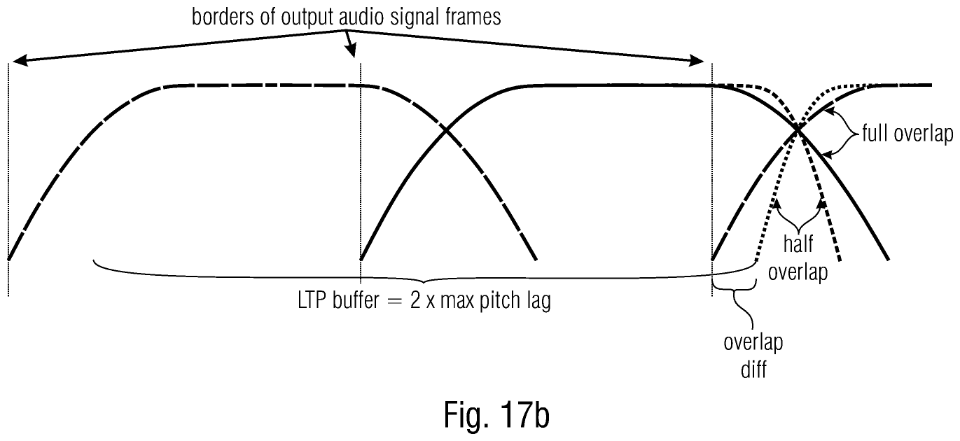

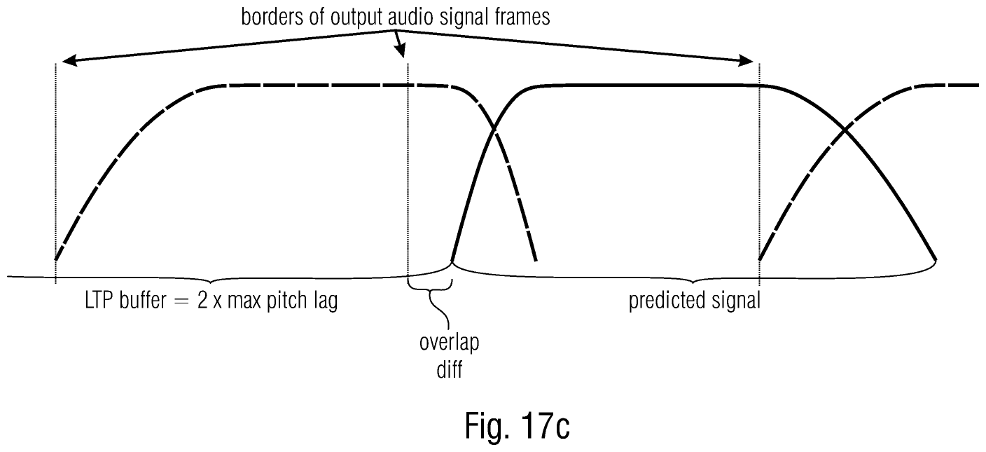

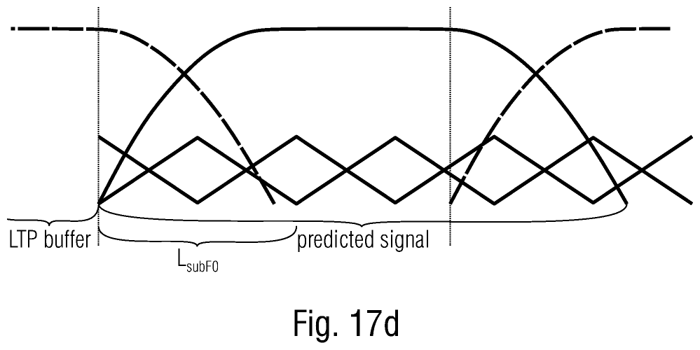

The LTP buffer is used in the following frame in the LTP to produce the predicted signal for the whole window of the MDCT. This is illustrated by FIG. 17a.

If a shorter overlap, for example half overlap, is used for the right overlap in the current window, then also the non-overlapping part “overlap diff” is saved in the LTP buffer. Thus, the samples at the position “overlap diff” (cf. FIG. 17b) will also be put into the LTP buffer, together with the samples at the position between the two vertical lines before the “overlap diff”. The non-overlapping part “overlap diff” is not in the decoder output in the current frame, but only in the following frame (cf. FIGS. 17b and 17c).

If a shorter overlap is used for the left overlap in the current window, the whole non-overlapping part up to the start of the current window is used as a part of the LTP buffer for producing the predicted signal.

The predicted signal for the whole window of the MDCT is produced from the LTP buffer. The time interval of the window length is split into overlapping sub-intervals of length L_{subF0} with the hop size L_{updateF0}=L_{subF0}/2. Other hop sizes and relations between the sub-interval length and the hop size may be used. The overlap length may be L_{updateF0}−L_{subF0} or smaller. L_{subF0} is chosen so that no significant pitch change is expected within the sub-intervals. In an example L_{updateF0} is an integer closest to d̅_{F}_{₀}/2, but not greater than d̅_{F}_{₀}/2, and L_{subF0} is set to 2L_{updateF0}. As illustrated by FIG. 17d. In another example it may be additionally requested that the frame length or the window length is divisible by L_{updateF0}.

Below, an example of “calculation means (1030) configured to derive sub-interval parameters from the encoded pitch parameter dependent on a position of the sub-intervals within the interval associated with the frame of the encoded audio signal” and also an example of “parameters are derived from the encoded pitch parameter and the sub-interval position within the interval associated with the frame of the encoded audio signal” will be given. For each sub-interval pitch lag at the center of the sub-interval i_{subCenter} is obtained from the pitch contour. In the first step, the sub-interval pitch lag d_{subF0} is set to the pitch lag at the position of the sub-interval center d_{contour}[i_{subCenter}]. As long as the distance of the sub-interval end to the window start (i_{subCenter}+L_{subF0}/2) is bigger than d_{subF0}, d_{subF0} is increased for the value of the pitch lag from the pitch contour at position d_{subF0} to the left of the sub-interval center, that is d_{subF0}=d_{subF0}+d_{contour}[i_{subCenter}−d_{subF0}] until i_{subCenter}+L_{subF0}/2<d_{subF0}. The distance of the sub-interval end to the window start (i_{subCenter}+L_{subF0}/2) may also be termed the sub-interval end.

In each sub-interval the predicted signal is constructed using the LTP buffer and a filter with the transfer function H_{LTP}(z), where:

H_{LTP}(z)=B(z,T_{fr})z^{-T}^{ᵢₙₜ}

where Tᵢₙₜ is the integer part of d_{subF0}, that is Tᵢₙₜ=└d_{subF0}┘, and T_{fr} is the fractional part of d_{subF0}, that is T_{fr}=d_{subF0}−Tᵢₙₜ, and B(z,T_{fr}) is a fractional delay filter. B(z,T_{fr}) may have a low-pass characteristics (or it may de-emphasize the high frequencies). The prediction signal is then cross-faded in the overlap regions of the sub-intervals. H_{LTP2}(z) Alternatively the predicted signal can be constructed using the method with cascaded filters as described in [21], with zero input response (ZIR) of a filter based on the

filter with the transfer function and the LTP buffer used as the initial output of the filter, where:

$${H}_{L T P 2} ( z ) = \frac{1}{1 - g B ( z , {T}_{f r} ) {z}^{- {T}_{i n t}}}$$

Examples for B(z,T_{fr}):

B(z, 0/4=0.0000z⁻²+0.2325z⁻¹+0.5349z⁰+0.2325z¹

B(z,¼=0.0152z⁻²+0.3400z⁻¹+0.5094z⁰+0.1353z¹

B(z, 2/4=0.0609z⁻²+0.4391z⁻¹+0.4391z⁰+0.0609z¹

B(z,¾=0.1353z⁻²+0.5094z⁻¹+0.3400z⁰+0.0152z¹

In the examples T_{fr} is usually rounded to the nearest value from a list of values and for each value in the list the filter B is predefined.

The predicted signal XP′ is windowed, with the same window as the window used to produce X_{M}, and transformed via MDCT to obtain X_{P}.

Below, an example of means for modifying the predicted spectrum, or a derivative of the predicted spectrum, dependent on a parameter derived from the encoded pitch parameter will be given. The magnitudes of the MDCT coefficients at least n_{Fsafeguard} away from the harmonics in X_{P} are set to zero (or multiplied with a positive factor smaller than 1), where N_{Fsafeguard} is for example 10. Alternatively other windows than the rectangular window may be used to reduce the magnitudes between the harmonics. It is considered that the harmonics in X_{P} are at bin locations that are integer multiples of iF0=2L_{M}/d̅_{F}_{_{corrected}}, where L_{M} is X_{P} length and d̅_{F}_{_{corrected}} is the average corrected pitch lag. The harmonic locations are └n·iF0┘. This removes noise between harmonics, especially when the half pitch lag is detected.

The spectral envelope of X_{P} is perceptually flattened with the same method as X_{M}, for example via SNS_{E}, to obtain X_{PS}.

Below an example of “a number of predictable harmonics is determined based on the coded pitch parameter is given. Using X_{PS}, X_{MS} and d̅_{F}_{_{corrected}} the number of predictable harmonics n_{LTP} is determined. N_{LTP} is coded and transmitted to the decoder. Up to N_{LTP} harmonics may be predicted, for example N_{LTP}=8. X_{PS} and X_{MS} are divided into N_{LTP} bands of length └iF0+0.5┘, each band starting at └(n−0.5)iF0┘, n∈{1, . . . , N_{LTP}}. n_{LTP} is chosen so that for all n≤n_{LTP} the ratio of the energy of X_{MS}−X_{PS} and X_{MS} is below a threshold τ_{LTP}, for example τ_{LTP}=0.7. If there is no such n, then n_{LTP}=0 and the LTP is not active in the current frame. It is signaled with a flag if the LTP is active or not. Instead of X_{PS} and X_{MS}, X_{P} and X_{M} may be used. Instead of X_{PS} and X_{MS}, X_{PS} and X_{MT} may be used. Alternatively, the number of predictable harmonics may be determined based on a pitch contour d_{contour}.

If the LTP is active then first └(n_{LTP}+0.5)iF0┘ coefficients of X_{PS}, except the zeroth coefficient, are subtracted from X_{MT} to produce X_{MR}. The zeroth and the coefficients above └(n_{LTP}+0.5)iF0┘ are copied from X_{MT} to X_{MR}.

In a process of a quantization, X_{Q} is obtained from X_{MR}, and X_{Q} is coded as spect, and by decoding X_{D} is obtained from spect.

Below, an example of a combiner (157) configured to combine at least a portion of the prediction spectrum (X_{P}) or a portion of the derivative of the predicted spectrum (X_{PS}) with the error spectrum (X_{D}) will be given. If the LTP is active then first └(n_{LTP}+0.5)iF0┘ coefficients of X_{PS}, except the zeroth coefficient, are added to X_{P} to produce X_{DT}. The zeroth and the coefficients above └(n_{LTP}+0.5)iF0┘ are copied from X_{D} to X_{DT}.

Below, the optional features of harmonic post-filtering will be discussed.

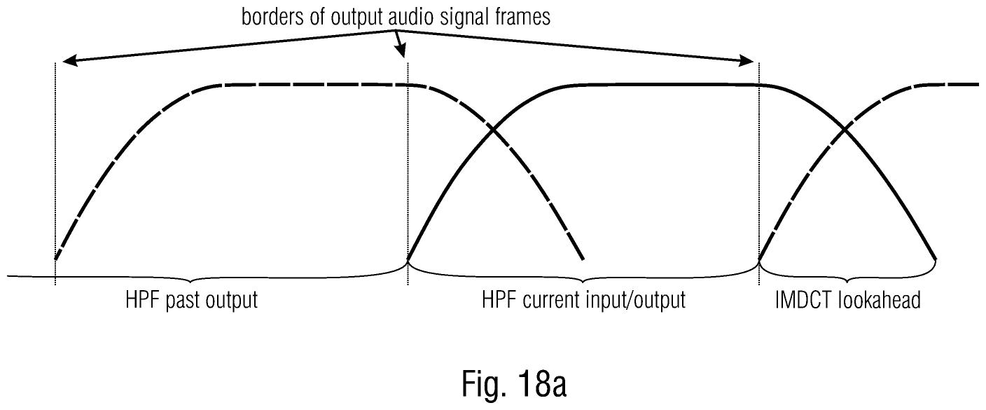

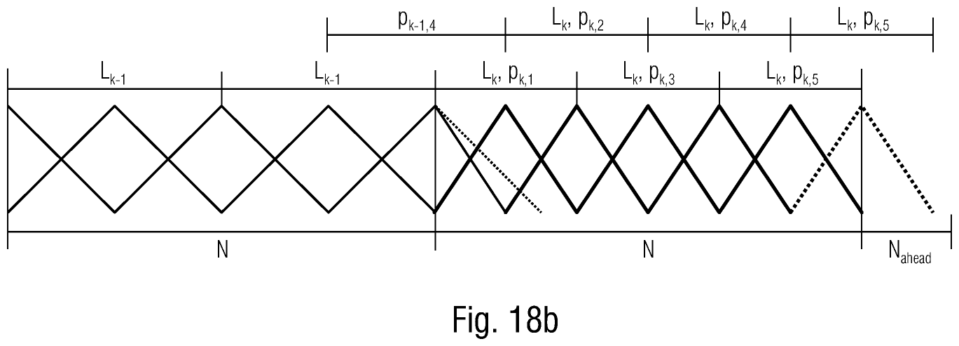

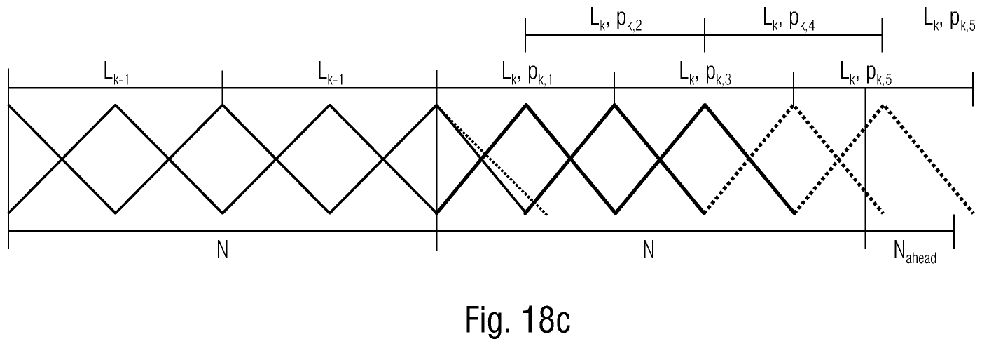

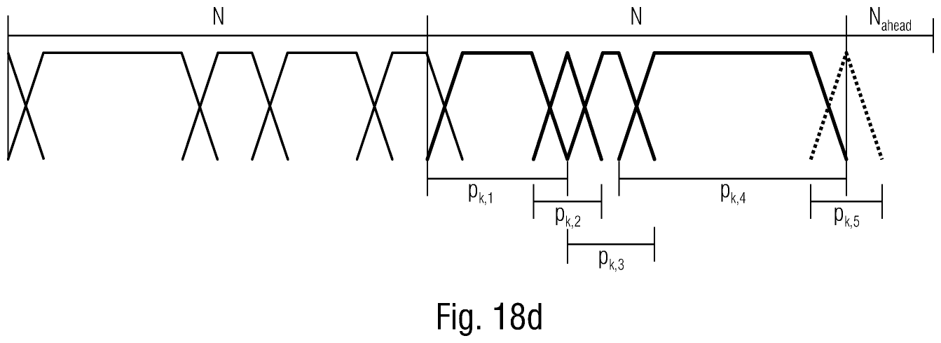

A time-domain signal y_{C} is obtained from X_{C} as output of IMDCT where IMDCT consists of the inverse MDCT, windowing and the Overlap-and-Add. A harmonic post-filter (HPF) that follows pitch contour is applied on y_{C} to reduce noise between harmonics and to output y_{H}. Instead of y_{C}, a combination of y_{C} and a time domain signal y_{P}, constructed from the decoded pulse waveforms, may be used as the input to the HPF. As illustrated by FIG. 18a.

The HPF input for the current frame k is y_{C}[n](0≤n<N). The past output samples y_{H}[n] (−d_{HPFmax}≤n<0, where d_{HPFmax} is at least the maximum pitch lag) are also available. N_{ahead} IMDCT look-ahead samples are also available, that may include time aliased portions of the right overlap region of the inverse MDCT output. We show an example where an time interval on which HPF is applied is equal to the current frame, but different intervals may be used. The location of the HPF current input/output, the HPF past output and the IMDCT look-ahead relative to the MDCT/IMDCT windows is illustrated by FIG. 18a showing also the overlapping part that may be added as usual to produce Overlap-and-Add.

If it is signaled in the bit-stream that the HPF should use constant parameters, a smoothing is used at the beginning of the current frame, followed by the HPF with constant parameters on the remaining of the frame. Alternatively, a pitch analysis may be performed on y_{C} to decide if constant parameters should be used. The length of the region where the smoothing is used may be dependent on pitch parameters.

When constant parameters are not signaled, the HPF input is split into overlapping sub-intervals of length Lₖ with the hop size L_{k,update}=Lₖ/2. Other hop sizes may be used. The overlap length may be L_{k,update}−Lₖ or smaller. Lₖ is chosen so that no significant pitch change is expected within the sub-intervals. In an example L_{k,update} is an integer closest to pitch_mid/2, but not greater than pitch_mid/2, and Lₖ is set to 2L_{k,update}. Instead of pitch_mid some other values may be used, for example mean of pitch_mid and pitch_start or a value obtained from a pitch analysis on y_{C} or for example an expected minimum pitch lag in the interval for signals with varying pitch. Alternatively a fixed number of sub-intervals may be chosen. In another example it may be additionally requested that the frame length is divisible by L_{k,update} (cf. FIG. 18b).

We say that the number of sub-intervals in the current interval k is Kₖ, in the previous interval k−1 is Kₖ₋₁ and in the following interval k+1 is Kₖ₊₁. In the example in FIG. 18b Kₖ=6 and Kₖ₋₁=4.

In other example it is possible that the current (time) interval is split into non integer number of sub-intervals and/or that the length of the sub-intervals change within the current interval as shown below. This is illustrated by FIGS. 18c and 18d.

For each sub-interval l in the current interval k (1≤l≤Kₖ), sub-interval pitch lag p_{k,l} is found using a pitch search algorithm, which may be the same as the pitch search used for obtaining the pitch contour or different from it. The pitch search for sub-interval l may use values derived from the coded pitch lag (pitch_mid, pitch_end) to reduce the complexity of the search and/or to increase the stability of the values p_{k,l} across the sub-intervals, for example the values derived from the coded pitch lag may be the values of the pitch contour. In other example, parameters found by a global pitch analysis in the complete interval of y_{C} may be used instead of the coded pitch lag to reduce the complexity of the search and/or the stability of the values p_{k,l} across the sub-intervals. In another example, when searching for the sub-interval pitch lag, it is assumed that an intermediate output of the harmonic post-filtering for previous sub-intervals is available and used in the pitch search (including sub-intervals of the previous intervals).

The N_{ahead} (potentially time aliased) look-ahead samples may also be used for finding pitch in sub-intervals that cross the interval/frame border or, for example if the look-ahead is not available, a delay may be introduced in the decoder in order to have look-ahead for the last sub-interval in the interval. Alternatively a value derived from the coded pitch lag (pitch_mid, pitch_end) may be used for p_{k,K}_{ₖ}.

For the harmonic post-filtering, the gain adaptive harmonic post-filter may be used. In the example the HPF has the transfer function:

$$H ( z ) = \frac{1 - α β h B ( z , 0 )}{1 - β h g B ( z , {T}_{f r} ) {z}^{- {T}_{i n t}}}$$

where B(z,T_{fr}) is a fractional delay filter. B(z,T_{fr}) may be the same as the fractional delay filters used in the LTP or different from them, as the choice is independent. In the HPF, B(z,T_{fr}) acts also as a low-pass (or a tilt filter that de-emphasizes the high frequencies). An example for the difference equation for the gain adaptive harmonic post-filter with the transfer function H(z) and bⱼ(T_{fr}) as coefficients of B(z,T_{fr}) is:

$$y [ n ] = x [ n ] - β h ( α {\sum }_{i = - m}^{m + 1} {b}_{i} ( 0 ) x [ n + i ] - g {\sum }_{j = - m}^{m + 1} {b}_{j} ( {T}_{f r} ) y [ n - {T}_{i n t} + j ] )$$

Instead of a low-pass filter with a fractional delay, the identity filter may be used, giving B(z,T_{fr})=1 and the difference equation:

y[n]=x[n]−βh(αx[n]−gy[n−Tᵢₙₜ])

The parameter g is the optimal gain. It models the amplitude change (modulation) of the signal and is signal adaptive.

The parameter h is the harmonicity level. It controls the desired increase of the signal harmonicity and is signal adaptive. The parameter β also controls the increase of the signal harmonicity and is constant or dependent on the sampling rate and bit-rate. The parameter β may also be equal to 1. The value of the product βh should be between 0 and 1, 0 producing no change in the harmonicity and 1 maximally increasing the harmonicity. In practice it is usual that βh<0.75.

The feed-forward part of the harmonic post-filter (that is 1−αβhB (z,0)) acts as a high-pass (or a tilt filter that de-emphasizes the low frequencies). The parameter α determines the strength of the high-pass filtering (or in another words it controls the de-emphasis tilt) and has value between 0 and 1. The parameter α is constant or dependent on the sampling rate and bit-rate. Value between 0.5 and 1 is of advantage in embodiments.

For each sub-interval, optimal gain g_{k,l} and harmonicity level h_{k,l} is found or in some cases it could be derived from other parameters.

For a given B(z,T_{fr}) we define a function for shifting/filtering a signal as:

$${y}^{- p} [ n ] = {\sum }_{j = - 1}^{2} {b}_{j} ( {T}_{f r} ) {y}_{H} [ n - {T}_{i n t} + j ] , {T}_{i n t} = ⌊ p ⌋ , {T}_{f r} = p - {T}_{i n t}$$

$$\overline{{y}_{C}} [ n ] = {y}_{C}^{- 0} [ n ]$$

$${y}_{L , l} [ n ] = {y}_{C} [ n + ( l - 1 ) L ]$$

With these definitions y_{L,l}[n] represents for 0≤n<L the signal y_{C} in a (sub-)interval l with length L, y̅_̅{̅C̅}̅ represents filtering of y_{C} with B(z, 0), y^{-p} represents shifting of y_{H} for (possibly fractional) p samples.

We define normalized correlation normcorr(y_{C},y_{H},l,L,p) of signals y_{C} and y_{H} at (sub-)interval l with length L and shift p as:

$$normcorr ( {y}_{C} , {y}_{H} , l , L , p ) = \frac{{\sum }_{n = 0}^{L - 1} {\overline{y}}_{L , l} [ n ] {y}_{L , l}^{- p} [ n ]}{\sqrt{{\sum }_{n = 0}^{L - 1} {( {\overline{y}}_{L , l} [ n ] )}^{2} {\sum }_{n = 0}^{{L}_{k} - 1} {( {y}_{L , l}^{- p} [ n ] )}^{2}}}$$

An alternative definition of normcorr(y_{C},y_{H},l,L,p) may be:

$$normcorr ( {y}_{C} , {y}_{H} , l , L , p ) = {\sum }_{j = - 1}^{2} {b}_{j} ( {T}_{f r} ) \frac{{\sum }_{n = 0}^{L - 1} {y}_{L , l} [ n ] {y}_{L , l} [ n - {T}_{i n t} ]}{\sqrt{{\sum }_{n = 0}^{L - 1} {( {y}_{L , l} [ n ] )}^{2} {\sum }_{n = 0}^{{L}_{k} - 1} {( {y}_{L , l} [ n - {T}_{i n t} ] )}^{2}}}$$

$${T}_{i n t} = ⌊ p ⌋ , {T}_{f r} = p - {T}_{i n t}$$

In the alternative definition y_{L,l}[n−Tᵢₙₜ] represents y_{H} in the past sub-intervals for n<Tᵢₙₜ.

In the definitions above we have used the 4^{th} order B(z,T_{fr}). Any other order may be used, requiring change in the range for j. In the example where B(z,T_{fr})=1, we get y̅=y_{C} and y^{-p}[n]=y_{H}[n−└p┘] which may be used if only integer shifts are considered.

The normalized correlation defined in this manner allows calculation for fractional shifts p.

The parameters of normcorr l and L define the window for the normalized correlation. In the above definition rectangular window is used. Any other type of window (e.g. Hann, Cosine) may be used instead which can be done multiplying y̅_{L,l}[n] and y_{L,l}^{-p}[n] with w[n] where w[n] represents the window.

To get the normalized correlation on a sub-interval we would set l to the interval number and L to the length of the sub-interval.

The output of y_{L,l}^{-p}[n] represents the ZIR of the gain adaptive harmonic post-filter H(z) for the sub-frame l, with β=h=g=1 and Tᵢₙₜ=└p┘ and T_{fr}=p−Tᵢₙₜ.

The optimal gain g_{k,l} models the amplitude change (modulation) in the sub-frame l. It may be for example calculated as a correlation of the predicted signal with the low passed input divided by the energy of the predicted signal:

$${g}_{k , l} = \frac{{\sum }_{n = 0}^{{L}_{k} - 1} {\overline{y}}_{{L}_{k} , l} [ n ] {y}_{{L}_{k} , l}^{- {p}_{k , l}} [ n ]}{{\sum }_{n = 0}^{{L}_{k} - 1} {( {y}_{{L}_{k} , l}^{- {p}_{k , l}} [ n ] )}^{2}}$$

In another example the optimal gain g_{k,l} may be calculated as the energy of the low passed input divided by the energy of the predicted signal:

$${g}_{k , l} = \frac{{\sum }_{n = 0}^{{L}_{k} - 1} {( {\overline{y}}_{{L}_{k} , l} [ n ] )}^{2}}{{\sum }_{n = 0}^{{L}_{k} - 1} {( {y}_{{L}_{k} , l}^{- {p}_{k , l}} [ n ] )}^{2}}$$

The harmonicity level h_{k,l} controls the desired increase of the signal harmonicity and can be for example calculated as square of the normalized correlation:

h_{k,l}=normcorr(y_{C},y_{H},l,Lₖ,p_{k,l})²

Usually the normalized correlation of a sub-interval is already available from the pitch search at the sub-interval.

The harmonicity level h_{k,l} may also be modified depending on the LTP and/or depending on the decoded spectrum characteristics. For an example we may set:

h_{k,l}=h_{modLTP}h_{modTilt}normcorr(y_{C},y_{H},l,Lₖ,p_{k,l})²

where h_{modLTP} is a value between 0 and 1 and proportional to the number of harmonics predicted by the LTP and h_{modTilt} is a value between 0 and 1 and inverse proportional to a tilt of X_{C}. In an example h_{modLTP}=0.5 if n_{LTP} is zero, otherwise h_{modLTP}=0.7+0.3n_{LTP}/N_{LTP}. The tilt of X_{C} may be the ratio of the energy of the first 7 spectral coefficients to the energy of the following 43 coefficients.

Once we have calculated the parameters for the sub-interval l, we can produce the intermediate output of the harmonic post-filtering for the part of the sub-interval l that is not overlapping with the sub-interval l+1. As written above, this intermediate output is used in finding the parameters for the subsequent sub-intervals.

Each sub-interval is overlapping and a smoothing operation between two filter parameters is used. The smoothing as described in [3] may be used.

Below, advantageous embodiments will be discussed

According to embodiments, an apparatus for encoding an audio signal is provided the apparatus comprises the following entities:
a time-spectrum converter (MDCT) for converting an audio signal having a sampling rate into a spectral representation;
a spectrum shaper (SNS) for providing a perceptually flattened spectral representation from the spectral representation, where the perceptually flattened spectral representation is divided into sub-bands of different (higher) frequency resolution than the spectrum shaper;
a rate-distortion loop for finding an optimal quantization step;
a quantizer for providing a quantized spectrum of the perceptually flattened spectral representation, or a derivative of the perceptually flattened spectral representation, depending on the optimal quantization step;
a lossless spectrum coder for providing a coded representation of the quantized spectrum;
a band-wise parametric coder for providing a parametric representation of the perceptually flattened spectral representation, or a derivative of the perceptually flattened spectral representation, where the parametric representation depends on the optimal quantization step and consists of parameters describing energy in sub-bands where the quantized spectrum is zero, so that at least two sub-bands have different parameters or that at least one parameter is restricted to only one sub-band.

Another embodiment provides an apparatus for encoding an audio signal which, vice versa comprises the following entities:
a time-spectrum converter (MDCT) for converting an audio signal having a sampling rate into a spectral representation;
a spectrum shaper (SNS) for providing a perceptually flattened spectral representation from the spectral representation, where the perceptually flattened spectral representation is divided into sub-bands of different (higher) frequency resolution than the spectrum shaper;
a rate-distortion loop for finding an optimal quantization step, that provides in each loop iteration a quantization step and chooses the optimal quantization step depending on the quantization steps;
a quantizer for providing a quantized spectrum of the perceptually flattened spectral, or a derivative of the perceptually flattened spectral representation, representation depending on the quantization step;
a band-wise parametric coder for providing a parametric representation of the perceptually flattened spectral representation, or a derivative of the perceptually flattened spectral representation, where the parametric representation depends on the optimal quantization step and consists of parameters describing energy in sub-bands where the quantized spectrum is zero;
a spectrum coder decision for providing a decision if a joint coding of a coded representation of the quantized spectrum and a coded representation of the parametric zero sub-bands representation fulfills a constraint that the total number of bits for the joint coding is below a predetermined limit,
where both the coded representation of the quantized spectrum and the coded representation of the parametric zero sub-bands require variable number of bits depending on the perceptually flattened spectral representation, or a derivative of the perceptually flattened spectral representation, and the quantization step.

According to embodiments, both apparatuses may be enhanced by a modifier that adaptively sets to zero at least a sub-band in the quantized spectrum, depending on the content of the sub-band in the quantized spectrum and in the perceptually flattened spectral representation.

Here a two-step band-wise parametric coder may be used. The two step band-wise parametric coder is configured for providing a parametric representation of the perceptually flattened spectral representation, or a derivative of the perceptually flattened spectral representation, depending on the quantization step, for sub-bands where the quantized spectrum is zero(, so that at least two sub-bands have different parametric representation);
where in the first step of the two step band-wise parametric coder provides individual parametric representations for sub-bands above frequency f_{EZ} where the quantized spectrum is zero,
and in the second step provides an additional average parametric representation for sub-bands above frequency f_{EZ} where the individual parametric representation is zero and for sub-bands below f_{EZ}.

Another embodiment provides an apparatus for decoding an encoded audio signal. The apparatus for decoding comprises the following entities:
a spectral domain audio decoder for generating a decoded spectrum depending on a quantization step, where the decoded spectrum is divided into sub-bands;
a band-wise parametric decoder that identifies zero sub-bands, consisting only of zeros, in the decoded spectrum and decodes a parametric representation of the zero sub-bands using the quantization step, where the parametric representation consists of parameters describing energy in the zero sub-bands, so that at least two sub-bands have different parameters or that at least one parameter is restricted to only one sub-band;
a band-wise generator that provides a band-wise generated spectrum depending on the parametric representation of the zero sub-bands;
a combiner that provides a band-wise combined spectrum as a combination of: the band-wise generated spectrum and the decoded spectrum; or
the band-wise generated spectrum and a combination of a predicted spectrum and the decoded spectrum;
a spectrum shaper (SNS) for providing a reshaped spectrum from the band-wise combined spectrum, or a derivative of the band-wise combined spectrum, where the spectrum shaper has different (lower) frequency resolution than the sub-band division; and
a spectrum-time converter for converting the reshaped spectrum into a time representation.

Another embodiment provides a band-wise parametric spectrum generator providing a generated spectrum that is combined with the decoded spectrum; or
a combination of a predicted spectrum and the decoded spectrum,
where the generated spectrum is band-wise obtained from a source spectrum, the source spectrum being one of:
a zero spectrum or
a second prediction spectrum or
a random noise spectrum or
the combination of the already generated part and the decoded spectrum (and a predicted spectrum)
a combination of them
with at least in some cases the source being the combination of the already generated part and the decoded spectrum (and a predicted spectrum).

Note the source spectrum may, according to further embodiments, be weighted based on energy parameters of zero sub-bands. The choice of the source spectrum for a sub-band is dependent on the sub-band positon, a power spectrum estimate, energy parameters, pitch information and temporal information.

According to embodiments, a number of parameters describing the spectral representation (X_{MR}) may depend on the quantized representation (X_{Q}).

Note in yet another embodiment, sub-bands (that is sub-band borders) for the iBPC, “zfl decode” and “Zero Filling” could be derived from the positions of the zero spectral coefficients in X_{D} and/or X_{Q}.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] 3rd Generation Partnership Project; Technical Specification Group Services and System Aspects; Audio codec processing functions; Extended Adaptive Multi-Rate—Wideband (AMR-WB+) codec; Transcoding functions (Release 16), no. 26.290. 3GPP, 2020.
[2] N. Rettelbach, B. Grill, G. Fuchs, S. Geyrsberger, M. Multrus, H. Popp, J. Herre, S. Wabnik, G. Schuller, and J. Hirschfeld, “Audio Encoder, Audio Decoder, Methods For Encoding And Decoding An Audio Signal, Audio Stream And Computer Program,” PCT/EP2009/0046022009.
[3] S. Disch, M. Gayer, C. Helmrich, G. Markovic, and M. Luis Valero, “Noise Filling Concept,” PCT/EP2014/0516302014.
[4] J. Herre and D. Schultz, “Extending the MPEG-4 AAC Codec by Perceptual Noise Substitution,” in Audio Engineering Society Convention 104, 1998.
[5] F. Nagel, S. Disch, and S. Wilde, “A continuous modulated single sideband bandwidth extension,” in 2010 IEEE International Conference on Acoustics, Speech and Signal Processing, 2010, pp. 357-360.
[6] C. Neukam, F. Nagel, G. Schuller, and M. Schnabel, “A MDCT based harmonic spectral bandwidth extension method,” in 2013 IEEE International Conference on Acoustics, Speech and Signal Processing, 2013, pp. 566-570.
[7] S. Disch, R. Geiger, C. Helmrich, F. Nagel, C. Neukam, K. Schmidt, and M. Fischer, “Apparatus, Method And Computer Program For Decoding An Encoded Audio Signal,” PCT/EP2014/0651182013.
[8] S. Disch, F. Nagel, R. Geiger, B. N. Thoshkahna, K. Schmidt, S. Bayer, C. Neukam, B. Edler, and C. Helmrich, “Apparatus And Method For Encoding Or Decoding An Audio Signal With Intelligent Gap Filling In The Spectral Domain,” PCT/EP2014/0651232013.
[9] S. Disch, F. Nagel, R. Geiger, B. N. Thoshkahna, K. Schmidt, S. Bayer, C. Neukam, B. Edler, and C. Helmrich, “Apparatus And Method For Encoding And Decoding An Encoded Audio Signal Using Temporal Noise/Patch Shaping,”PCT/EP2014/0651232013.
[10] S. Disch, A. Niedermeier, C. R. Helmrich, C. Neukam, K. Schmidt, R. Geiger, J. Lecomte, F. Ghido, F. Nagel, and B. Edler, “Intelligent Gap Filling in Perceptual Transform Coding of Audio,” 2016.
[11] S. Disch, S. van de Par, A. Niedermeier, E. Burdiel Pérez, A. Berasategui Ceberio, and B. Edler, “Improved Psychoacoustic Model for Efficient Perceptual Audio Codecs,” in Audio Engineering Society Convention 145, 2018.
[12] C. R. Helmrich, A. Niedermeier, S. Disch, and F. Ghido, “Spectral envelope reconstruction via IGF for audio transform coding,” in 2015 IEEE International Conference on Acoustics, Speech and Signal Processing (ICASSP), 2015, pp. 389-393.
[13] C. Neukam, S. Disch, F. Nagel, A. Niedermeier, K. Schmidt, and B. N. Thoshkahna, “Apparatus And Method For Decoding And Encoding An Audio Signal Using Adaptive Spectral Tile Selection,” PCT/EP2014/0651162013.
[14] A. Niedermeier, C. Ertel, R. Geiger, F. Ghido, and C. Helmrich, “Apparatus And Method For Decoding Or Encoding An Audio Signal Using Energy Information Values For A Reconstruction Band,” PCT/EP2014/0651102013.
[15] S. Disch, B. Schubert, R. Geiger, and M. Dietz, “Apparatus And Method For Audio Encoding And Decoding Employing Sinusoidal Substitution,” PCT/EP2012/0767462012.
[16] S. Disch, B. Schubert, R. Geiger, B. Edler, and M. Dietz, “Apparatus And Method For Efficient Synthesis Of Sinusoids And Sweeps By Employing Spectral Patterns,” PCT/EP2013/0695922013.
[17] M. Dietz, G. Fuchs, C. Helmrich, and G. Markovic, “Low-Complexity Tonality-Adaptive Audio Signal Quantization,” PCT/EP2014/0516242014.
[18] M. Oger, S. Ragot, and M. Antonini, “Model-based deadzone optimization for stack-run audio coding with uniform scalar quantization,” in 2008 IEEE International Conference on Acoustics, Speech and Signal Processing, 2008, pp. 4761-4764.
[19] C. Helmrich, J. Lecomte, G. Markovic, M. Schnell, B. Edler, and S. Reuschl, “Apparatus And Method For Encoding Or Decoding An Audio Signal Using A Transient-Location Dependent Overlap,” PCT/EP2014/053293, 2014.
[20] 3rd Generation Partnership Project; Technical Specification Group Services and System Aspects; Codec for Enhanced Voice Services (EVS); Detailed algorithmic description, no. 26.445. 3GPP, 2019.
[21] G. Markovic, E. Ravelli, M. Dietz, and B. Grill, “Signal Filtering,” PCT/EP2018/080837, 2018.
[22] E. Ravelli, M. Schnell, C. Benndorf, M. Lutzky, and M. Dietz, Apparatus And Method For Encoding And Decoding An Audio Signal Using Downsampling Or Interpolation Of Scale Parameters, U.S. Patent PCT/EP2017/078921.
[23] E. Ravelli, M. Schnell, C. Benndorf, M. Lutzky, M. Dietz, and S. Korse, Apparatus And Method For Encoding And Decoding An Audio Signal Using Downsampling Or Interpolation Of Scale Parameters, U.S. Patent PCT/EP2018/0801372018.
[24] Low Complexity Communication Codec. Bluetooth, 2020.
[25] Digital Enhanced Cordless Telecommunications (DECT); Low Complexity Communication Codec plus (LC3plus), no. 103 634. ETSI, 2019.

1. An encoder for encoding a spectral representation of audio signal divided into a plurality of sub-bands, wherein the spectral representation comprises frequency bins or of frequency coefficients and wherein at least one sub-band comprises more than one frequency bin, the encoder comprising:
a quantizer configured to generate a quantized representation of the spectral representation of audio signal divided into the plurality sub-bands;
a band-wise parametric coder configured to provide a coded parametric representation of the spectral representation depending on the quantized representation, wherein the coded parametric representation comprises parameters describing the spectral representation in the sub-bands or coded versions of the parameters describing the spectral representation in the sub-bands; wherein there are at least two sub-bands being different and the parameters describing the spectral representation in the at least two sub-bands being different wherein the parameters describe the energy in the sub-bands;
wherein at least one sub-band of the plurality of sub-bands is quantized to zero or wherein a spectral representation for at least one sub-band of the plurality of sub-bands is zero in the quantized representation.

2. The encoder according to claim 1,
wherein the band-wise parametric coder determines the at least one sub-band of the plurality of sub-bands in the quantized representation quantized to zero and wherein the band-wise parametric coder codes the at least one sub-band of the plurality of sub-bands quantized to zero in the quantized representation; or
wherein the parameters describe the energy in the sub-bands that are quantized to zero.

3. The encoder according to claim 1, wherein the coded parametric representation uses variable number of bits or wherein the number of bits used for representing the coded parametric representation is dependent on the spectral representation of audio signal; or
wherein coded representation uses variable number of bits or wherein the number of bits used for representing the coded representation is dependent on the spectral representation of audio signal; or
wherein coded representation uses entropy coding with variable number of bits; or wherein the required number of bits for the entropy coding of the coded parametric representation is calculated; or
wherein the number of bits used for representing the coded parametric representation and a coded representation is below a predetermined threshold.

4. The encoder according to claim 1, further comprising a spectrum coder configured to generate a coded representation of the quantized representation; or
wherein the band-wise parametric coder together with a spectrum coder forms a joint coder; or wherein the band-wise parametric coder together with a spectrum coder are configured to jointly acquire a coded version of the spectral representation of audio signal.

5. The encoder according to claim 1, further comprising a time-spectrum converter or an MDCT converter configured for converting an audio signal comprising a sampling rate into the spectral representation to acquire the spectral representation.

6. The encoder according to claim 1 for encoding an audio signal, wherein the spectral representation is perceptually flattened; or
further comprising a spectral shaper which is configured for providing a perceptually flattened spectral representation from the spectral representation; or
wherein the perceptually flattened spectral representation is divided into sub-bands of different or higher frequency resolution than a coded spectral shape used for spectral flattening; or
further comprising a processor for processing an input signal of a time-spectrum converter or an MDCT converter with an LP filter in order to spectrally flatten the audio signal.

7. The encoder according to claim 1, further comprising a rate-distortion loop configured for determining an optimal quantization step or for estimating an optimal quantization step; or
further comprising a rate-distortion loop, wherein the rate distortion loop is configured to perform at least two iteration steps or at least two iteration steps for two quantization steps; or
further comprising a rate-distortion loop, wherein the rate distortion loop is configured to adapt a quantization step dependent on previous quantization steps or to adapt the quantization step dependent on previous quantization steps so as to determine an optimal quantization step.

8. The encoder according to claim 7, wherein the rate distortion loop comprises a bit counter configured to estimate bits used for coding and a recoder configured to recode the parameters describing the spectral representation.

9. The encoder according to claim 1, wherein the number of the parameters describing the spectral representation depends on the quantized representation.

10. The encoder according to claim 4, further comprising a spectrum coder decision entity configured for providing a decision if a joint coding of a coded representation of the quantized representation; and the coded parametric representation fulfills a constraint that a total number of bits for the joint coding is below a predetermined threshold; or
wherein both the coded representation of the quantized spectrum and the coded representation of the parametric representation are based on a variable number of bits dependent on the spectral representation, or dependent on a derivative of the perceptually flattened spectral representation, and the quantization step.

11. The encoder according to claim 1, further comprising a modifier configured to adaptively set at least a sub-band in the quantized spectrum to zero, dependent on a content of the sub-band in the quantized spectrum and in the spectral representation of audio signal.

12. The encoder according to claim 1, wherein the parameters describe the energy in the sub-bands and wherein the band-wise parametric coder comprises two stage, wherein in the first stage of the two stages the band-wise parametric coder is configured to provide individual parametric representations of the sub-bands above a frequency, and where the second stage of the two stages provides an additional average parametric representation for sub-bands above the frequency where the individual parametric representation is zero and for sub-bands below the frequency.

13. A decoder for decoding an encoded audio signal, the encoded audio signal comprising at least a coded representation of spectrum and a coded parametric representation, wherein the encoded audio signal further comprises a quantization step, the decoder comprising:
a spectral domain decoder configured for generating a decoded and dequantized spectrum from the coded representation of spectrum and quantization step, wherein the decoded and dequantized spectrum is divided into sub-bands;
a band-wise parametric decoder is configured to identify zero sub-bands in a decoded spectrum or the decoded and dequantized spectrum and to decode a parametric representation of the zero sub-bands based on the coded parametric representation,
wherein the parametric representation comprises parameters describing the energy in the zero sub-bands and wherein there are at least two sub-bands being different and, thus, parameters in at least two sub-bands being different and wherein the coded parametric representation is represented by use of a variable number of bits and wherein the number of bits used for representing the coded parametric representation is dependent on the coded representation of spectrum.

14. A decoder for decoding an encoded audio signal, comprising:
a spectral domain decoder configured for generating a decoded and dequantized spectrum dependent on the encoded audio signal, wherein the decoded and dequantized spectrum is divided into sub-bands;
a band-wise parametric decoder configured to identify zero sub-bands in a decoded spectrum or a decoded and dequantized spectrum and to decode a parametric representation of the zero sub-bands based on the encoded audio signal;
a band-wise spectrum generator configured to generate a band-wise generated spectrum dependent on the parametric representation of the zero sub-bands;
a combiner configured to provide a band-wise combined spectrum; where the band-wise combined spectrum comprises a combination of the band-wise generated spectrum and the decoded and dequantized spectrum or a combination of the band-wise generated spectrum and a combination of a predicted spectrum and the decoded and dequantized spectrum and
a spectrum-time converter configured for converting the band-wise combined spectrum or a derivative of the band-wise combined spectrum into a time representation.

15. The decoder according to claim 13, wherein the derivative of the band-wise combined spectrum comprises a reshaped spectrum reshaped by use of a spectrum shaper or a noise shaper; or
further comprising a processor configured to acquire a time domain signal from an output of a spectrum-time converter, or a spectral shaper configured to spectrally shape a time domain signal (derived from an output of a spectrum-time converter) by processing with an LP filter; or
wherein a band-wise combined spectrum or a reshaped spectrum is converted using a spectrum-time converter to the time domain signal.

16. The decoder according to claim 13, wherein the band-wise parametric decoder is configured to decode a parametric representation of the zero sub-bands based on the encoded audio signal using a quantization step; or
wherein the parametric representation comprises parameters describing energy in sub-bands and wherein there are at least two sub-bands being different and, thus, parameters describing energy in at least two sub-bands being different; or
wherein the parametric representation comprises parameters describing energy in sub-bands; or
wherein energy of individual zero lines in non-zero sub-bands is estimated and not coded explicitly; or
wherein zero sub-bands are defined by a decoded spectrum or the decoded and dequantized spectrum output of the spectrum decoder; or
wherein the coded parametric representation is coded by use of a variable number of bits and wherein the number of bits used for representing the coded parametric representation is dependent on the coded representation of spectrum; or
wherein a number of sub-bands for which there is the parametric representation depends on the coded representation of spectrum.

17. The decoder according to claim 13,
wherein value of the parametric representation of the zero sub-bands is decoded depending on a quantization step g_{Q}_{₀}; or
wherein parametric representation depends on the coded representation of spectrum.

18. The decoder according to claim 13, wherein the band-wise parametric decoder is configured to decode the parametric representation of the zero sub-bands based on the encoded audio signal using an information of an output of the spectral domain decoder or using the decoded and dequantized spectrum.

19. The decoder according to claim 14, where the spectrum shaper is configured to spectrally shape the band-wise combined spectrum or the derivative of the band-wise combined spectrum using a spectral shape acquired from a coded spectral shape; wherein the coded spectral shape uses a different or lower frequency resolution than the sub-band division.

20. The decoder according to claim 13, further comprising a band-wise parametric spectrum generator configured to generate a spectrum to acquire a generated spectrum that is added to the decoded and dequantized spectrum or to a combination of a predicted spectrum and the decoded and dequantized spectrum, where the generated spectrum is band-wise acquired from a source spectrum, the source spectrum being one of:
a second prediction spectrum; or
a random noise spectrum; or
the already generated parts of the generated spectrum; or
the decoded and dequantized spectrum or the combination of the predicted spectrum and the decoded and dequantized spectrum; or
a combination of one or two of the above.

21. A band-wise parametric spectrum generator configured to generate a spectrum to acquire a generated spectrum that is added to a decoded and dequantized spectrum or to a combination of a predicted spectrum and the decoded and dequantized spectrum, where the generated spectrum is band-wise acquired from a source spectrum, the source spectrum being one of:
a second prediction spectrum; or
a random noise spectrum; or
the already generated parts of the generated spectrum; or
the decoded and dequantized spectrum or the combination of the predicted spectrum and the decoded and dequantized spectrum; or
a combination of one or two of the above
wherein at least one sub-band is acquired using the already generated parts of the generated spectrum.

22. The decoder according to claim 13, wherein a source spectrum is weighted based on an energy parameter of zero sub-bands.

23. The band-wise parametric spectrum generator according to claim 21, wherein the source spectrum is weighted based on the energy parameters of zero sub-bands.

24. The decoder according to claim 20, wherein a choice of the source spectrum for a sub-band is dependent on at least one of: the sub-band position, tonality information, power spectrum estimation, energy parameter, pitch information or temporal information.

25. The band-wise parametric spectrum generator according to claim 21, wherein a choice of the source spectrum for a sub-band is dependent on at least one of: the sub-band position, tonality information, power spectrum estimation, energy parameter, pitch information or temporal information.

26. The decoder according to claim 24, wherein the tonality information is ϕ_{H}, or pitch information is d̅_{F}_{₀}, or a temporal information is the information if TNS is active or not.

27. The band-wise parametric spectrum generator according to claim 25, wherein the tonality information is ϕ_{H}, or pitch information is d̅_{F}_{₀}, or a temporal information is the information if TNS is active or not.

28. A method for encoding a spectral representation of audio signal divided into a plurality of sub-bands, wherein the spectral representation comprises frequency bins or of frequency coefficients and wherein at least one sub-band comprises more than one frequency bin, comprising:
generating a quantized representation of the spectral representation of audio signal divided into plurality sub-bands;
providing a coded parametric representation of the spectral representation depending on the quantized representation, wherein the coded parametric representation comprises parameters describing the spectral representation in the sub-bands or coded versions of the parameters describing the spectral representation in the sub-bands; wherein there are at least two sub-bands being different and the parameters describing the spectral representation in the at least two sub-bands being different wherein the parameters describe the energy in the sub-bands;
wherein at least one sub-band of the plurality of sub-bands is quantized to zero or wherein a spectral representation for at least one sub-band of the plurality of sub-bands is zero in the quantized representation.

29. A method for decoding an encoded audio signal, the encoded audio signal comprising at least a coded representation of spectrum and a coded parametric representation, wherein the encoded audio signal further comprises a quantization step, comprising:
generating a decoded and dequantized spectrum from the coded representation of spectrum and quantization step, wherein the decoded and dequantized spectrum is divided into sub-bands;
identifying zero sub-bands in a decoded spectrum or the decoded and dequantized spectrum and decoding a parametric representation of the zero sub-bands based on the coded parametric representation,
wherein the parametric representation comprises parameters describing the energy in the zero sub-bands and wherein there are at least two sub-bands being different and, thus, parameters in at least two sub-bands being different and wherein the coded parametric representation is represented by use of a variable number of bits and wherein the number of bits used for representing the coded parametric representation is dependent on the coded representation of spectrum.

30. A method for decoding an encoded audio signal, the method comprising:
generating a decoded and dequantized spectrum based on an encoded audio signal, wherein the decoded and dequantized spectrum is divided into sub-bands;
identifying zero sub-bands in a decoded spectrum or the decoded and dequantized spectrum and to decode a parametric representation of the zero sub-bands based on the encoded audio signal;
generating a band-wise generated spectrum dependent on the parametric representation of the zero sub-band;
providing a band-wise combined spectrum; where the band-wise combined spectrum comprises a combination of the band-wise generated spectrum and the decoded and dequantized spectrum or a combination of the band-wise generated spectrum and a combination of a predicted spectrum and the decoded and dequantized spectrum; and
converting the band-wise combined spectrum or a derivative of the band-wise combined spectrum into a time representation.

31. A method for generating a band-wise generated spectrum, comprising generating a spectrum to acquire a generated spectrum that is added to a decoded and dequantized spectrum or to a combination of a predicted spectrum and the decoded and dequantized spectrum, where the generated spectrum is band-wise acquired from a source spectrum, the source spectrum being one of:
a second prediction spectrum; or
a random noise spectrum; or
the already generated parts of the generated spectrum ; or
a combination of at least two of the above.

32. A non-transitory digital storage medium having stored thereon a computer program for performing a method for encoding a spectral representation of audio signal divided into a plurality of sub-bands, wherein the spectral representation comprises frequency bins or of frequency coefficients and wherein at least one sub-band comprises more than one frequency bin, comprising:
generating a quantized representation of the spectral representation of audio signal divided into plurality sub-bands;
providing a coded parametric representation of the spectral representation depending on the quantized representation, wherein the coded parametric representation comprises parameters describing the spectral representation in the sub-bands or coded versions of the parameters describing the spectral representation in the sub-bands; wherein there are at least two sub-bands being different and the parameters describing the spectral representation in the at least two sub-bands being different wherein the parameters describe the energy in the sub-bands;
wherein at least one sub-band of the plurality of sub-bands is quantized to zero or wherein a spectral representation for at least one sub-band of the plurality of sub-bands is zero in the quantized representation,
when the computer medium is run by a computer.
